(19) United States
(12) Patent Application Publication
(10) Pub. No.: US 2016/0022532 A1
(43) Pub. Date: Jan. 28, 2016

(54) DEVICES AND METHODS FOR PROMOTING FEMALE SEXUAL WELLNESS

(71) Applicant: EXPLORAMED NC6, INC., Mountain View, CA (US)

(72) Inventors: JOSHUA MAKOWER, Los Altos Hills, CA (US); Earl A. Bright, Los Altos, CA (US); Eric A. Goldfarb, Belmont, CA (US); Arthur Ferdinand, San Jose, CA (US); Pablo Acosta, Newark, CA (US); William M. Facteau, Atherton, CA (US); Sharon Lam Wang, Los Altos Hills, CA (US); Alex Goldenberg, San Francisco, CA (US); Michael Strasser, San Francisco, CA (US); Imraan Aziz, Oakland, CA (US); Kyle Lamson, San Francisco, CA (US); John Colombo, San Carlos, CA (US); William Justin Grange, San Francisco, CA (US); Jose Luis Cordoba, Malaga (ES)

(21) Appl. No.: 14/874,711

(22) Filed: Oct. 5, 2015

Related U.S. Application Data
(63) Continuation of application No. 14/759,707, filed on Jul. 8, 2015.
Application No. 14/759,707 is a continuation-in-part of application No. 13/798,085, filed on Mar. 13, 2013.
(60) Provisional application No. 61/731,487, filed on Nov. 30, 2012.
(60) Provisional application No. 61/839,792, filed on Jun. 26, 2013.
(60) Provisional application No. 61/856,717, filed on Jul. 21, 2013.
(60) Provisional application No. 61/864,558, filed on Aug. 10, 2013.

(51) Int. Cl. A61H 19/00

(52) U.S. Cl. CPC A61H 19/34; A61H 2201/5005; A61H 2201/5033; A61H 2201/5038; A61H 2201/5035; A61H 2201/1207; A61H 2201/1238; A61H 2201/0107; A61H 2201/165; A61H 2201/5046

(57) ABSTRACT

Devices, systems, and methods for promoting female sexual wellness and function. The devices, systems, and methods encourage clitoral engorgement using suction over the clitoris combined with vibratory stimulation

### FIELD OF THE INVENTION

Embodiments of the present invention relate generally to devices and methods and more particularly to promoting female sexual wellness and function. In particular, certain embodiments are useful for promoting, facilitating, stimulating, or enhancing sexual desire, arousal or satisfaction in a female.

### BACKGROUND OF THE INVENTION

Clitoral vascular engorgement plays an important role in female sexual desire, arousal and satisfaction. Sexual arousal results in smooth muscle relaxation and arterial vasodilation within the clitoris. The resultant increase in blood flow leads to tumescence of the glans clitoris and increased sexual arousal. A variety of conditions may cause clitoral erectile insufficiency and reduced clitoral arterial flow. This, in turn, may lead to difficulty or inability to achieve clitoral tumescence. Female sexual wellness may also be negatively affected by a lack of subjective excitement, genital lubrication or orgasmic function.

The incidence of symptoms ranging from dissatisfaction to dysfunction is high in women. For example, in the National Health and Social Life Survey of 1,749 women age 18-59, 43% experienced sexual. Further, female sexual dysfunction is altered with aging, is progressive and highly prevalent affecting 30-50% of women and 68 to 75% of women experience sexual dissatisfaction or “problems” (not dysfunctional in nature). In a national survey of more than 31,000 women in the United States, 44.2% of women reported experiencing a sexual problem. According to other studies, over 53 million women (43% of the U.S. population) have reported one or more sexual problems and over 14 million women meet the clinical criteria for Female Sexual Dysfunction (FSD), with low desire being by far the most common problem (reported by 46 million women). (See, e.g., Spector I, Carey M. Incidence and prevalence of the sexual dysfunctions: a critical review of the empirical literature. 19: 389-408, 1990; Rosen R C, Taylor J F, Leiblum S R, et al: Prevalence of sexual dysfunction in women: results of a survey study of 329 women in an outpatient gynecological clinic J Sex. Mar. Ther. 19:171-188, 1993; Read S, King M, Watson J: Sexual dysfunction in primary medical care: prevalence, characteristics and detection by the general practitioner. J. Public Health Med. 19:387-391, 1997; Laumann E, Paik A, Rosen R. Sexual Dysfunction in the United States Prevalance and Predictors. JAMA, 1, 281: 537-544; Read S, King M, Watson J. Sexual dysfunction in primary medical care: prevalence, characteristics and detection by the general practitioner. J Public Health Med. 1997; 19:387-91; Schein M, Zyzanski S J, Levine S, Medalie J H, Dickman R L, Alemagno S A. The frequency of sexual problems among family practice patients. Fain Pract Res J. 1988; 7:122-34; Shifren J L, Monz B U, Russo P A, Segreti A, Johannes C B. Sexual problems and distress in United States women: prevalence and correlates. Obstet Gynecol. 2008; 112(5):970-978; and Shifren, Obstet Gynecol 2008; 112: 970-8. Each of these publications is incorporated by reference herein.)

Research indicates that a sufficient blood supply is required for good clitoral and vaginal function and satisfying sexual experience at any age. Women at risk for Female Sexual Dysfunction include those using birth control pills, those with poor vascular health (such as those with diabetes, high cholesterol, or hypertension), aging women and those undergoing or having undergone cancer radiation treatment (which may adversely decrease lubrication, hormone levels, and/or genital sensation). Using birth control pills can lower the circulating levels of testosterone needed to regulate blood flow to genitals and stimulate sexual desire and can cause long-term permanent sex hormone insufficiency. Also, the prevalence of sexual problems increases dramatically by age, with 27.2% of women aged 18 to 44 years, 44.6% of women aged 45 to 64 years, and 80.1% of women aged 65 years and older reporting sexual problems.

While the majority of male and female sexual organ is similar, a subtle anatomical difference makes females more susceptible to inhibitors. While the glans penis in men and the glans clitoris in women similarly each have the highest concentration of sensory receptors than any other location in the body, the male anatomy provides more extensive structural support for the glans penis. Addressing male sexual dysfunction can take advantage of this structural support by augmenting or enhancing the venous trapping function of the corpus cavernosum. In contrast, no anatomical sustain mechanism exists in women for engorgement making women more susceptible to an array of powerful inhibitors. While the female corpus canvernosum does become engorged during stimulation (sec FIG. 29), it does not sustain engorgement to the same degree as the male anatomy.

FIG. 30 illustrates the variety of factors that can act as inhibitors or promoters of sufficient sexual stimulation. For example, FIG. 30 illustrates how sensory and psychosocial factors, such as the well-being of the woman's relationship with her partner and emotional or visual cues, drive central nervous system (CNS) mediated promotion or inhibition (denoted by the +/− symbol). Other health factors such as diabetes or cardiovascular disease or factors such as drugs can drive other inhibition or promotion. This multifactorial web has made developing a safe drug for treating women very challenging.

The female sexual response cycle affects the incidence of a satisfying sexual experience (SSE) for women. The cycle includes the states of (i) emotional and physical satisfaction, leading to (ii) emotional intimacy, leading to (iii) being receptive to sexual stimuli, leading to (iv) sexual arousal, leading to (v) arousal and sexual desire, which takes the cycle back around to the state of (i) emotional and physical satisfaction. Spontaneous sex drive can occur between states (ii) and (iii), between states (iii) and (iv), and/or between states (iv) and (v).

These and other challenges can be addressed by embodiments of the present invention.

### BRIEF SUMMARY OF THE INVENTION

Certain embodiments of the present invention are related to a system or a method for promoting female sexual arousal; for clitoral engorgement using suction combined with vibratory stimulation; for providing variable and customizable control of vibration and suction; for providing a novel power-tissue optimization scheme based on stimulators mounted on a flexible membrane; for providing a novel suction attachment modality combined with multi-focal actuators; and for providing novel actuators for mechanical motion and suction.

Certain embodiments of the present invention are related to a system, or a method for providing a tissue-contacting chamber and at least two stimulators coupled to the chamber and controlled such that the user experiences spatially differentiated stimulation. The system can include a suction port in fluid communication with an interior of the tissue-contacting chamber. The system can include a suction adjustment mechanism integral to the tissue-contacting chamber. The system can include a plunger positioned within the interior of the tissue-contacting chamber and configured to adjust suction within the tissue-contacting chamber. The system can include a sealing surface attached to the tissue-contacting chamber and configured to maintain a substantially airtight seal against tissue. The system can include a controller and/or remote controller. The system can include that parameters of the stimulators are controlled and the parameters are selected from the group consisting of vibrational frequency, vibrational intensity, vibrational duration, sequence of motor vibration, and combinations thereof. The system can include that the stimulators are controlled by selecting from a pre-programmed algorithm, a user-customizable algorithm, or combinations thereof. The system can include a suction-generating device and a wearable device body, wherein the suction-generating device is detachable from the wearable device body. The system can include that the device body remains substantially in contact with tissue after the suction-generating device is detached. The system can include a membrane at least partially encapsulating at least one of the stimulators. The system can include that the membrane is coupled to the chamber. The system can include that the membrane is configured to be displaceable by the user's clitoris. The system can include that the stimulators are controlled such that the user experiences simulated macroscopic motion. The system can include that the stimulators generate macroscopic motion while contacting tissue. The system can include that vibration generated by one stimulator is isolated from vibration created by another stimulator. The system can include that vibration generated by one stimulator is isolated from a wall of the tissue-contacting chamber. The system can include that at least one of the stimulators are held in direct contact with the user's clitoris during an application of suction.

Certain embodiments of the present invention are related to a system, or a method for providing a mechanically-stabilized housing, a suction chamber within the housing, and a plurality of stimulators. The system can include a low-profile housing. The system can include that the housing is configured to be wearable. The system can include that the stimulators are configured to provide multivariate stimulation. The system can include that the stimulators are configured to provide a combination of macroscopic motion and vibratory stimulation. The system can include that the stimulators are configured to generate a stroking motion.

Certain embodiments of the present invention are related to a system, or a method for providing a tissue-contacting chamber including a suction chamber, the suction chamber being in fluid connection with a programmable suction pump, and at least two stimulators mounted within the suction chamber, wherein the motors and the suction pump are configured to be independently controllable via a control circuit. The system can include a controller block that includes pre-loaded vibration patterns and pre-loaded suction patterns. The system can include that the controller block is configured to allow a user to create vibration patterns and suction patterns. The system can include a wearable device body and a suction pump is mounted within the device body. The system can include that the controller block is configured to enable the user to set a first suction level and a second suction level. The system can include that the controller block is configured to enable the user to set a rate at which the suction pump alternates between the first suction level and the second suction level.

### BRIEF DESCRIPTION OF THE DRAWINGS

FIGS. 1A through 1D illustrate various views of a device according to an embodiment of the invention.

FIGS. 2A through 2D illustrate various views of the interior components of a device according to an embodiment of the invention.

FIG. 3A illustrates a membrane according to an embodiment of the invention.

FIG. 3B illustrates a perspective view of the body-contacting side of a device according to an embodiment of the invention.

FIG. 3C illustrates a close-up perspective view of the body-contacting side of a device according to an embodiment of the invention.

FIG. 4A illustrates a perspective view of the interior of a chamber portion and associated stimulators of a device according to an embodiment of the invention.

FIG. 4B illustrates a perspective view of the exterior of a chamber portion and associated stimulators of a device according to an embodiment of the invention.

FIG. 5A illustrates a perspective view of the interior of a chamber portion and associated stimulators of a device according to an embodiment of the invention.

FIG. 5B illustrates a perspective view of the exterior of a chamber portion and associated stimulators of a device according to an embodiment of the invention.

FIG. 6 illustrates stimulators and vibration isolators of a device according to an embodiment of the invention.

FIG. 7 illustrates a wearable garment and a device according to an embodiment of the invention.

FIGS. 8A through 8C illustrate various views of a device according to an embodiment of the invention.

FIGS. 8A′ through 8C′ illustrate various views of a device according to an embodiment of the invention.

FIG. 9 illustrates a portion of a device configured to provide macroscopic motion according to an embodiment of the invention.

FIG. 10 illustrates a portion of a device configured to provide macroscopic motion according to another embodiment of the invention.

FIG. 11 illustrates a device configured to provide macroscopic motion according to an embodiment of the invention.

FIG. 12 illustrates a perspective view of a device according to another embodiment of the invention.

FIG. 13 illustrates a cross-sectional view of a device according to another embodiment of the invention.

FIGS. 14A and 14B illustrate views of a device and assembly of such a device according to another embodiment of the invention.

FIGS. 15A and 15B illustrate views of a device according to another embodiment of the invention.

FIG. 16 illustrates a view of a device according to another embodiment of the invention.

FIG. 17 illustrates a view of a device according to another embodiment of the invention.

FIGS. 18A and 18B illustrate perspective views of a device and a detachable suction element according to another embodiment of the invention.

FIG. 19 illustrates a cross-sectional view of a device according to another embodiment of the invention.

FIG. 20 illustrates a cross-sectional view of a device and a perspective view of a controller according to another embodiment of the invention.

FIGS. 21 and 22 illustrate stimulator and lever arrangements according to embodiments of the invention.

FIGS. 23A and 23B illustrate a device providing macroscopic motion according to an embodiment of the invention.

FIGS. 24A through 24D illustrate various views of a device according to an embodiment of the invention.

FIGS. 25A and 25B illustrate a charging station and device according to an embodiment of the invention.

FIG. 25C illustrates a charging station and device according to another embodiment of the invention.

FIGS. 26A and 26B illustrate views of a device and a controller according to an embodiment of the invention.

FIGS. 27A and 27B illustrate views of a device according to an embodiment of the invention.

FIG. 28 illustrates a view of a device according to an embodiment of the invention.

FIG. 29 illustrates a view of certain elements of the human female anatomy relevant to embodiments of the invention.

FIG. 30 is a flowchart illustrating multiple inhibitors and promoters of a satisfying sexual experience and their interdependence.

FIGS. 31A through 31C illustrate the relationship between engorgement and vibration propagation.

FIGS. 32A through 32E illustrate use of various embodiments of the invention.

FIG. 33 is a partial cross-sectional view of another embodiment of the invention.

FIGS. 34A through 34D are side views of a portion of certain embodiments with different tissue contacting configurations.

FIGS. 35A and 35B are plan views of a device with a removable flange assembly.

FIG. 36 is a perspective view of a removable flange assembly.

FIGS. 37A and 37B show a removable flange assembly including a flange membrane.

FIG. 38A is a side elevation of a removable flange assembly.

FIGS. 38B and 38C are a side elevation and a perspective view, respectively, of a cross-section of the removable flange assembly of FIG. 38.

FIG. 39 is a plan view of the flexible membrane of the suction chamber.

FIG. 40 is a perspective, phantom view of an integrated device.

FIGS. 41A and 41B illustrate a device body configured to fit comfortably and reliably on a user in multiple contexts.

FIG. 42 is a perspective view of a device that includes an onboard manual pump.

FIGS. 43A-43K show various embodiments of the sealing flange assembly.

FIGS. 44A-44C illustrate user interfaces for a smartphone-type controller.

FIGS. 45A and 45B illustrate a side view and a partial interior view of a device having motors in the device body.

FIG. 46 illustrate a device having multiple motors free to vibrate and impinge upon a tissue chamber.

FIGS. 47A-47D illustrate arrays of stimulating elements for use in a device.

FIGS. 48A-48C illustrate a stylus-type stimulation system and a complementary stimulating array.

FIGS. 49A-49C illustrate a motor and end effectors system for stimulating tissue in a tissue or suction chamber.

FIGS. 50A-50D illustrate arrays of end effectors in combination with at least one motor and at least one coupler for stimulating tissue.

FIGS. 51A and 51B illustrate two views of a spatially differentiated resonating element driven by one or more motors.

FIGS. 52A-52D illustrate various embodiments of device with stabilizing, adhering, and/or securing features.

FIG. 53 illustrates an embodiment of a device capable of simultaneous intravaginal and clitoral fit and stimulation.

FIGS. 54A-54D illustrate embodiments of a clitoral engagement chamber and associated device body.

### DETAILED DESCRIPTION OF THE INVENTION

Embodiments of the present invention described herein, including the figures and examples, are useful for promoting female sexual wellness and function.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

Short summaries of certain terms are presented in the description of the invention. Each term is further explained and exemplified throughout the description, figures, and examples. Any interpretation of the terms in this description should take into account the full description, figures, and examples presented herein.

The singular terms “a,” “an,” and “the” include plural referents unless the context clearly dictates otherwise. Thus, for example, reference to an object can include multiple objects unless the context clearly dictates otherwise. Similarly, references to multiple objects can include a single object unless the context clearly dictates otherwise.

The terms “substantially,” “substantial,” and the like refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

The term “about” refers to a value, amount, or degree that is approximate or near the reference value. The extent of variation from the reference value encompassed by the term “about” is that which is typical for the tolerance levels or measurement conditions.

The term “stimulator” refers to elements that provide stimulation using mechanical motion (such as vibration), electrical stimulation, temperature, or other sensory stimulation.

Certain biological molecules and anatomical structures exist in a healthy female to create engorgement of the vulvar and clitoris erectile tissues. These molecules and structures facilitate stiffening the underlying stratum upon which the nerves in the clitoris are deployed. The effect of the stiffening is to allow for the more rigid projection and presentation of the clitoral structures for stimulation, as well as mechanically allowing energy waves to be propagated across the surface more efficiently with less energy absorption by the tissues. As a result, a rigid clitoris stimulated mechanically via deflection, vibration, and the like propagates these forces across the tensed surface of the structure rather than being lost within the loose connective tissue. Thus, means for producing an engorged environment (via drugs or via suction, for example) can enhance sensation and produce other reflexive responses (e.g., lubrication and oxytocin release). Further, the type and distribution of sensory nerve endings within the tissues of the clitoris and surrounding tissue explain why certain motions, pressures, vibrations, and other stimuli more optimally deliver pleasurable sensations than others. Vibration and suction both have the capacity to stimulate engorgement via the nitrous oxide pathway and thus both can increase sensitivity to sexual stimulation. The two follow different neuronal/physiologic pathways. Dual-triggering with the use of vibration and suction combined provide additive effects. Pacinian or pacini corpusles also called Vater-pacini receptors conduct signals in response to vibratory “pressure” (tissue vibration is conducted via a pressure wave)—the reflex responses utilize NOS pathways which deploy into the same structures that are engorged in the embodiments of the suction elements described herein. Motion/slippage in a repetitive pattern also produces a “pressure” pattern and vibratory nerve signaling. Nerves can adapt to stimuli quickly, thus vibration in one spot will typically become less impactful, therefore moving the site of vibration is beneficial, whether manually or automatically. All of the above are mediated by DH testosterone and other hormonal components (and thus testosterone therapy can help improve the quality of the tissues as well as their “activity”) but we have discovered through mechanical stimulation—either through suction or vibration or both—many of the hormonal pathways can be bypassed and the reflex responses can be triggered directly.

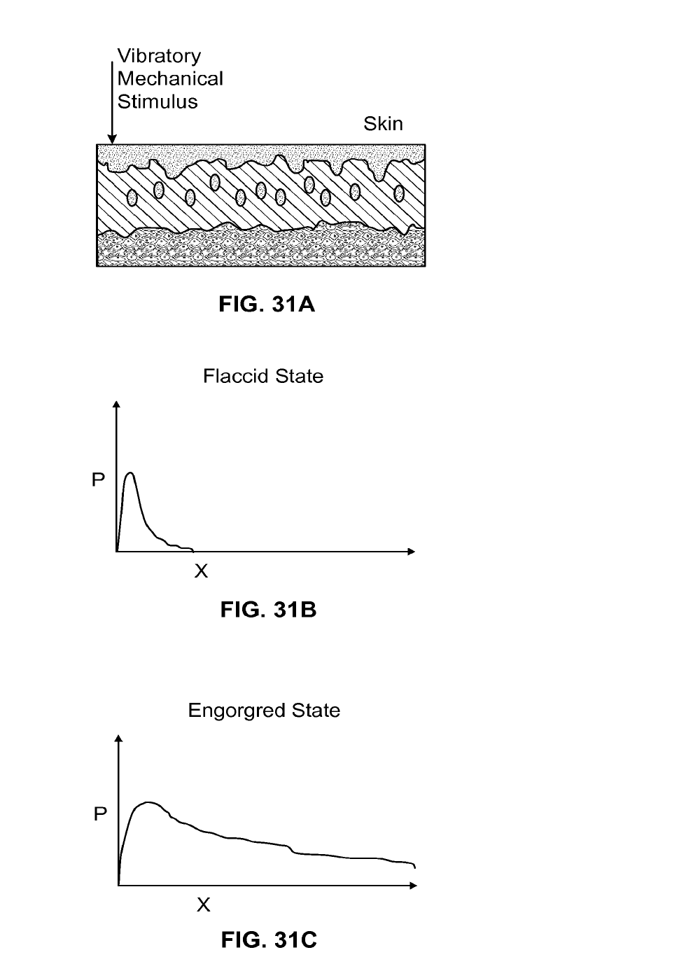

We have discovered that engorgement and vibration together are a powerful combination such that engorgement creates a more suitable mechanical back-board for the pacinian corpusles to be stimulated and that applying both simultaneously should produce more profound effects than either applied alone. In both sexes, engorgement of the sexual organs is the key physiological target in that engorgement is fundamental to achieve an SSE. As illustrated in FIGS. 31A through 31C, vibrational energy propagates better along a tensioned, engorged substrate. Embodiments described herein provide methods and devices for engorging sexual organs to better propagate vibrational energy.

Certain prior art stimulation devices, such as vibrators, provide relatively diffuse stimuli. That is, the vibrating motion supplied by a vibrator is applied relatively evenly over the clitoris and surrounding tissue. In certain vibrating devices that are capable of delivering vibration over a more tightly focused area, the frequency and magnitude of the vibration may still present a relatively diffuse vibratory motion to clitoral tissue. Additionally, much of the vibration of prior art vibrators is lost in vibrating the handle, housing and the user's hand or other portion of their body.

Advantageously, certain embodiments described herein are capable of providing complex patterns of suction. Such complex suction waveforms can provide a comparatively organic stimulation experience as compared to prior art mechanical stimulation devices. For some users, the variable suction patterns, algorithms waveforms of certain embodiments can provide engorgement and stimulation such that effective arousal is achieved without the use of vibration.

Advantageously, and in contrast to prior art devices, embodiments described herein are capable of providing spatially-differentiated vibratory motion. That is, a woman experiences spatially-differentiated vibratory motion. In certain embodiments, such spatially-differentiated vibratory motion may simulate an experience of macroscopic motion about the clitoris. Macroscopic motion can be understood as analogous to stroking motion, lingual motion, or motion consistent with intercourse. For some users, the spatially-differentiated vibratory motion of certain embodiments can provide engorgement and stimulation such that effective arousal is achieved without the use of suction. For some users, the macroscopic motion about the clitoris of certain embodiments can provide engorgement and stimulation such that effective arousal is achieved without the use of suction.

An aspect of spatially-differentiated stimulation is the isolation of the stimulation generated by a stimulator(s) from the stimulation generated by another, nearby stimulator. By isolating the stimulation generated by one motor from another, a device simulates and/or mimics macroscopic motion about the clitoris. Another aspect of spatially-differentiated stimulation is isolation of the stimulation generated by a stimulator(s) from the housing which minimizes loss of stimulation and allows the stimulation to be focused on the tissue of interest.

A further benefit of isolating vibration in devices according to embodiments disclosed herein, is that a small device may be discreetly worn which produces little noise while a focused, isolated vibration is applied and clitoral tissue is engorged.

Certain embodiments of devices disclosed herein use suction to draw tissue into contact with vibrating elements. Certain devices remain in contact with tissue by virtue of the suction applied to the tissue. Yet another benefit of isolating vibration in devices is that the airtight seal between the device and tissue is not substantially disrupted by the vibration. This type of vibration isolation involves substantially isolating the sealing elements of the device from the vibrating elements in the device.

The compact size of devices disclosed herein makes them capable of being discreetly worn and capable of being carried in a purse. Yet, devices disclosed herein are sized and configured to be accessible and controllable while being worn. Devices disclosed herein may be usable prior to and during intercourse or as a program for recruitment of blood flow and nerve sensitization of tissue. Devices disclosed herein may be adjustable and customizable and provide selectable, variable suction and vibrational properties. Devices disclosed herein may be capable of being controlled remotely, such as by a smartphone. Devices discloses herein may be capable of promoting and/or sustaining female sexual arousal.

Advantageously, devices disclosed herein use relatively low power motors to produce focused, spatially-differentiated vibration.

According to certain embodiments, the device has some or all of the following characteristics: (i) has a suitable fit; (ii) provides appropriate stimulation; (ii) is sufficiently comfortable or tolerable; and (iv) performs reliably and safely.

Regarding suitable fit, the following attributes may be present in a device having a suitable fit: (i) the device is wearable while ambulatory without the need for a tether or additional garment; (ii) the device is sized such that the attachment area fits between the labia majora inferior to the clitoris and the housing may exit the labia majora superior to the clitoris; (iii) the device continues to fit throughout the engorgement process; and (iv) the device is wearable during sexual intercourse. Further, the device can be configured such that placement of a portion of the device posterior of the labia majora is sufficient to securely hold the device in place, with or without additional suction.

According to certain embodiments, suitable fit can be achieved by providing some or all of the following parameters: (i) the device design and center of gravity allow the device to hold to the tissue for at least 5 minutes without a tether; (ii) the device may be worn under clothing; (iii) the mass of the device allows for attachment by suction only; (iv) the device stay in place for at least 5 minutes without adjustment; (v) the device has a compliant tissue interface region; (vi) the device stays in place while standing and walking while wearing the device; (vii) the footprint of device attachment area is anatomically appropriate; (viii) the device is designed to fit over at least a woman's clitoral region; (ix) the device provides space for the tissue to expand; (x) the external device envelope allows for discreet use; (xi) the device is designed such it does not occlude or limit access to the vaginal opening; (xii) the device body can withstand a force compressing it against a soft surface, such as a body; (xiii) the device height does not limit interaction of partners and the edge geometry is comfortable for both partners.

In certain embodiments, proper placement can be achieved by activating one or more motors to a detectable level of vibration to allow the user to center the stimulatory effect about the clitoris. By pre-activating the motors during placement, the user can customize the fit and determine the most effective location for vibrational simulation and/or suction stimulation.

Regarding appropriate stimulation, one or more of the following attributes can be present in a device providing appropriate stimulation: (i) the device applies suction to the vulvar region or more specifically the clitoral region to facilitate engorgement of the clitoral tissues; (ii) the device is capable of applying vibrational energy to at least the region of clitoral tissues; and (iii) the device provides stimulation for a sufficient period of time to achieve the desired degree of arousal.

According to certain embodiments, appropriate stimulation may be achieved by providing some or all of the following parameters: (i) the device provides suction to the clitoral region in a range of about 0.7 in Hg to about 9 in Hg; (ii) the device provides suction with the optional addition of personal lubricant in an environment in which pubic hair is present; (iii) the device maintains the selected level of suction for a minimum of 5 minutes; (iv) the user can control the level and pattern of suction including via use of wireless remote control; (v) the device generates vibration within the frequency range of 100-300 Hz; (vi) the vibrational forces (peak to peak) under load promote arousal; (vii) the vibratory elements are held in direct contact with tissue when suction is applied; (viii) the device provides full power stimulation for a minimum of 30 minutes on a single battery charge; and (ix) the device is capable of moving the vibration between sources as directed by the user.

Regarding comfort and tolerability, one or more of the following attributes may be present in a device that is sufficiently comfortable and tolerable: (i) the device allows for the user to release suction when desired; (ii) the device does not produce excessive noise; (iii) the device does not cause irritation of the urethra; and (iv) the device is comfortable to wear, with tissue contact surfaces that are soft and pliable and/or smooth with no protrusions.

According to certain embodiments, sufficient comfort and tolerability may be achieved by providing some or all of the following parameters: (i) the user can release the suction within 5 seconds when desired; (ii) the device does not produce sound that exceeds 70 dB, as measured at a distance of 2 inches from the outside of the shell when attached to the user; and (iii) the device fits over a woman's vulvar or clitoral region without occluding the urethral opening.

Regarding reliable and safe performance, the following attributes may be present in a device that performs safely and reliably: (i) the device does not pose a hazard of electrical shock; and (ii) the device allows for proper cleaning or disposal after each use.

According to certain embodiments, reliable and safe performance may be achieved by providing some or all of the following parameters: (i) the battery and electronics compartment(s) isolated from incidental contact with fluids; (ii) the maximum discharge rate of battery is not considered hazardous; (iii) the device life may be rated at 2-3 years; (iv) the stimulators are rated for at least sufficient use; (v) the device is water resistant when cleaned as recommended; and (vi) the device protects regions from contact with tissue/fluids or allows access to region behind the tissue interface for cleaning.

Certain embodiments have some or all of the following features: (i) the user is able to customize the suction and vibratory stimulation to suit their needs; (ii) the device withstands stresses of normal use; and (iii) the device may not have any user-replaceable parts.

Specific aspects of the device features may include some or all of the following: (i) the user is able to set suction to the level that is comfortable to them; (ii) the user is able to detach the suction tube from the device without losing vacuum pressure that leads to device detachment; (iii) the user is able to control vibration function by means of wireless remote control; (iv) the user interface is via iOS, Android, or other mobile operating system application on a Bluetooth enabled device or via an RF or Bluetooth key fob styled controller; (v) the user is able to control vibration parameters such as pattern transition speed and vibration amplitude; (vi) power is provided via an internal rechargeable battery, not accessible to the user; (vii) the user is able to control/direct vibration focus through pointing with finger on a wireless enabled device; (viii) the user is able to control degree of motor overlap; (ix) the motor overlap optimized for organic feel; (x) the device is enabled with basic rotational motor patterns; (xi) the device withstands an external force applied to the external shell (over the attachment area) by the user; (xii) the shell withstands sufficient vacuum cycles without loss of integrity; (xiii) the user is able to customize the motor pattern including direction, motor selection, looping, and save/recall the customized pattern; and (xiv) the user is able to customize the suction pattern and save/recall the customized pattern. Studies have shown that different areas of the female brain are activated when the clitoris is self-stimulated than when the clitoris is stimulated by a partner and that often times a female can achieve orgasm easier through self-stimulation than when stimulated by a partner. With the certain embodiments of the devices described herein, the female can record the stimulation pattern that allows her to achieve orgasm through self-stimulation and store it in the devices memory. Subsequently, the device can be used during intercourse to play the saved pattern such that the female can achieve orgasm as if she were self-stimulating.

Preferred attributes of certain embodiments include: (i) user adjustable suction for fixation and blood flow recruitment; (ii) user adjustable vibration for blood flow recruitment and nerve stimulation; (iii) spatially differentiated stimulation via macro-motion or isolation & control of multiple stimulation sources; (iv) tether-less and wearable during intercourse; and (v) customizable & reusable.

One embodiment of a device includes: (i) a shell that houses a circuit and battery and connects to suction zone; (ii) compliant wings to improve attachment; (iii) multiple stimulators attached to inner walls of compliant suction zone; (iv) motors isolated from outer shell to minimize damping and non-specific vibration; and (v) suction applied from removable applicator causes walls to move inward improving tissue contact.

In one embodiment of the device, a receptacle is coupled to a squeeze bulb for providing suction to the receptacle. The squeeze bulb can be integral to the housing or it may be removable. The receptacle is coupled to adhesive wings capable of conforming to interact with tissue. The wings are designed to conform to the anatomy and may include, for example, a butterfly-like shape. The wings may help stabilize the device and maintain contact with the device in the relevant anatomy. The edges of the wings and of the tissue contacting surfaces of the device are soft or radiused or both.

Certain embodiments of the device include onboard circuitry, power, pump, or other electronic features. For example, the device includes an antenna for interacting with the remote controller, such as an RF antenna. The device includes a battery.

Certain embodiments of the device are controlled by a remote drive connected via drive cable to vibratory and/or suction elements inside the wearable part of the device.

Certain embodiments of the invention provide mechanical motion, preferably macroscopic motion, to simulate the motions naturally used by women to stimulate the clitoris in contrast to high-frequency mechanical vibrations of certain prior art devices. Some embodiments provide multivariate stimulation of the clitoris via a stabilized platform. By mechanically stabilizing a platform, such as through suction attachment, it is possible to create a broad array of stimulating effects directly against the target clitoral tissues. Such effects may be difficult to achieve on a non-mounted platform. Examples of macroscopic motions include a rotary motion, a linear stroking motion, a low frequency “thumping” motion, and combinations above. Such macroscopic motions may be combined with vibration, for example, simple vibration or multiple and/or complex waveform vibration.

Certain embodiments of the device provide variable suction. In such embodiments, the user may rapidly and easily adjust the suction levels. Further, in certain embodiments the variable suction is programmable such that the amount of suction applied by the device can vary according to a pattern. In some instances, the suction pattern is complementary to the vibration and/or macroscopic motion patterns. The device controller includes a means for controlling the suction patterns, pre-loaded suctions patterns, user-configurable suctions patterns, or combinations thereof. The device controller enables the user to selected pre-loaded combinations of a suction pattern, a vibrational pattern, and/or a macroscopic motion pattern and also enables the user to design and select customized combinations.

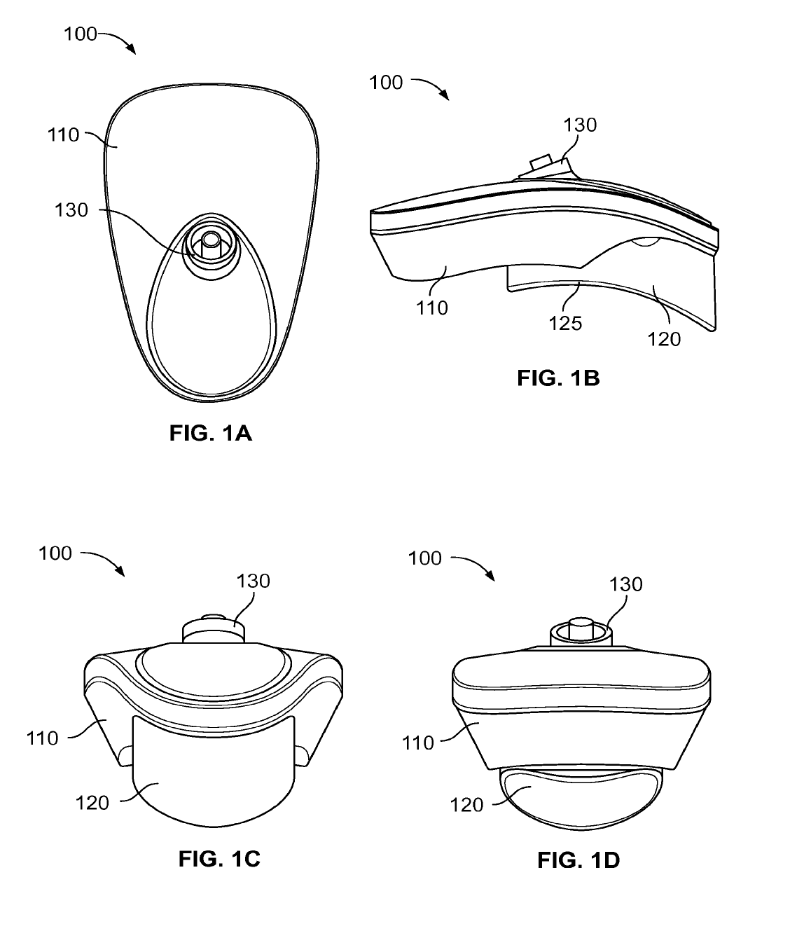

FIGS. 1A, 1B, 1C, and 1D illustrate different views of a device 100 according to one embodiment. Device body 110 is designed to comfortably and discreetly fit against the user's body while remaining accessible and controllable. Device body 110 may include onboard controller circuitry, such as a circuit board, as well as a user control pad. Alternately or additionally, device body 110 may include an antenna for communication with a remote control device. Device body 110 may include a power source, such as a battery. Device body 110 is coupled to suction chamber 120. Suction chamber 120 includes sealing edge 125, which is capable of providing a substantially airtight seal against tissue. Sealing edge 125 may be a flange having a wider width than is pictured in FIGS. 1A through 1D. Suction port 130 is in fluid communication with the interior of suction chamber 120 and provides a connection to a suction device (not pictured), which created negative pressure within suction chamber 120. Suction port 130 may also include a check valve or other one-way valve such that when negative pressure is applied to suction chamber 120 the check valve or other one-way valve prevents suction loss through the valve. Optionally, device body 110 may include an onboard pump system to provide the initial suction to suction chamber 120. Further, the onboard pump system may further include a pressure sensor to maintain a desired level of negative pressure within suction chamber 120 despite the presence of any leaks that may occur along sealing edge 125. Although not pictured in this embodiment, device 100 may include the suction chambers, sealing members, stimulators or other stimulation features, or combinations thereof, described in other embodiments herein.

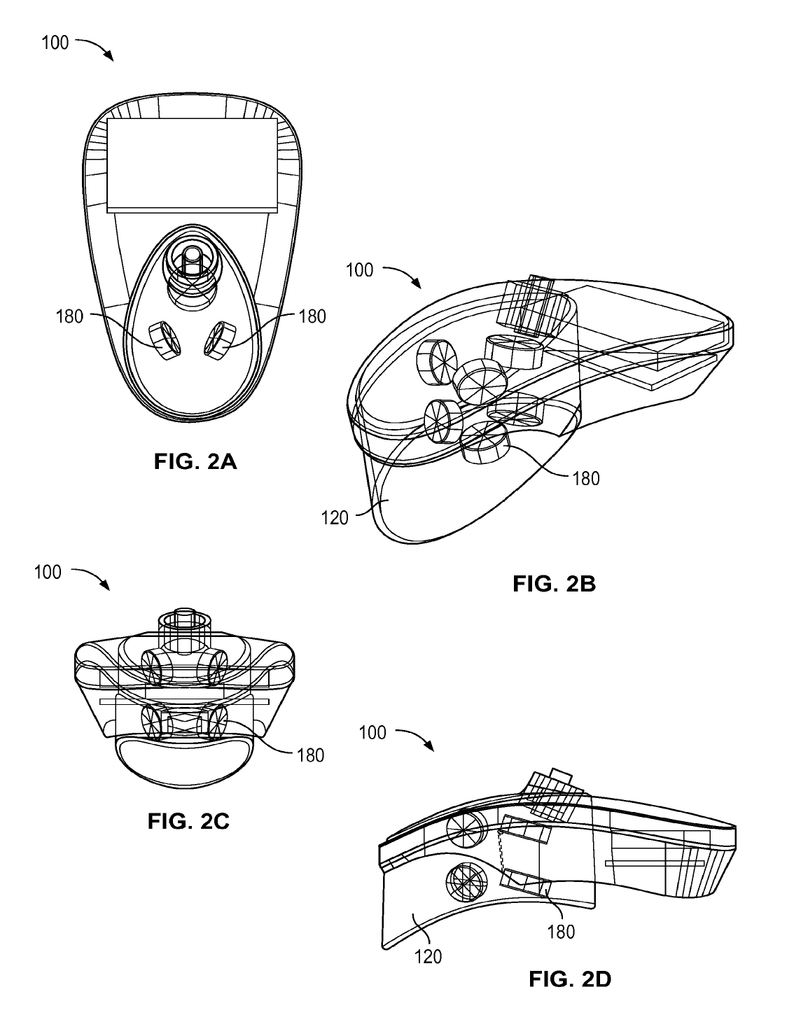

FIGS. 2A, 2B, 2C, and 2D illustrate different views of the device 100 according to one embodiment. These figures depict vibratory motors 180 arrayed within the interior of suction chamber 120. In certain embodiments, the vibratory motors 180 are miniature coin style motors, which have an eccentrically rotating mass that provides vibratory motion. Device 100 is designed such that the vibratory motors 180 engage tissue when tissue is drawn into suction chamber 120. Vibratory motors 180 can be embedded in the walls of suction chamber 120, or they may be otherwise mounted in connection with suction chamber 120. In certain embodiments, it is preferable to minimize the transfer of vibration from vibratory motors 182 to the housing of suction chamber 120. Preferably, the majority of the vibratory energy is transferred to the tissue contacting vibratory motors 180. Vibratory motors 180 may be vibrationally isolated from the rest of device 100 by using mounting mechanisms that inhibit the transfer of vibrational motion to the walls of suction chamber 120. As described herein, vibratory motors 180 may be individually addressable by the controller circuitry such that patterns of motion, and in particular simulations of macroscopic motion, can be applied to the tissue in contact with the vibratory motors.

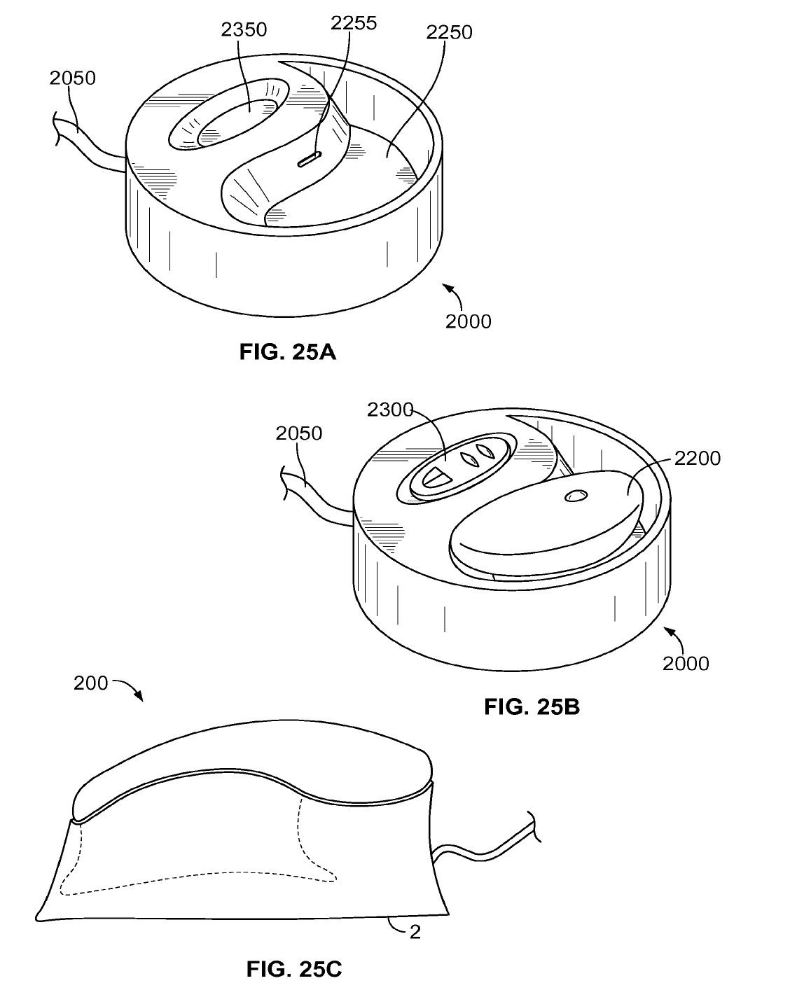

FIGS. 25A and 25B illustrate a charging station 2000 for a device 2200 and a key fob style controller 2300. Charging station 2000 can be plugged into an electrical outlet via cord 2050. Device 2200 can be placed inside device cavity 2250 and controller 2300 can be placed in controller cavity 2350. The walls of the cavities can have charging contact points, such as contact point 2255, for charging the device battery. Or, the battery of device 2200 can be charged by induction. Station 2000 can contain a comparatively high capacity battery that is charged via cord 2050 and is capable of holding charge and also recharging the comparatively smaller capacity battery in device 2200 when station 2000 is unplugged from an electrical outlet. Controller 2300 can be also be charged by the methods described herein or their equivalents. FIG. 25C depicts device 200 in charging cradle 2, which has the same attributes as the charging station depicted in FIGS. 25A and 25B. That is, cradle 2 is capable of charging device 200 by induction, contact points, or other means and contains a rechargeable battery capable of charging the battery within device 200.

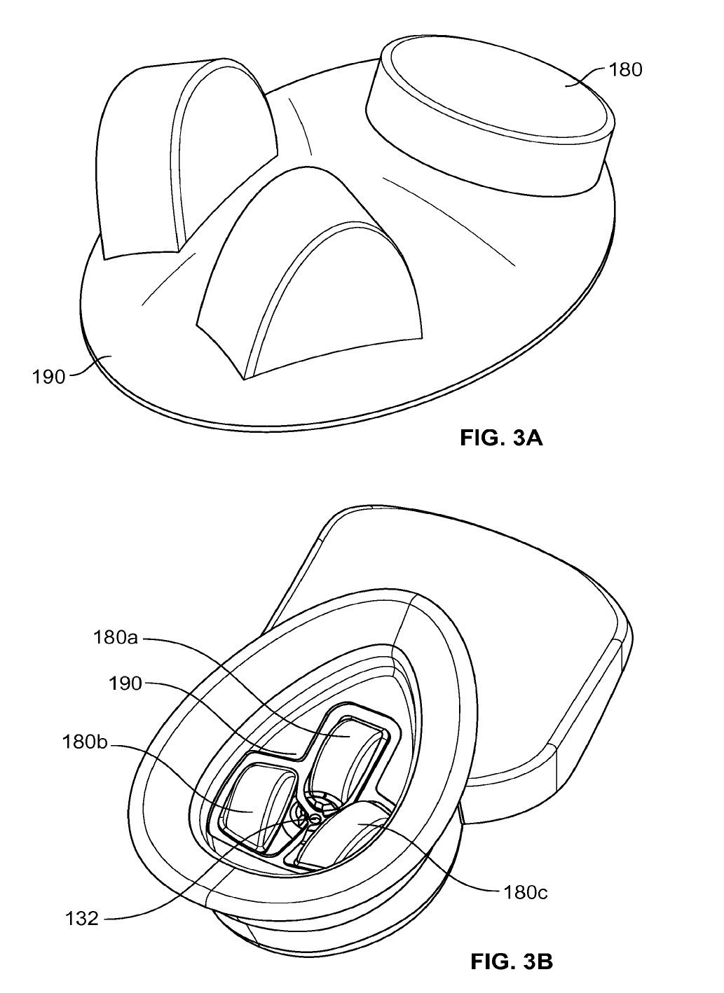

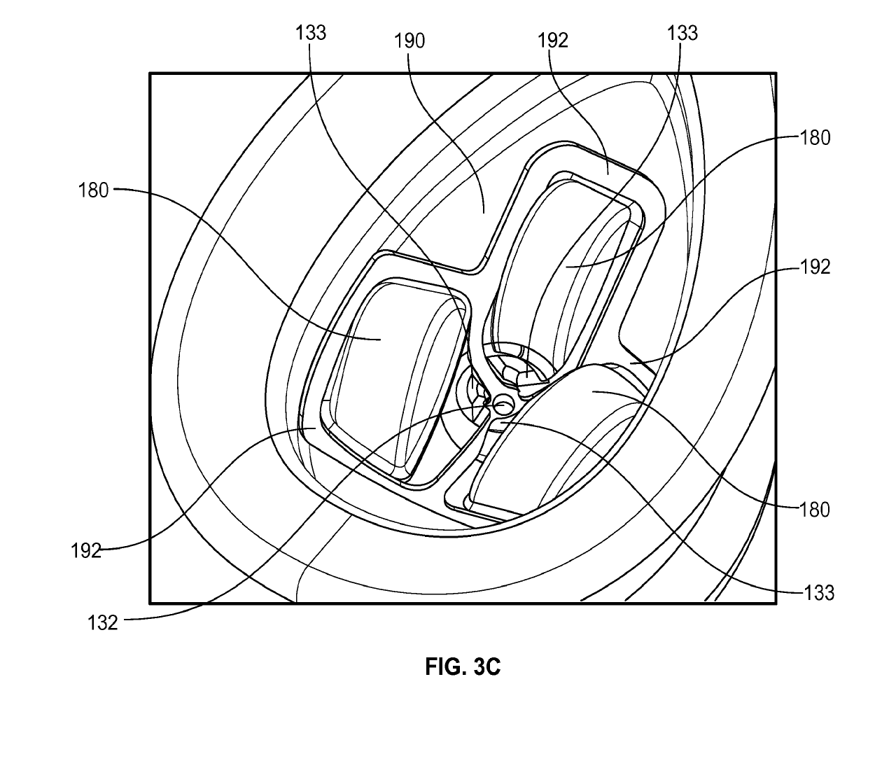

FIG. 3A illustrates three vibratory motors 180 encapsulated in a membrane 190. Membrane 190 is configured to be inserted within a suction chamber of a device. Membrane 190 provides a safe, comfortable, and reliable protective barrier around vibratory motors 180 within a suction chamber. The protective barrier helps reduce tissue irritation and provides a way to clean and reuse the device. As pictured in FIG. 3B, membrane 190 has a convex shape, which defines an interior portion into which tissue is drawn. Membrane 190 has at least one, but preferably more than one holes, perforations, slits, or combinations thereof, to allow deformation of the membrane and airflow. During use when suction is applied through the suction port to the suction chamber tissue is drawn in to the suction chamber and against membrane 190. Membrane 190 deforms towards the interior of the suction chamber while maintaining intimate contact between vibratory motors 180 and tissue. FIG. 3A depicts two of the vibratory motors as being configured to be placed end on against tissue. Any number of the motor(s) can be used and any number may be configured to be placed on end.

FIG. 3B illustrates a perspective view of the tissue-contacting side of device 100 according to an embodiment. In this embodiment, vibratory motors 180 are spaced relatively close together and thereby form a cavity that is sized to approximate the volume of clitoral tissue to be engaged by the device. FIG. 3C illustrates a close-up view of clitoral tissue cavity. Suction inlet 132 is depicted at the approximate apex of the clitoral tissue cavity, but the inlet can be offset to one side rather than being at the apex. Further, suction inlet 132 can be physically offset from the clitoral tissue cavity by a permeable membrane, mesh, or other offset structure. In other words, a fabric or mesh screen can be placed over suction inlet 132 to prevent tissue from becoming trapped insider the suction inlet. For example, an expanded PTFE membrane can be used as the offset structure to provide and maintain a vacuum path between tissue and the suction inlet. FIG. 3C illustrates protrusions 133 as forming an offset structure. Still further, suction inlet 132 may be physically offset from the clitoral tissue cavity by a narrow channel that is too narrow for clitoral tissue to penetrate. Still further, suction inlet 132 can include multiple smaller diameter suction inlets recessed among protrusions. Such offset structures can be combined. Still further, the motors can be sufficiently prominent or protruding from the surface of the flexible membrane (while still being covered by the membrane) to function as offset structures that hold back tissue from blocking the suction inlet region. The offset structures function to prevent tissue from completely covering suction inlet 132, which could cause a drop in vacuum flow as well as damage or pain to tissue.

FIGS. 3B and 3C show the miniature coin-style vibratory motors 180 are deeply recessed into membrane 190 such that one third to one half of the motor extends beyond membrane 190 and toward tissue. Deeply recessing the motors places them closer to tissue and provides a deep clitoral tissue cavity. Close proximity to tissue and a deep clitoral tissue cavity can each provide higher stimulating forces as compared to shallowly recessed motors. It is advantageous to transmit as much force as possible from the motor to the tissue, particularly in the embodiments in which the device is maintained in contact with tissue by suction. In such embodiments, it is advantageous to transmit the force efficiently to tissue since the motors are relatively low power and force losses will dampen the stimulation effect.

FIGS. 3B and 3C depict channels 192 in membrane 190 that at least partially surround the recessed portion of vibratory motors 180. Channels 192 can be a thinned out portion of membrane 190 and can be part of the membrane mold or can be created by removing material from the membrane after molding. Channels 192 function to help provide and maintain a vacuum path between tissue and the suction inlet by providing a “leak path.” As discussed above, it is preferable in certain embodiments to maintain a flow path to suction inlet 132. Channels 192 also function to isolate the vibration of a given motor from the rest of the membrane and the body of the device. Being thinner regions than the surrounding membrane, channels 192 can flex more and reduce or prevent vibrational energy loss that might otherwise be transmitted to the relatively thicker and less flexible parts of the membrane. Minimizing or eliminating vibrations in the membrane from being transmitted to the device body has the advantages of avoiding undesirable effects such as noise, discomfort, reduced stimulation, and reduced suction (by virtue of losing the seal provided by the sealing edge).

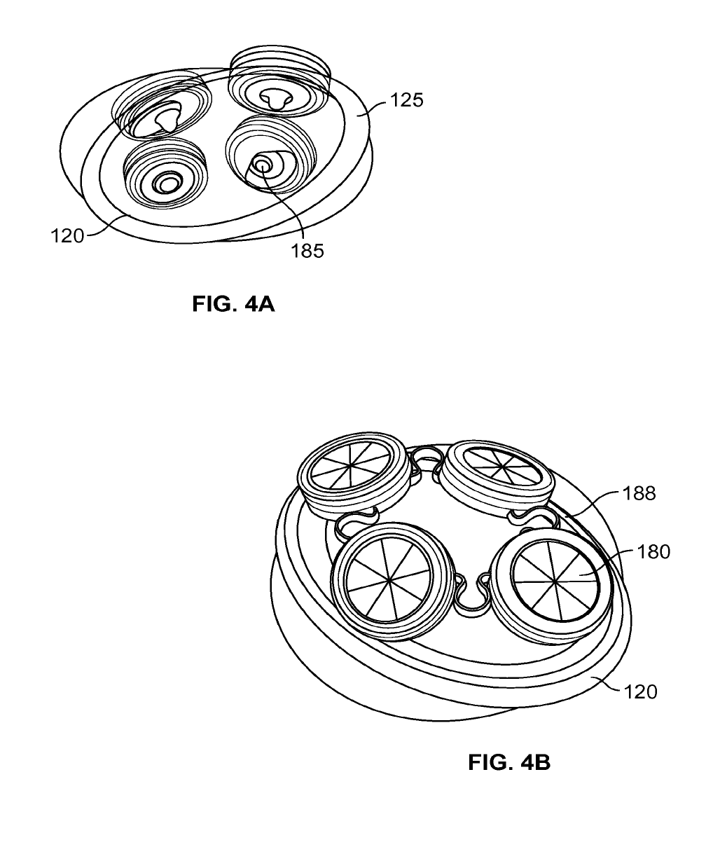

FIGS. 4A and 4B illustrate views of a suction chamber 120 and vibratory motors 180 according to an embodiment. FIG. 4A depicts a view of the interior of suction chamber 120 and depicts stimulating features 185 coupled to vibratory motors 180. When tissue is drawn into suction chamber 120, stimulating features 185 transmit vibratory energy generated by vibratory motors 180 to the tissue. Stimulating features 185 may have a variety of shapes, textures, and configurations. Stimulating features 185 may be different in a single device and may be interchangeable, replaceable, and customizable. FIG. 4B depicts a view of the outer surface of suction chamber 120 and illustrates the arrangement of vibratory motors 180.

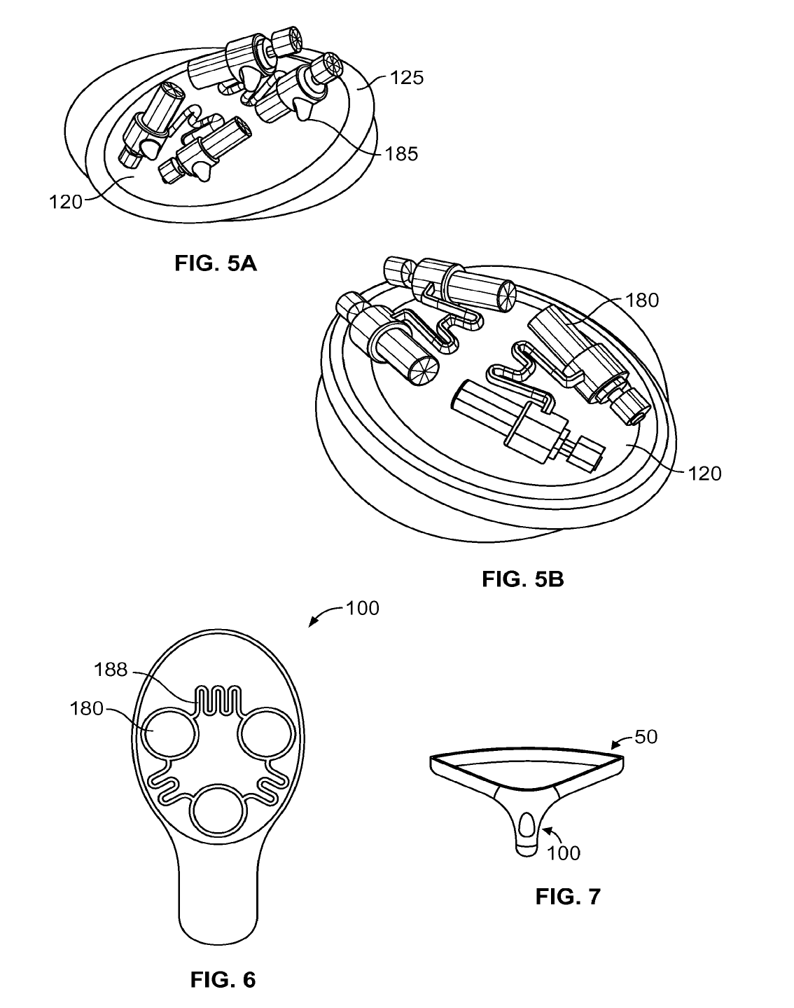

FIGS. 5A and 5B illustrate the use of suction chamber 120 and miniature vibratory motors 180 according to an embodiment. In this embodiment, miniature vibratory motors 180 are cylindrical in contrast to the disk-like miniature coin-style motors. Vibratory motors 180 are coupled to stimulating features 185 to transmit vibratory energy to tissue.

FIG. 6 illustrates a view of a device according to an embodiment. Stimulators 180 are spaced apart by isolating arms 188. Isolating arms 188 provide a sub-assembly in which stimulators 180 can be assembled. Isolating arms 188 function to isolate the vibrational energy of one stimulator from another stimulator. This is useful in circumstances where the stimulators are activated at different times and/or at different frequencies and/or at different amplitudes. By isolating the vibrational energy generated by one motor from the vibrational energy generated by another motor, it is possible to simulate macroscopic motion around or on tissue. FIG. 6 depicts one type of vibration isolation, but other types and their equivalents are within the scope of this disclosure.

FIG. 7 illustrates a view of the device 100 and an embodiment of a garment 50. In this embodiment, garment 50 is a simple strap or belt that connects to device 100 and helps maintain its position on the body of the user. In certain embodiments, garment 50 is optional as device 100 is configured to maintain its position on the body primarily via suction. However, it is understood that for some users an additional means of maintaining the position of device 100 may be desirable. Further, it is understood that device 100 may be configured to be attached or could be otherwise integral with other garments including lingerie or other women's intimate apparel. Jewelry with functional elements that stimulate other areas of the skin can be used to increase arousal. Such functional elements can be one or more of air blowing across the skin, stroking of a soft element, application of slight warming or cooling.

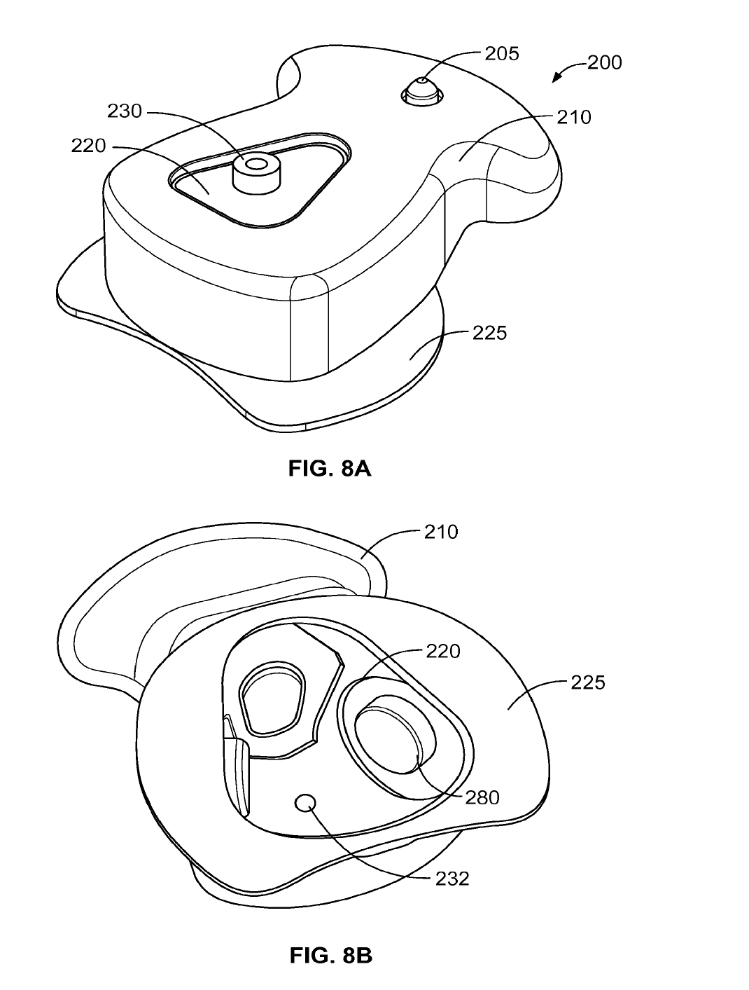

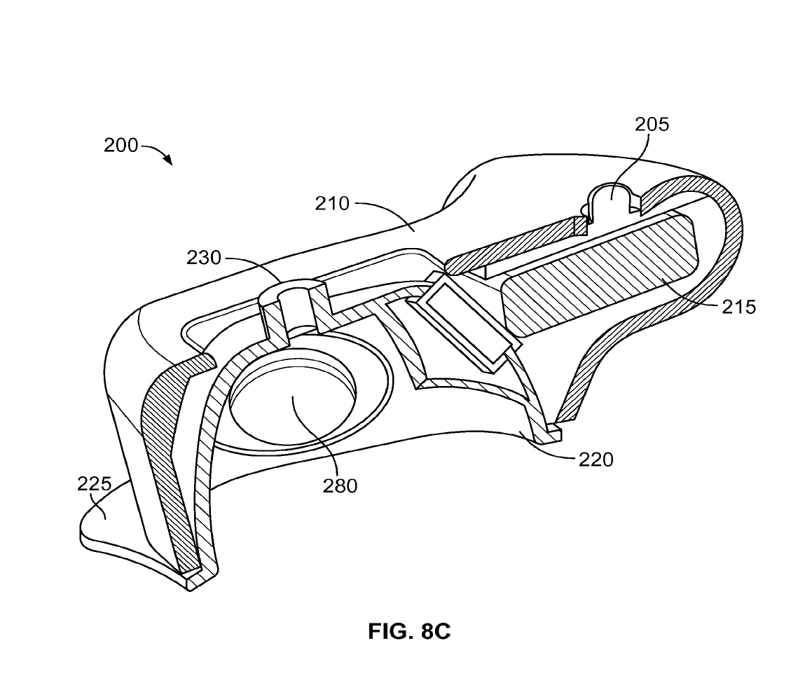

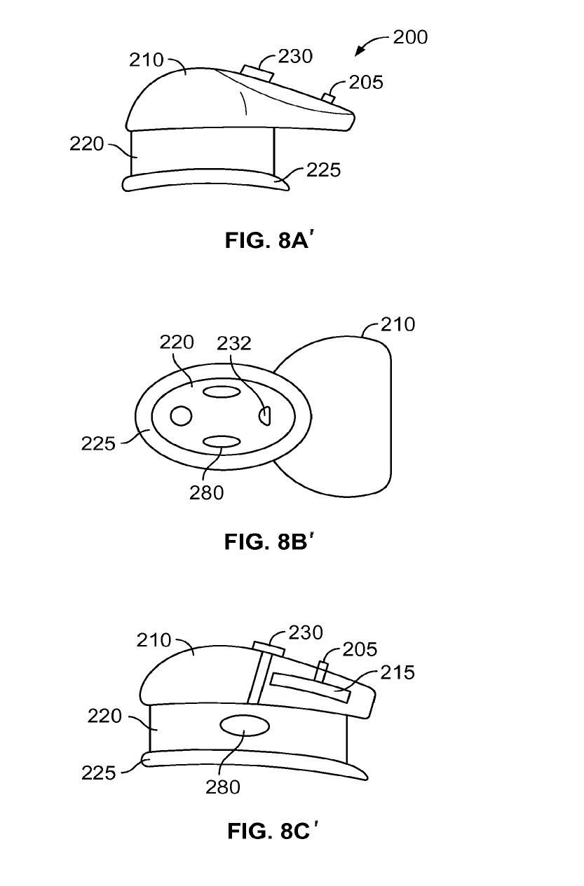

FIGS. 8A, 8A′, 8B, 8B′, 8C, and 8C′ depict a device 200 according to an embodiment. Device body 210 includes suction chamber 220. Suction chamber 220 includes sealing and stabilization flange 225, having a sealing edge 226, which is adapted to provide a substantially airtight seal against tissue. Suction port 230 provides fluid communication between the interior of suction port 220 and a suction device (not pictured). Device body 210 includes a user control area, which in this embodiment includes activation button 205. It is understood that the user control area may contain multiple control inputs. Further, the device 200 may be controlled remotely. FIGS. 8B and 8B′ illustrate a bottom view of device 200 and depicts the interior of suction chamber 220. Multiple stimulators 280 are coupled to the inner walls of suction chamber 220. Suction inlet 232 includes a check valve or other one-way valve connecting suction port 232 to the interior of suction chamber 220. FIGS. 8C and 8C′ depict a cutaway view of device 200 and illustrates, in addition to the features already described, controller block 215. Controller block 215 is electronically attached to the user control area and/or remotely controllable by a remote control device via an antenna. Device body 210 provides a safe, reliable, and comfortable protective barrier, which protects the electronics in controller block 215.

Suction ports can connect to suction devices using various types of fluid connectors, including but not limited to snap fittings, quick-release fittings, screw fittings, luer lock fittings, push-in fittings, magnetic couplers, and their equivalents.

Device body 210 includes a firm but flexible shell, which houses electronics and couples the electronics to suction chamber 220. Device body 210 may further include a charging port to recharge the power source included in controller block 215. Activation buttons present in the user control area may be recessed or otherwise made comfortable, safe, and reliable.

Sealing flange 225 may include soft, flexible, compliant material, such as silicone, gel or closed cell polyurethane foam, and may optionally be mildly adhesive to tissue or may be adapted to contain an adhesive material. Also, the foam or other material could contain a lubricant that serves to fill gaps in the seal between the sealing flange and tissue. Other structures, such as filaments structures like velour or corduroy or other woven or non-woven fabrics can be used at the sealing flange in conjunction with adhesives and/or lubricants to provide a secure fit and help minimize leak paths. In some embodiments a fabric used in the sealing flange may be moisture responsive such that it “clings” or otherwise forms a close bond with skin and mucosa when the fabric becomes wet. The moisture may come from the user's body or may be applied in the form of lubricant, adhesive, or simply water or saline.

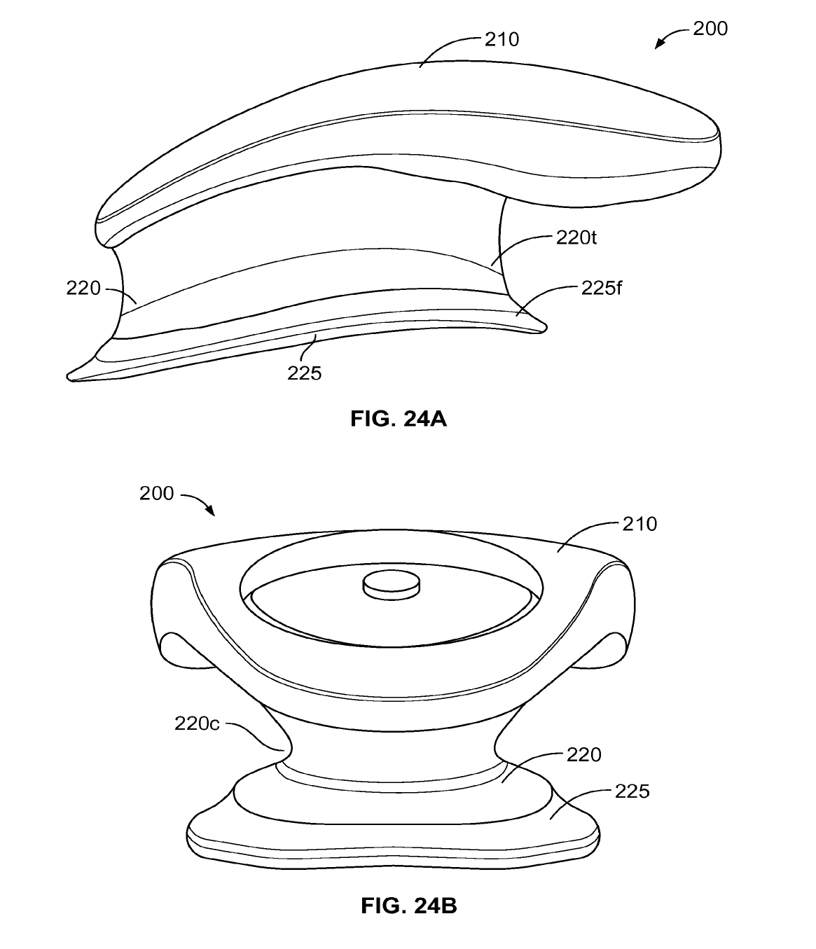

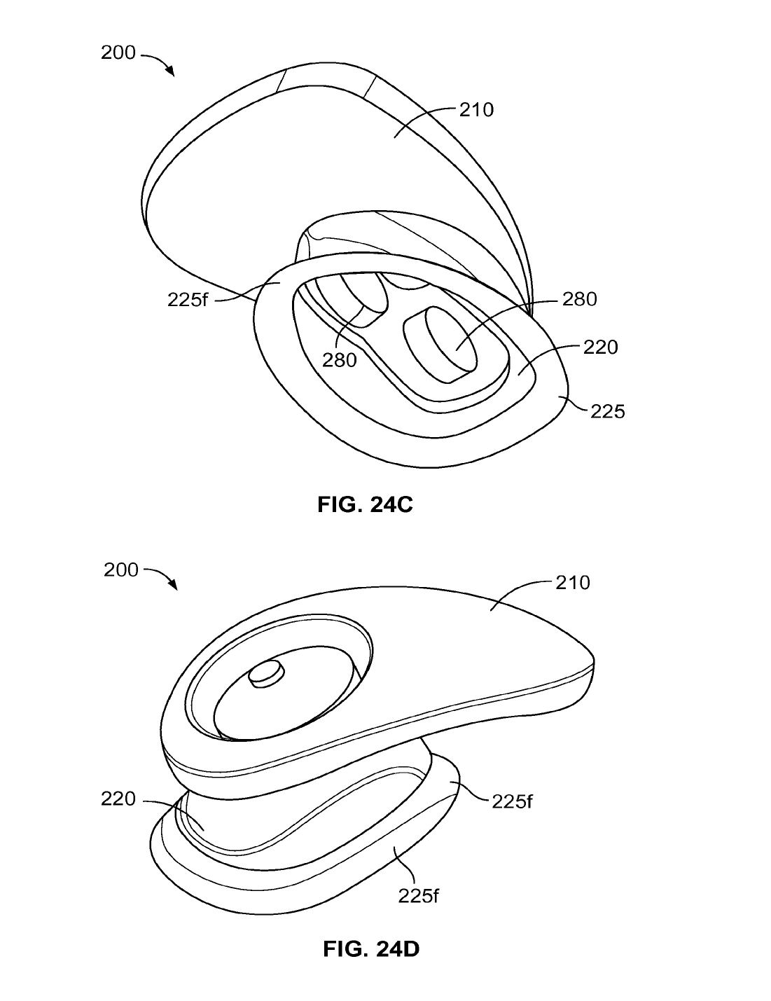

FIGS. 24A, 24B, 24C, and 24D illustrate different views of device 200 according to another embodiment. Device 200 includes device body 210, which can house controller circuitry, and suction chamber 220. The controller circuitry can be accessed using an interface mounted on device body 210 and/or via a remote controller.

The remote controller can be physically tethered to device body 210 or it can be wirelessly connected. Suction body 220 includes sealing and flange 225, which is adapted to provide a substantially airtight seal against tissue. The various views of FIGS. 24A, 24B, 24C, and 24D illustrate certain features of the shape and form of device 200 which promote comfortable, discreet, and secure attachment of device 200. For example, device 200 is sized such that the attachment area, defined by area where sealing flange 225 meets suction chamber 220, fits between the labia majora inferior to the clitoris and device body 210 may exit the labia majora superior to the clitoris. Further, the taper of the upper section of suction chamber 220 facilitates comfortable, discreet, and secure fit. The curve of device body 210 can help device 200 conform to the user and allow discreet placement inside garments.

Specifically, the front section 225f of sealing flange 225 is placed superior to the clitoris and tucked under the anterior commissure of the labia majora. In that position, the labia majora inferior to the anterior commissure can snugly engage the tapered section 220t of suction chamber 220 such that substantially the entire front and lateral portions of the sealing flange 225 are tucked under the labia majora. Advantageously, the tapered section 220t of suction chamber 220 allows the labia majora to comfortably engage a comparatively narrower section of the device while vaginal tissue superior to the vaginal orifice engages the comparatively wider sealing flange 225.

Proper placement of device 200 can be easily and repeatably achieved by following a few steps. For example, when a user first attempts to place the device, they may benefit from the use of a mirror such that the user's head and shoulders are propped up and they can use the mirror to observe themselves placing the device. The user can open their outer labia so that they can see their inner labia and the hooded glans of the clitoris. Users can identify a groove within their outer labia that runs along the inner labia at the bottom and the hooded clitoris at the top. Device 200 can be effective when the sealing flange 225 is centered over the clitoris and the comparatively soft edges of the sealing flange 225 fit into the groove. In some cases the user can tug their outer labia to make space for the outer ring to fit snugly in the groove. The vibratory motors can then fit snugly around the glans of the clitoris. In some instances, the user can apply an amount of a lubricant (such as a water-based lubricant) to coat their inner and outer labia, the glans of the clitoris, the hood of the clitoris, and the comparatively soft edges of the sealing flange 225. The user can activate the vibratory motors at a relatively low power setting to help place the device. By using the sensation from the low power vibrations as a guide, the user can ensure that the clitoris is placed snugly within the space defined by the inner portions of the vibratory motors. In some cases, the user can apply stimulation with their inner labia separated. A properly placed device will be high enough on the user's vulva to effectively cup the clitoris and not block the urethra or the vaginal opening.

In certain embodiments, multiple vibratory-disc, or miniature coin-style, motors are embedded in the wall of a flexible suction chamber. In certain embodiments, the motors are embedded in a flexible membrane, which is attached to the walls of the suction chamber. When suction is applied, tissue is brought into contact with the stimulator. The motors can be controlled by controller circuitry to produce one or more of the following patterns: (i) all on; (ii) clockwise; (iii) counter clockwise; (iv) up-down; (v) lateral; (vi) all pulse; (vii) selected motor pulse; (viii) gradients in frequency; and (ix) gradients in amplitude. The translation of the vibratory pattern and spatial isolation of the motors may produce a desired effect of simulating macroscopic motion without incorporation parts that actually move in macroscopic dimensions. Stiffening members may be added to the motor mounts to vary and/or isolate vibration. The inner surface of the membrane may be textured to transmit vibration to tissue. The flexible membrane reduces or eliminates the coupling of the motor vibration to the device housing and increases or maximizes energy delivery into the tissue.

In one embodiment depicted in FIG. 3B, patterns are created by three vibratory motors. For example, rotational patterns (clockwise or counter clockwise) are created by first activating motor 180a and then activating motor 180b and then activating motor 180c. After a motor is activated it can be completely deactivated or have its power reduced such that a pattern of higher power vibration rotates around the array of motors. As another example, a V pattern of vibration is created by simultaneously activating motors 180a and 180b, then deactivating both, and then simultaneously activating motors 180a and 180c and then deactivating both. The V pattern can then be repeated. As another example, a lateral pattern is created by alternating activation and deactivation of motors 180b and 180c while motor 180a remains deactivated. As another example, a lateral pattern is created by alternating activation and deactivation of motors 180b and 180c while motor 180a remains activated.

The patterns described above and equivalent patterns can be created by arrays with more than three motors. Rotational patterns, lateral patterns, vertical patterns, and combination thereof can be created by selectively activating and deactivating motors. All such patterns are within the scope of the invention disclosed herein regardless of the number of motors. Further, in embodiments herein in which vibratory motors are depicted as providing the stimulation, other stimulators can be used in place of or in addition to the vibratory motors. That is, one or more of the vibratory motors can instead be an electrical stimulator, temperature stimulator, or other stimulator.

In certain embodiments, multiple vibratory motors create resonance or diphasic amplification. Resonant or diphasic amplification patterns may be advantageous because they may create unique vibratory patterns that would be difficult to achieve with a single vibrating source, and they may create amplification in vibratory power that exceeds the capability of a single motor. Such amplification may be useful in the case of certain electrical power or space constraints. Resonance or diphasic amplification created through the use of multiple vibratory sources may employ different sources including rotary motors, linear motors, and piezoelectrics. The combination of multiple sources may create a large range of customizable and selectable resonant patterns. Further, motors of different sizes and/or power can be used to create multiple resonant frequencies to amplify the vibration effect.

Multiple, isolated and independent motors may combine to produce diphasic amplification or resonant patterns and/or may simulate macroscopic motions. Transitions between motors are smoother with sine wave than square wave. Optimizing the timing and the amplitude of the motion during transition improves the “organic” feel of the stimulation. Preferably, multiple small motors are used to provide easily-differentiated stimulation and simulation of macroscopic motion. Small eccentric motors placed on edge provide a focused vibration point, which promotes differentiation among several vibration sources. Slower vibration transitions promote differentiation among several vibration sources as compared to more rapid transitions.

In certain embodiments, devices provide macroscopic motion in addition to, or instead of, simulating macroscopic motion.

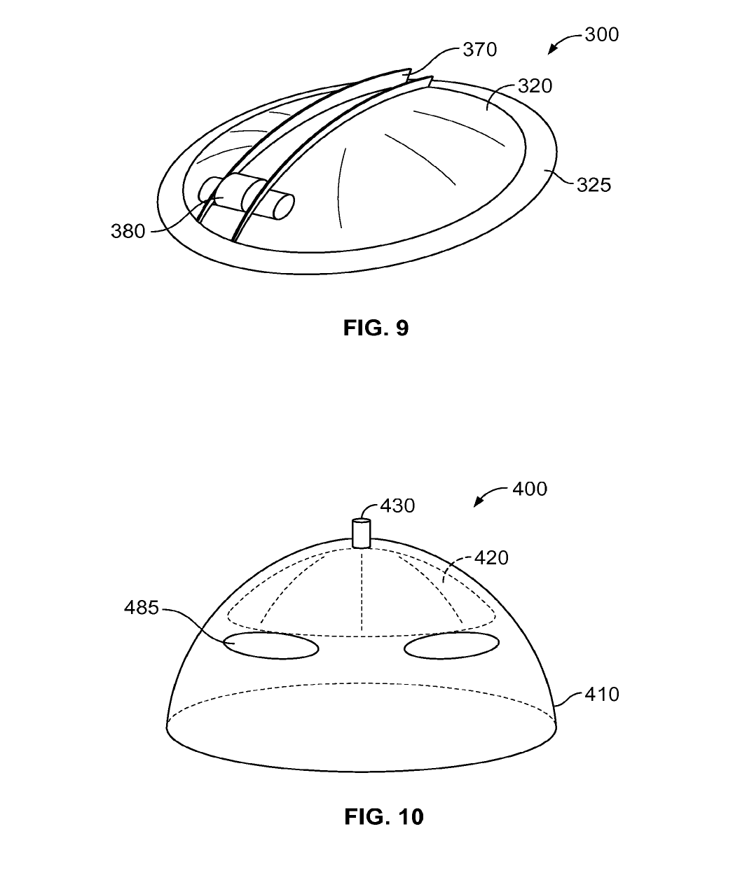

FIG. 9 depicts a device 300 that provides macroscopic motion according to an embodiment. Device 300 includes suction chamber 320 and sealing edge 325, which are both configured to engage tissue as described herein. In this embodiment suction chamber 320 is flexible and deformable such that motor 380 deforms suction chamber 320 as it traverses suction chamber 320 via rails 370. Motor 380 may be coupled to a cylinder or may itself be a cylinder, which rolls, slides, or otherwise moves along rails 370. The motion of motor 380 across suction chamber 320 simulates a stimulating stroking motion and promotes blood flow and/or clitoral engorgement. Suction chamber 320 includes a suction port (not pictured), which is used similar to suction ports described herein and includes a check valve or other one-way valve to maintain suction in the chamber. Motor 380 may vibrate in addition to traversing rails 370 and thereby provide both a stroking motion and a vibratory motion.

FIG. 10 depicts an embodiment of a device 400 providing macroscopic motion according to an embodiment. Device 400 includes device body 410 and dome 420. Dome 420 is configured to rotate with respect to device body 410 about an axis central to both device body 410 and dome 420. Stimulating features 485 are coupled to dome 420. Suction port 430 operates to provide suction to the interior of device body 410 to draw tissue into contact with stimulating features 485. A motor (not pictured) drives the rotation of dome 420 with respect to device body 410 and rotates stimulating features 485 about the clitoral tissue drawn into the interior of device body 410. Stimulating features 485 may also be driven by vibratory motors to provide both a stroking motion and a vibratory motion.

Alternately, the motion of the dome may be driven magnetically. For example, dome 420 may include a single offset magnet. Device body 410 may include several electromagnets, which are individually addressable by a controller. The motion of the dome can be driven by selectively charging each electromagnet in a sequence or pattern.

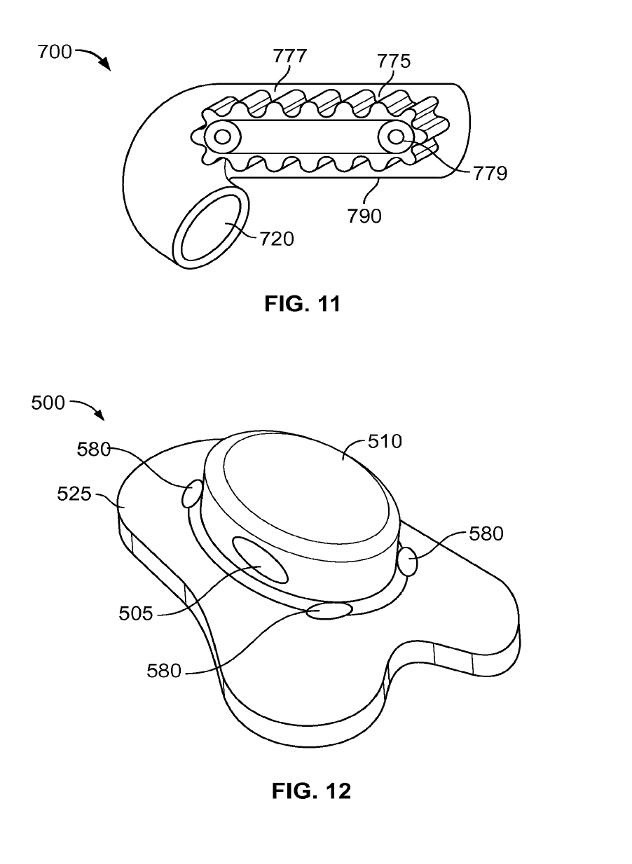

FIG. 11 depicts one embodiment of a device 700 in which a moving tread 775 under a stationary membrane 790 provides macroscopic motion for stimulation. The moving tread 775 is housed under a thin membrane 790, which is compliant and flexible and moves with features on the tread. The tread 790 has raised regions 777 spaced apart from each other at physiologically-relevant spacings. The tread rides on two or more rollers 779, at least one of which is powered to cause the tread to rotate.

FIG. 12 illustrates a device 500 according to an embodiment. Device body 510 is attached to flange 525, which is configured to maintain a substantially airtight seal against tissue. The tissue-contacting surface of flange 525 may include a mild adhesive, and/or an adhesive substance may be applied to the tissue-contacting surface of flange 525. Optionally, a lubricant and/or an exothermic substance may be applied to the tissue-contacting surface of flange 525. Flange 525 is flexible and conformable and adapted to provide a reliable and comfortable anatomical fit. Device body 510 includes a suction chamber (not pictured) capable of drawing tissue into its interior. Device body 510 includes vibratory motors 580 capable of delivering spatially-isolated vibration to tissue. Device body 510 included activation button 505 in a user-accessible location, such as on the side of the exterior of the suction chamber.

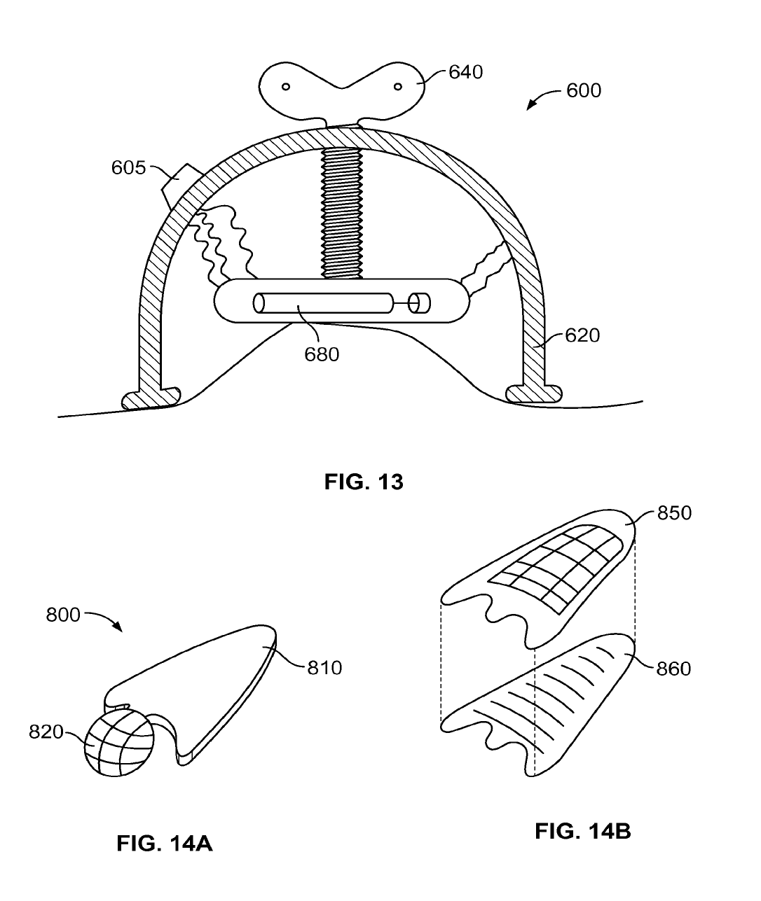

FIG. 13 illustrates a device 600 according to an embodiment. Device 600 includes suction chamber 620, which is configured to apply suction to tissue through a suction port or other mechanism as described herein. Device 600 includes a stimulator 680 and power source such as a battery. Stimulator 680 is suspended from suction chamber 620 via an adjustment arm 640. Adjustment arm 640 allows a user to precisely and repeatably control the force of contact between stimulator 680 and tissue. Device 600 includes an activation button 605 and can include remote control capabilities via an onboard antenna. Alternately, the adjustment arm can be electronically controlled, such as by applying current through a nitinol arm to control the position of the motor relative to tissue.

FIGS. 14A and 14B illustrate one embodiment of a device 800, which includes a thin flexible membrane 810 designed to deliver a pulsating wave along its length. A flexible electronic controller 850 drives one or more flexible actuators 860 that are at least partially encapsulated in the thin flexible membrane 810. The flexible membrane may have a curved configuration that defines an internal chamber. Suction can be applied to the internal chamber through various mechanisms, including a deformable suction chamber 820 attached to the membrane 810. Optionally, when the membrane is exposed to air a mild exothermic reaction occurs to further stimulate blood flow.

In one embodiment of the device, the device could create a sweeping wave motion. The speed and amplitude of the wave is variable, selectable and adjustable in real time. The wave motion can also be used to deliver therapeutic substances directly to the genital region. The substances can be stored in the polymeric adhesive region or immediately behind the adhesive region. The mechanical displacement algorithm or, alternately, an algorithm focused on delivery, could be used to meter out drug at the desired rate. Thin-film actuators include shape memory polymers and metals, ferroelectric thin films, polymer thin films, piezoelectric films, polymer/metal composites, and combinations thereof. Light or electromagnetic radiation can be used to power the actuators.

In certain embodiments of the invention, wave motion can be achieved by sequentially charging regions of the thin-film actuator. As each region is energized, that region undergoes a conformational change that causes a local displacement of the structure. Various temporo-spatial patterns can be created to stimulate a stroking motion. Alternatively, some regions may be made to vibrate all other regions provide a simulated stroking motion. The thin-film may be electrically activatable polymer, a piezoelectric material, shape memory polymer, a shape memory metal, or composite material containing one or more of the following materials: metals, polymers, particles, strips, charge elements, water, salt, bases, acids, etc. In some embodiments, the thin film actuator is formed from graphene, which is capable of being driven by current to deliver vibration stimulation, simulated macroscopic motion, and/or macroscopic motion.

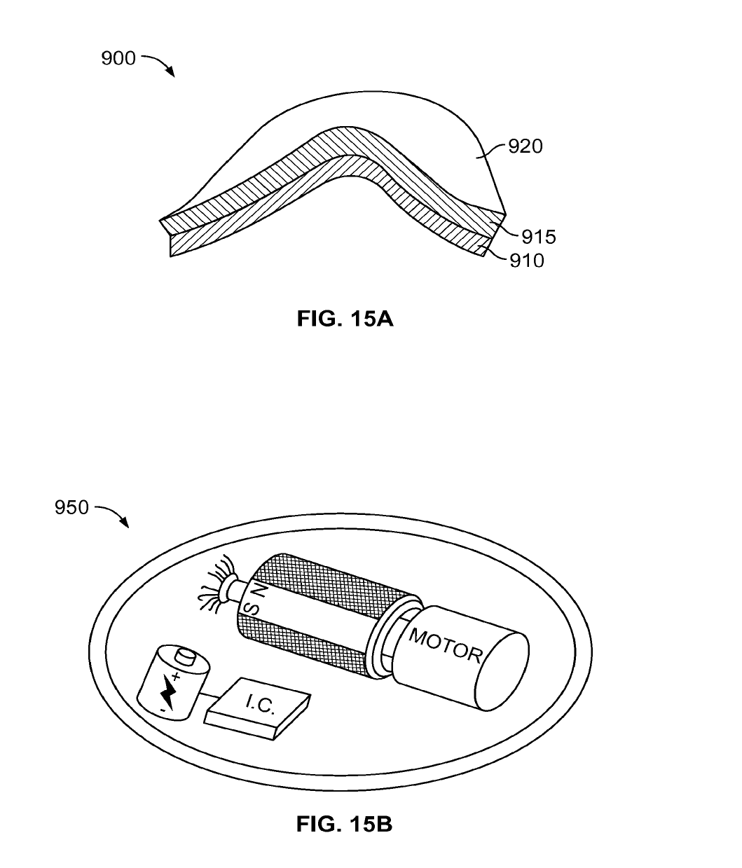

FIGS. 15A and 15B illustrate an embodiment including a magnetically coupled thin-film actuator 900 and controller 950. The thin-film actuator 900 is applied to the clitoral hood and the controller 950 is placed into the vaginal vault. The controller 950 delivers a variable wave electromagnetic energy to the thin-film actuator 900, causing the actuator to vibrate. If the electromagnetic energy is provided by a rotating magnet, the magnet may be eccentric in weight. Such eccentricity allows for local vibration or may also be weighted such that only the thin-film actuator is vibrated. The thin-film may be disposable and comprised of other magnetically adherable material. The controller may be onboard the device or maybe remote. The density of the magnetic element allows for variable focus of actuation along the surface. There may be an adhesive layer 910, such as a mildly adhesive polymer layer, to adhere to tissue. The vibration is caused by electromagnetic activation of magnetic layer 915, which resides between adhesive layer 910 and surface layer 920. The controller includes a rotary magnet, a motor, circuitry, and the power source such as a battery. The controller may be encapsulated for safety, reliability, and comfort.

In another embodiment, a controller may be placed in an interior space of the vagina and physically tethered to a device placed about the clitoris. The controller and the device may be connected using a malleable connector to allow comfortable or tolerable positioning of the device. Advantageously, by moving the relatively heavier control and power components from the clitoral device to the vaginal device, the clitoral device may be more comfortable and wearable. The vaginal device may also include stimulating features such as vibrational motors.

FIG. 16 illustrates an embodiment of device 1100 in which a stimulator 1180 is in contact with the top or anterior surface of a suction chamber 1120. Device 1100 includes flange 1125, which provides a substantially airtight seal with tissue while being reasonably comfortable and wearable. Suction chamber 1120 draws tissue into its interior using a separate suction device or by deformation of the suction chamber prior to the device 110 being placed in contact with tissue. When tissue is drawn within suction chamber 1120, stimulator 1180 (or more than one stimulator) may be used to stimulate clitoral tissue. Stimulator 1180 (or motors) may be controlled via a user control area on device 1100 or remotely.

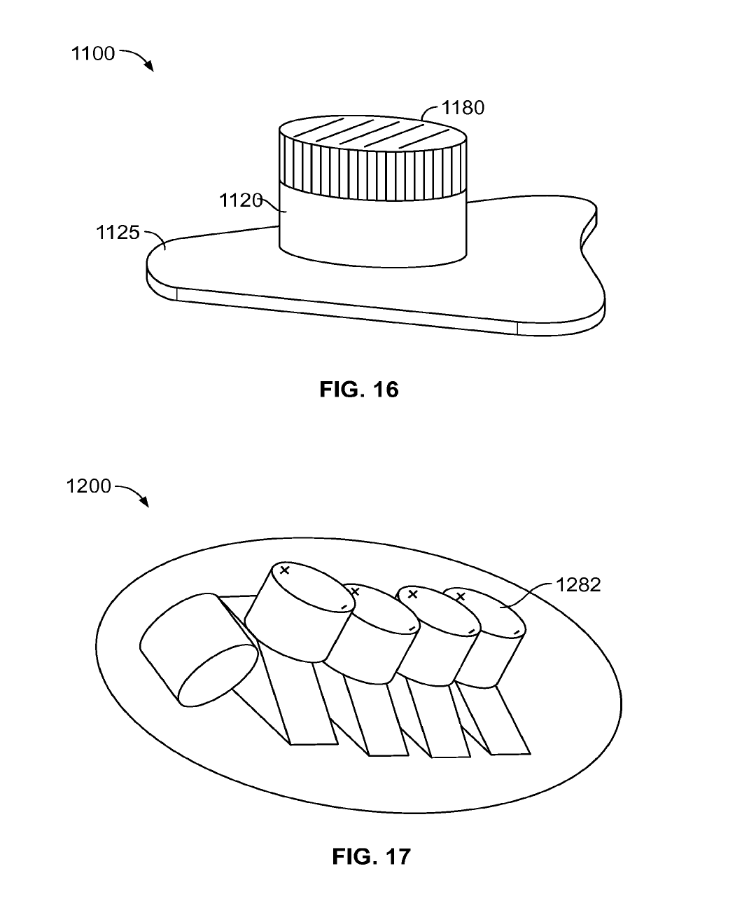

Certain embodiments of the invention take advantage of a wide spectrum of input, wider than the input available from certain prior art devices. For example, input may include complex waveforms such as literal music, or superimposed waveforms that make up a type of “song.” The multiple oscillations of a “song” can produce a desired mechanical effect on the actuators in contact with tissue. The location or spatial placement of these “songs” could be distributed differentially across the target tissue surfaces to produce enhanced effects. For example, some regions may be more optimally stimulated through low-frequency patterns in other areas through higher frequency patterns. High amplitude patterns in combination with variable mid to high vibrations are also possible. By adjusting these effects spatially, the simulation of manual stimulation, lingual stimulation, or intercourse may be achieved. Multiple stimulation signatures are available to the user to produce different effects. Nominally, some tissue may respond more to a simulated “rubbing” effect and others to a more cyclic “depression” or thumping effect. The “songs” may be downloadable to a remote player or to the device itself through web-based media marketplaces, such as iTunes. FIG. 17 illustrates a device 1200 that includes an array of acousto-mechanical drivers 1282, or voice coils (e.g., “speakers”) to create a variable assortment of stimuli across the surface. Each driver 1282 is individually addressable by a controller to generate the complex waveforms and patterns of stimuli described herein.

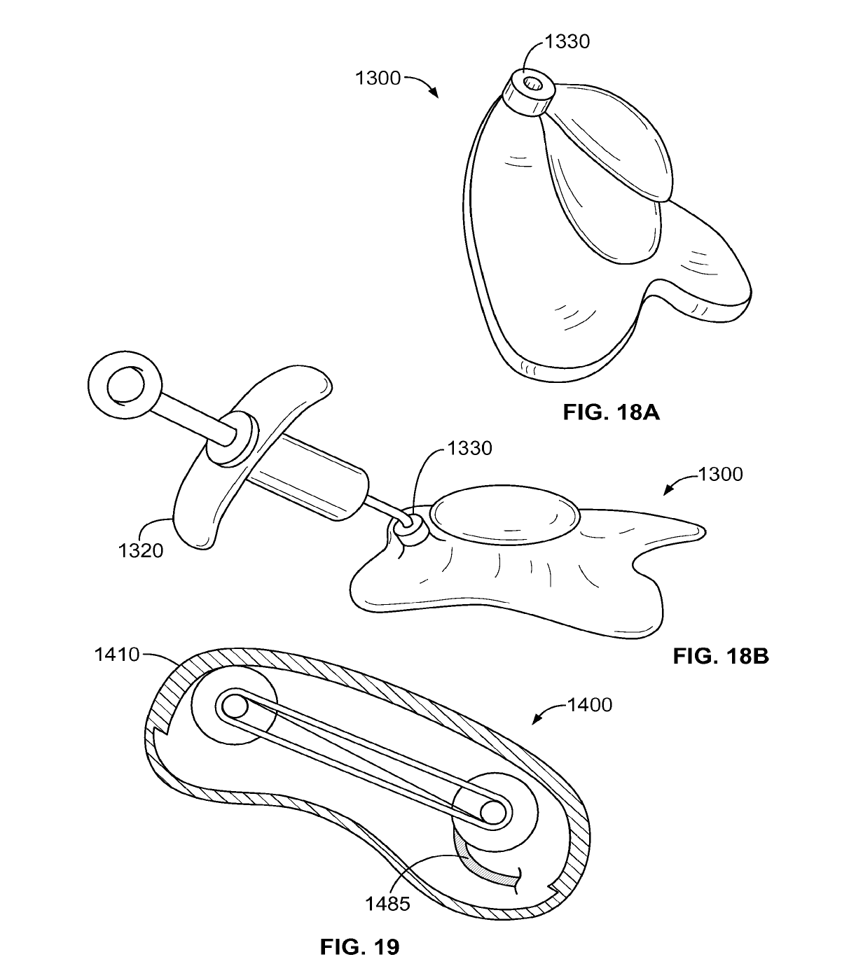

FIGS. 18A and 18B illustrate the interaction of a device 1300 and a separate suction device 1320. The combination of device 1300 and suction device 1320 provide a kit for use according to embodiments described herein. Device 1300 includes a suction port 1330 that is in fluid communication with the interior of a suction chamber (not labeled) on device 1300. Suction device 1320 is depicted as a syringe-type suction device but other suction devices are within the scope of this disclosure. A separate suction device allows for the precise, repeatable, and reliable application of suction and as well as discreet and comfortable wearing of device 1300.

FIG. 19 illustrates an embodiment of device 1400 in which a stimulating feature 1485 is driven by a motor housed within a device body 1410. Device 1400 is placed in contact with clitoral tissue by suction means described herein or by placing the device in close contact with tissue via a garment or garment-like apparatus. Stimulating feature 1485 provides macroscopic motion to stimulate engorgement of the clitoris by providing a more natural stroking and/or lingual motion as compared to a vibratory motion. Device 1400 may include one or more stimulating features.

In certain embodiments, the controller is designed to map the user's motions on a control surface to the tissue-contacting surface of the stimulating part of the device. By pressing their fingers on the control surface, the user can create various levels of pressure a vibration in the corresponding location on the tissue-contacting surface. As the user moves their fingers across the control surface and optimally desired way, a sequence of motions, pressures, vibrations, and/or stimuli that mimic these actions are created on the tissue-contacting surface. These movements and inputs can be stored either locally on the device or a controller level and played back when desired to create desired effect without requiring the user to repeat their input pattern.

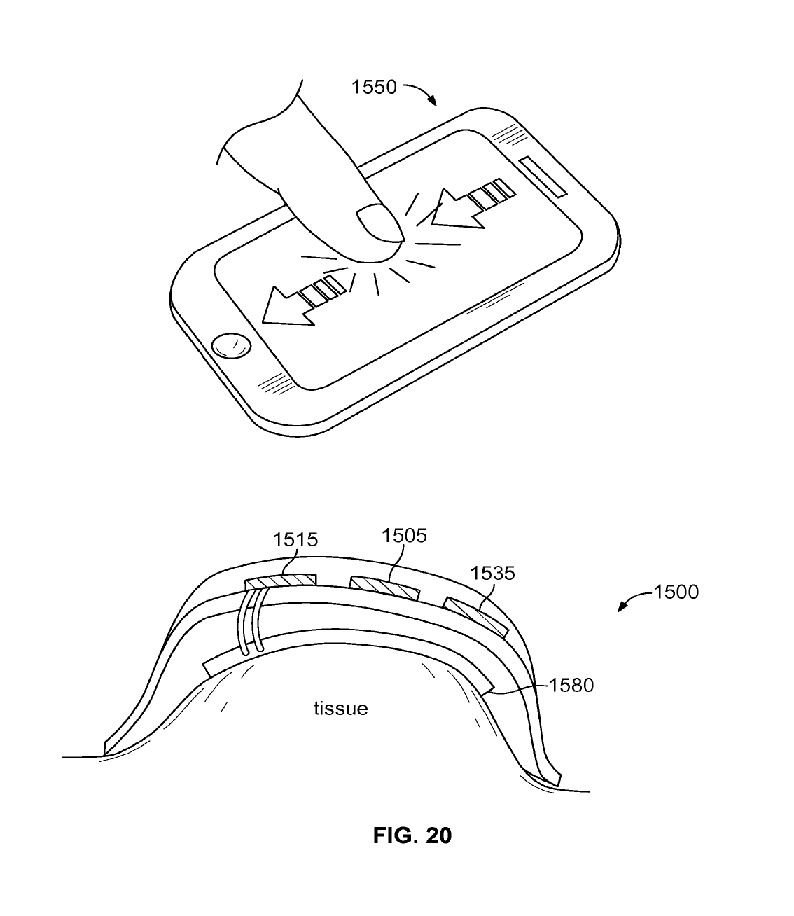

FIG. 20 illustrates an embodiment of a device 1500, which can be remotely controlled by a touchpad device 1550 to provide precise and customizable stimulation. Touchpad device 1550 may be a smartphone or other equivalent device. Device 1500 includes electro-active layer 1580, which directly contacts tissue or contacts tissue through a thin membrane. Tissue is drawn into contact with electro-active layer 1580 through methods described herein. Device 1500 includes a power source 1515, a local controller 1505, and an antenna 1535. Electro-active layer 1580 is configured to mimic the motion and pressure applied by the user's finger on the touchpad device 1550 to the clitoral tissue within device 1500.

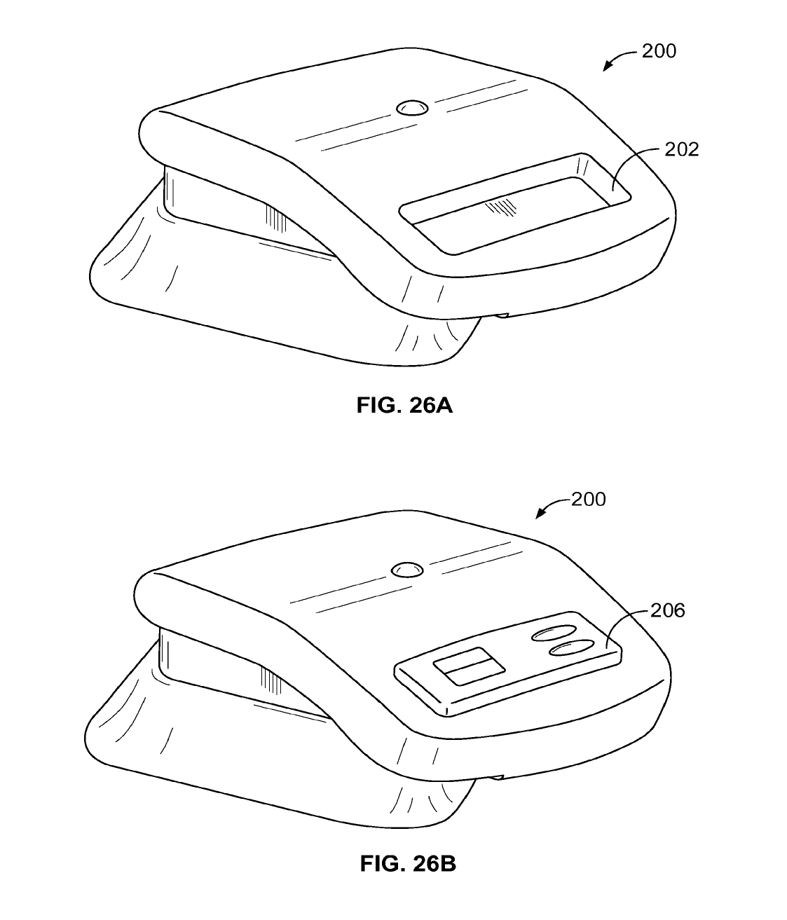

In certain embodiments, a remote controller is a controller configured to send radio-frequency signals to the device worn by the user. The controller may be sized similar to a key fob remote control commonly associated with automobiles. A key fob styled remote can include several buttons capable of controlling the full range of functions of the device discussed herein. FIGS. 26A and 26B illustrate a key fob styled remote controller 206 and device 200, which includes a complementary housing space 202 such that the remote 206 can be docked with the device and housed there when not in use or even when in use. In general, the controller circuitry can include a circuit board, amplifiers, radio antennae (including Bluetooth antennae).

Devices using low power Bluetooth or other radio antennae may experience dropped connections when the remote/device pair is separated by distance or by a physical obstruction (such as a user's or partner's body). In such cases, it is desirable for the device to remain operating under its pre-drop operating conditions while the remote attempts to automatically pair again with the device. Said differently, it is undesirable to require the user or partner to have to manually re-establish the Bluetooth pairing between the remote and the device if the pair connection is lost during device use. And, it is undesirable for the device to cease operating under its existing pre-drop conditions if a pair connection is lost. Thus, certain remotes are configured to automatically re-establish the pair connection with the device without requiring user intervention.

In situations where the remote automatically re-establishes the pair connection with the device, it can be important for the remote to query the device for the current device operating conditions. That is, since the device has maintained a state of operating conditions when the pairing was lost, it is desirable that the remote not interrupt the device operating conditions when the pair connection is re-established. As a counter example, in some Bluetooth pairings, after the pair connection is established the “master’ controller will send a reset signal to the “slave” device. Such a reset would be undesirable in the circumstance where a device is operating under a given set of parameters, patterns, or programs because those parameters, patterns, or programs would be interrupted by the reset signal. Such an interruption could be detrimental to the user experience.

In certain embodiments, the controller is physically tethered to the device worn by the user. The tether can include electrical connection as well as a fluid connection to provide suction to the suction chamber on the device.

In certain embodiments, the stiffness of parts of the device, such as the suction chamber, an arm suspending a vibratory motor, or stimulating feature, can be controlled by moved a stiffening member, such as a stylet, in or out of a receiving lumen in the part whose stiffness is being controlled.

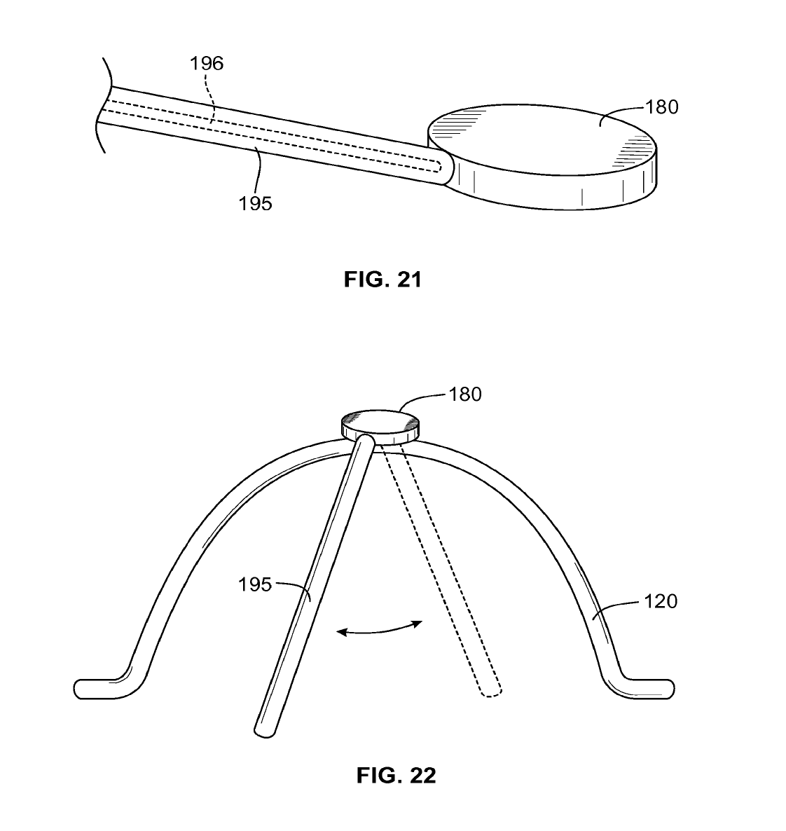

FIG. 21 illustrates an embodiment of a device in which stimulator 180 is coupled to the end of lever 195. Lever 195 has an interior receiving lumen for receiving a stiffening stylet. By stiffening lever 195, which may be attached to a device body, or to a suction chamber such as the chamber pictured in FIG. 13, the stimulator 180 may be made to more firmly engage tissue. FIG. 22 depicts an embodiment in which lever 195 is coupled to oscillating motor 180, which is attached to suction chamber 120. Lever 195 is driven to have a larger motion at its far end relative to the smaller motion of oscillating motor 180. In such an embodiment, lever 195 provides the sensation of macroscopic motion using the relatively small motions of the couple motor.

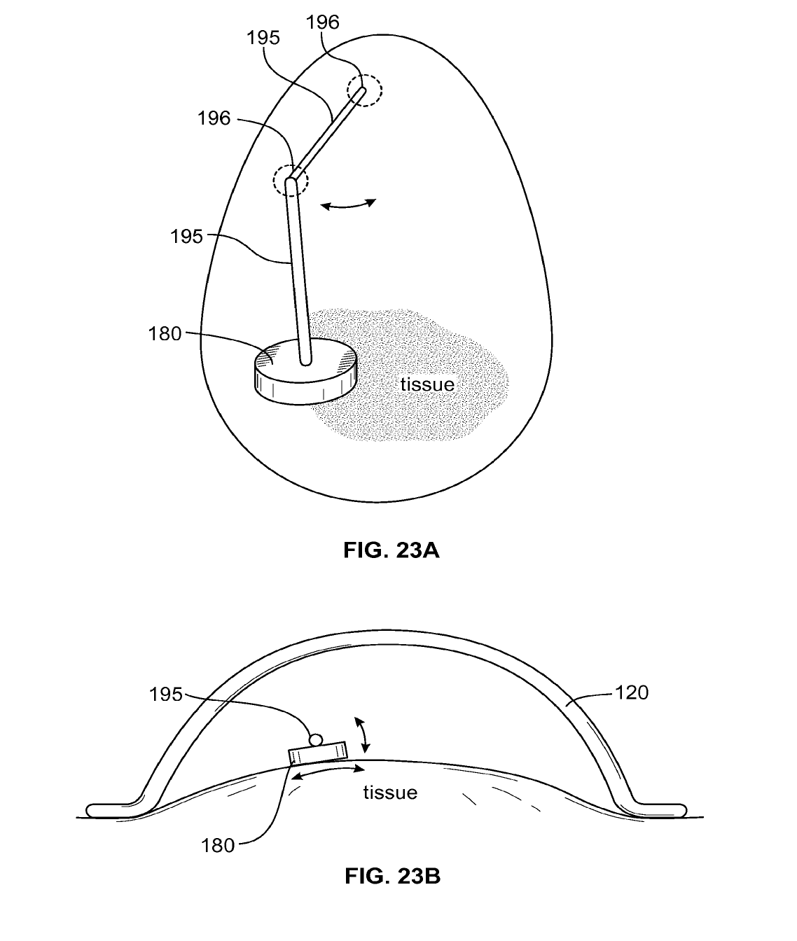

FIGS. 23A and 23B depict an embodiment in which a stimulator 180 is mounted within suction chamber 120. FIG. 23A depicts a sectional plan view and illustrates a mechanism including two levers 195 and two pivot points 196. The pivot points and levers cooperate to sweep stimulator 180 across the target tissue. While the mechanism is depicted with two lever and two pivot points, other combinations of mechanical elements are possible provided that they generate a controllable sweeping or stroking motion across the target tissue. FIG. 23B depicts a sectional end view, which illustrates stimulator 180 as both sweeping across tissue and pivoting about the longitudinal axis of lever 195. In certain embodiments, the pivoting motion is passive and conforms to the shape of the tissue to maintain substantial contact between stimulator 180 and target tissue. In other embodiments, the pivoting motion is actively controlled and can be used to deliver more stimulating force to target tissue. For example, as described herein, miniature coin style motors with an eccentric mass deliver more force when placed edge-on to tissue. By actively pivoting the motors, differential force effects can be achieved. Pivot point 196 may also be passive or active in the sense that they may be motors capable of driving the sweeping motion or they may be comparatively simple joint that allow the motor to be swept across tissue by a driving force at one of the points or within the case of the device.

Some of the embodiments of the device deliver suction to engorge and stiffen the tissues and vibration to provide stimulation to the region. In other embodiments, the device delivers suction to engorge and stiffen the tissues and electrical or neural stimulation provides stimulation to the region. In other embodiments, warming or cooling is applied, including light or infrared energy (e.g., near infrared light emitting diodes), instead of vibration or electrical or neural stimulation or in combination with those stimulation types. The stimulation source preferably is in intimate contact with the tissue to optimize energy transfer.

The mounting of the vibration sources may also allow for isolation so that there is spatial differentiation between sources and minimal diffusion of vibratory energy to adjacent structures in the device or tissue. Mounting stimulators on a flexible membrane which travels with the tissue as it becomes engorged with suction may accomplish these goals. However, the membrane should have a direct path between the suction source and tissue—if there is no path the amount of suction delivered will be significantly lower. Placing holes or slits in the membrane may allow for sufficient vacuum and energy transfer. However, holes or slits are placed in the membrane may allow fluid from the tissues to travel through the membrane into the interior vibration source region of the device.

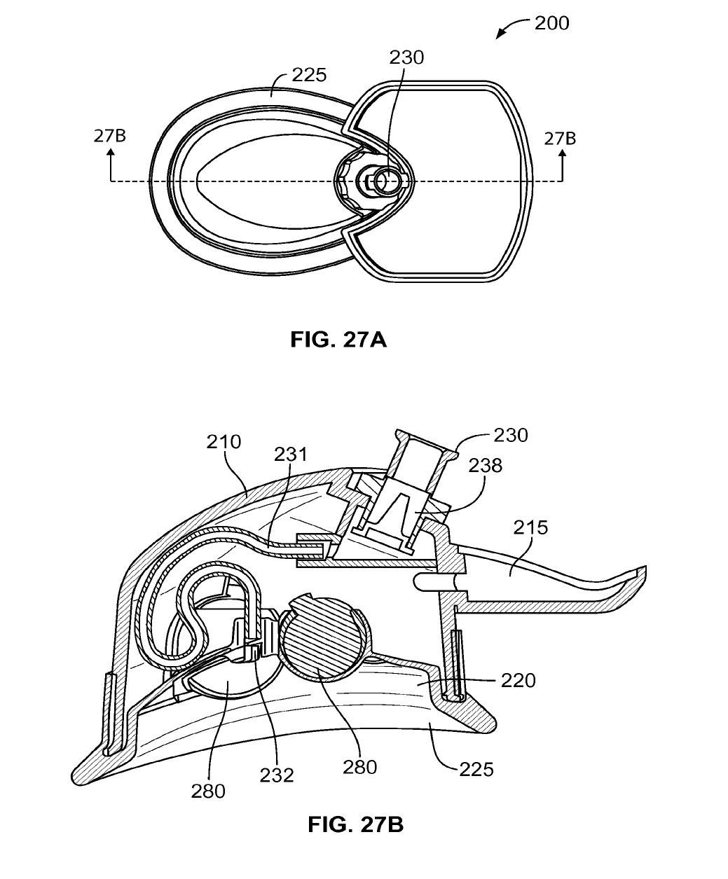

FIGS. 27A and 27B illustrate a plan view and a cross-sectional view of a device according to certain embodiments. Device 200 includes device body 210 and suction chamber 220. Suction chamber 220 includes sealing flange 225 including sealing edge 226, which is adapted to provide a substantially airtight seal against tissue. Suction port 230 provides fluid communication between the interior of suction port 220 and a suction device (not pictured) that can be detachable or remain attached. Device body 210 includes a user control area 215. It is understood that the user control area may contain multiple control inputs. Further, the device 200 may be controlled remotely. Multiple vibratory motors 280 are coupled to the inner walls of suction chamber 220. Suction inlet 232 includes duck bill valve 238 (or a check valve or other one-way valve) connecting suction port 232 to the interior of suction chamber 220. Device body 210 includes a firm but flexible shell, which houses electronics and couples the electronics to suction chamber 220. Device body 210 may further include a charging port to recharge the power source included in controller block 215. Activation buttons present in the user control area may be recessed or otherwise made comfortable, safe, and reliable. Sealing flange 225 may include soft, flexible, compliant material (e.g., silicone), and may optionally be mildly adhesive to tissue or may be adapted to contain an adhesive material. Device body 210 is configured such that the posterior, or underside, of device body 210 is in a different plane than sealing flange 225. This configuration allows device body 210 to ride over the pubic bone of the user and to optionally attach to a garment while sealing flange 225 is in contact with tissue.

FIG. 27B depicts suction tube 231 connecting suction inlet 232 with suction port 230. The suction tube material is chosen to be resistant to adhesion by biological material. The path of the suction tube through the device housing can be configured to account for pressure drops and to avoid areas where fluid may pool. The suction tube provides an additional barrier between fluid and the electromechanical and electrical components within the interior housing of the device body.

In embodiments including a suction tube, there is a pressure differential between the chamber above and below the membrane. When suction is applied, the area above the membrane is at higher pressure than the area below the membrane which can encourage the membrane to move down toward tissue, thereby increasing contact forces between the motors and tissue. This pressure differential mechanism can be actively used to increase energy transmission.

The challenge of cleaning fluid from interior regions of the device is addressed by enabling the flexible portion of the suction cup to be removed from the housing so it can be cleaned by the user. Alternately, as depicted in FIGS. 27A and 27B, a tube could be connected between the suction luer and a single hole in the membrane. The interior of this hole may have features (e.g., protrusions, a permeable shield, and the like) to prevent the tissue from clogging the hole when vacuum is applied. In this case, fluid would not be able to enter the interior surfaces of the device and would be contained to the tissue interface and the suction tube channel. These regions could be rinsed by the user without disassembly.

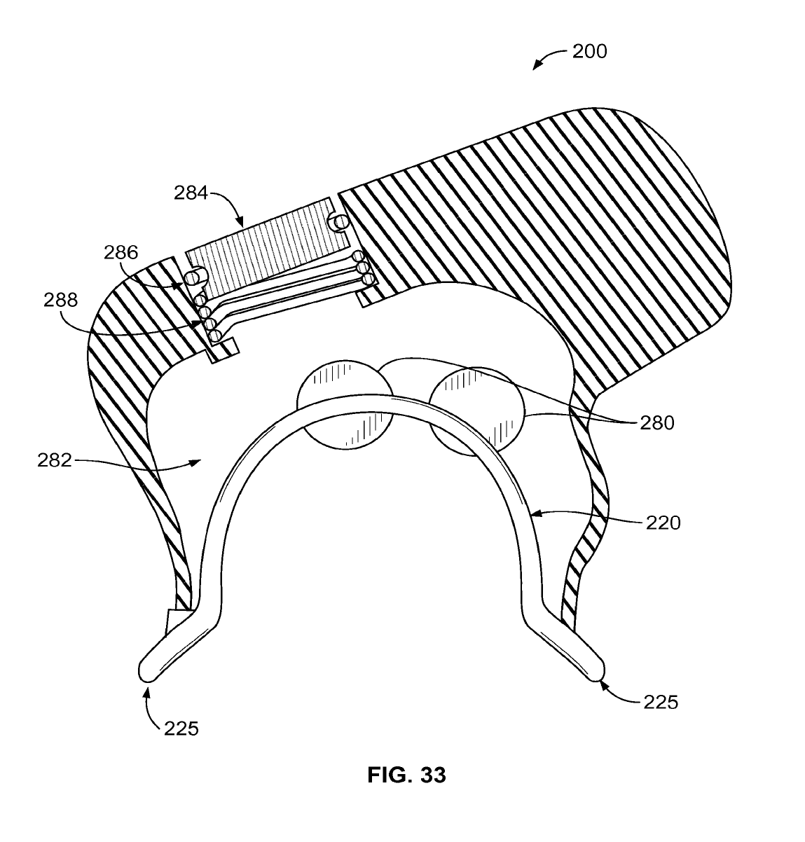

To address the challenge of cleaning, in another embodiment as shown in FIG. 33, no fluid is allowed to enter the interior 282 of the device 200 such that the surface under suction chamber 220 and all of the external surfaces of device 200 can be easily cleaned with soap and water. Interior 282 can be vacuum sealed or contain a gel or fluid. The embodiment of device 200 in FIG. 33 has a non-deformable button 284. Button 284 has an O-ring 286 to form a seal around the button. Button 284 is mounted on a spring 288 such that when button 284 is depressed and released it is biased toward its starting position. Sealing flange 225 creates a seal, primarily at sealing edge 226, with the woman's tissue. Suction chamber 220 is a resilient membrane dome that is biased to return to its starting position. Displacement of button 284 forces pressure downward on the resilient membrane dome which forces air out from under suction chamber 220. The sealing flange 225 in contact with the tissue acts likes a one-way valve and as the button is released, the resilient membrane tries to return to its starting position thus creating suction under suction chamber 220 to create negative pressure over the clitoris and encourage engorgement. A biasing member can be added to the suction chamber dome to increase the recoil.

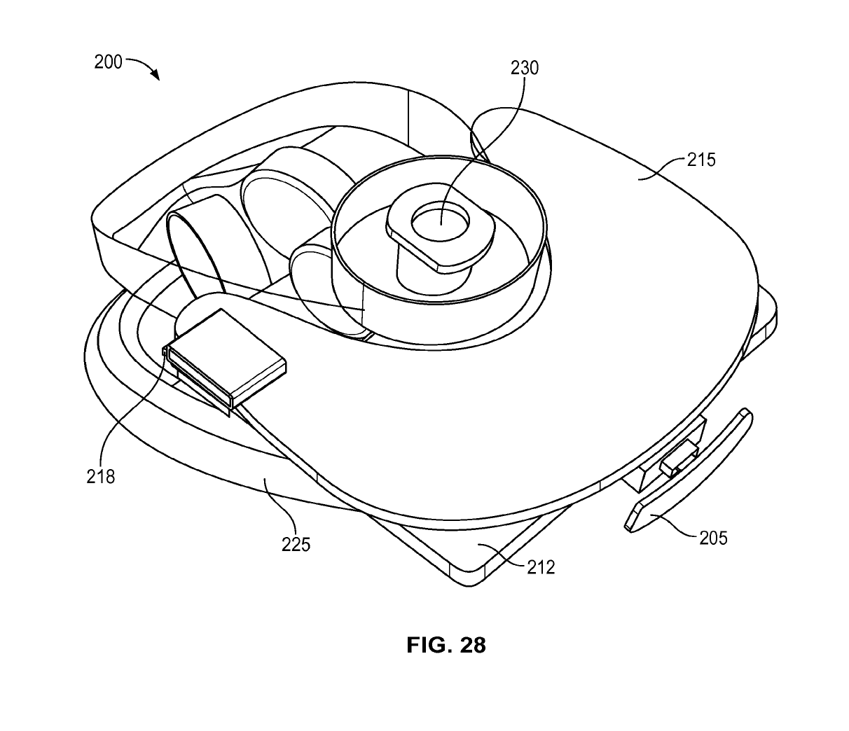

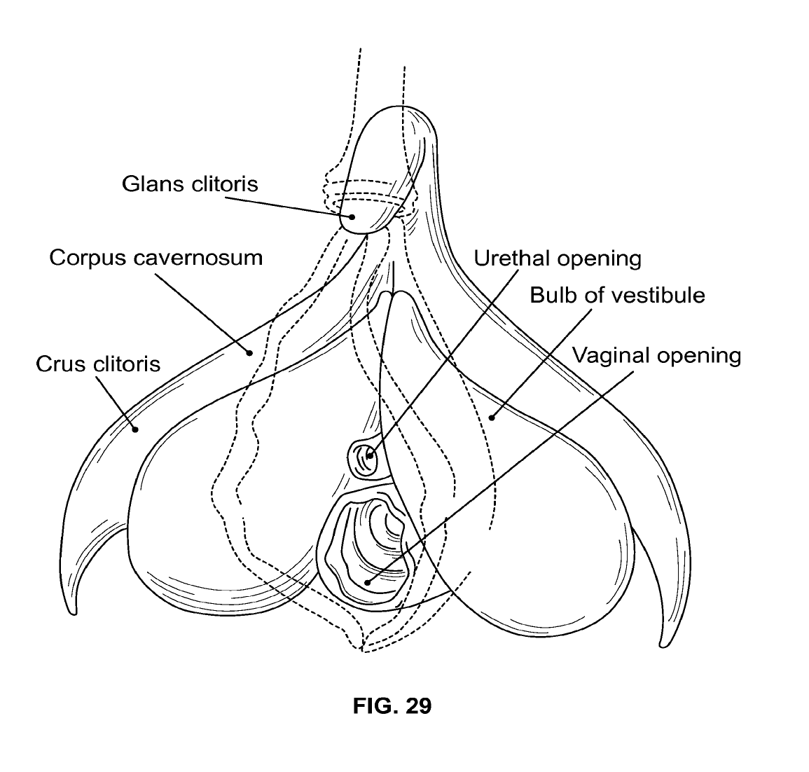

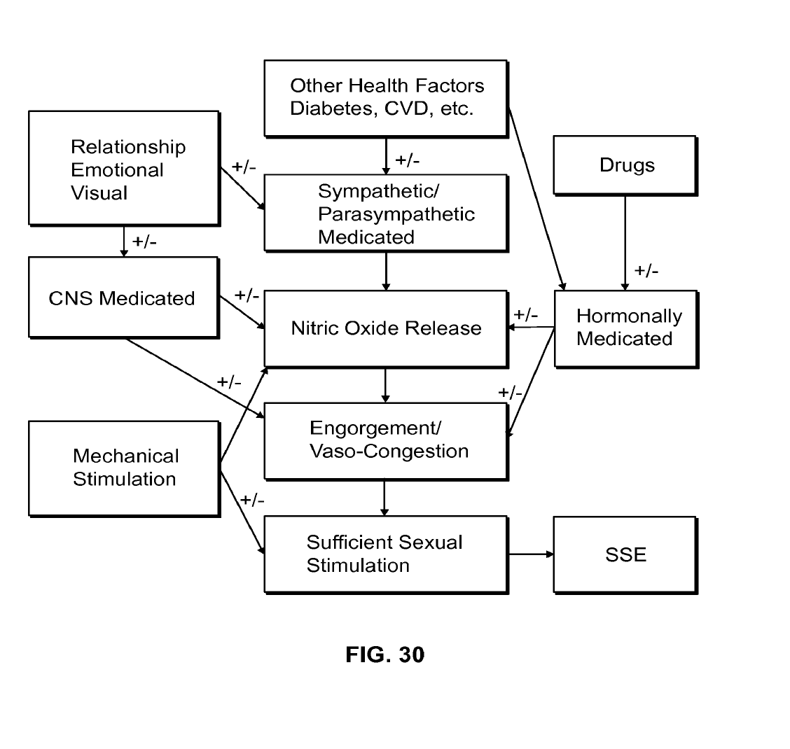

FIG. 28 depicts a view of a device 200 with the outer housing removed. Controller block 215 (or circuit board) is housed underneath the outer housing and between suction port 230 and activation button 205. Activation button 205 is, of course, operably connected to controller block 215 as is I/O port 218. I/O port 218 can plug into an interface cable (or an interface port in a holder) that can be used to program and/or charge the device. Battery 212 is underneath controller block 215.

Certain materials may be preferable for use as actuators in devices disclosed herein. For example, electro-active polymers expand and contract with the application of electrical current and can incorporate taxels (focal points) to increase resolution. Electro-active polymers can be packed in dense arrays, are highly customizable, and show good frequency range. Some designs are extremely low profile. Piezoelectric materials are another example. Piezoelectric crystals generate stepping function movement that can be used for rotary or linear motion and/or vibration. Piezoelectric materials can be miniaturized and incorporated into electronics and show good frequency range. Another example is voice coils in which linear motion is caused by generation of electrical field around a magnet. Voice coils can achieve high amplitude with low voltage and are smaller size than miniature coin cell motors.

Voice coils can also allow more control flexibility than rotary motors—the frequency and amplitude can be decoupled from each other. Voice coils also allow for greater isolation of vibrational energy because only the moving element vibrates and the housing is essentially stationary. This can allow for greater spatial differentiation.

Certain actuator materials may be used to form an actuator array that provides high spatial resolution for vibrations. For example, an array that provides for 14 vibratory sources could improve the sensation of motion delivered to the user and provide for significant customization modes. In this example, each vibration node is 4 mm in diameter, significantly smaller than the 8 to 15 mm diameter coin cell motors. A vibration node of 4 to 6 mm in diameter would be desirable for this application to achieve the intended resolution.

Certain embodiments are capable of approximating kinesthetic forces (or macroscopic motions such as palpation or rubbing) using an array of vibrational motors. Devices disclosed herein are capable of achieving (or at least simulating) kinesthetic (or macroscopic) sensations using actuators that typically produce only tactile sensations. Devices capable of producing a convincing, organic-feeling palpation sensation rely on the coordination of: (i) motor spacing in the array (preferably, motors are spaced at about 1-4 mm); (ii) breadth of field of each motor; (iii) traversal rate for a pattern played on the motors; and (iv) overlap.

According to certain embodiments, devices fabricated as described herein are able to tune strength, traversal rate, and overlap, to the fixed physical parameters like the motor spacing, skin contact, etc. Various algorithms allow independent control of motor strength, traversal rate, and overlap. In a device fabricated according to embodiments disclosed herein, an algorithm was implemented in a low-cost embedded microcontroller. Three input parameters were varied, by radio control using Bluetooth Low Energy components communicating from an iOS device (iPod of iPhone 5 generation) to an embedded microcontroller (Texas Instruments CC2540), to ultimately set those algorithm input parameters. The algorithm output controlled pulse width modulated drives for all 3 to 5 motors simultaneously. The algorithm also allowed for unique patterns such that the user could specify order of traversal through the motor array. Different profiles, e.g. square, sine, ramp, were used to turn on the different motors at different rates as the pattern progressed through the motor array.

For motors with a non-linear response curve, feed-forward techniques (or feedback if sensors are incorporated in the device) can compensate for such a response curve. Thus, motors turn on when commanded as opposed to with a lag, so that the coordination discussed above can be achieved. In some embodiments, an accelerometer may compensate for effects of gravity.

Miniature coin-style vibratory motors having an eccentric mass are used in certain embodiments. Generally speaking, coin-style motors require larger masses and higher power in order to increase the stimulating force delivered to tissue. Thus, the stimulating force in eccentric motors is a function of mass, and more power is required to drive that mass. In certain embodiments described herein, despite the relatively high mass and relatively high power of the motors the devices can provide spatially-differentiated vibration via the isolation structures and methods described herein. Even when the motors are positioned relatively close together to provide a close fit to the clitoris, embodiments described herein can provide substantial vibrational isolation and provide the user with a spatially-differentiated stimulation experience.

In certain embodiments, modified voice coils are used as the stimulators. As described above, voice coils can achieve high amplitude with low voltage and are smaller size than miniature coin style motors. Voice coils can be modified to include a mass attached to the membrane driven by the electromagnetic field. Advantageously, such mass-bearing voice coils retain the desirable properties of voices coils, including rapid response time, independent control of frequency and amplitude, high acceleration, high precision force control, and relatively low power consumption.

Embodiments of the device may have variable suction controlled by the user or another remote controller. A user may remotely select a pressure and the device will change to that pressure within seconds. The device may include an onboard pump that maintains suction and/or goes up/down from that initial established suction. Certain diaphragm pumps may be used as onboard pumps. Further, the motor driving the diaphragm pump may be used to produce vibratory motion. In certain embodiments, the onboard pump can be a modified voice coil designed to mimic the action of a diaphragm pump. The onboard pump can alternately be made with using a voice coil actuator that moves a membrane in a sealed and valved chamber.

In embodiments using an onboard pump or in embodiments using a remote pump, the suction may be programmed to complement the vibratory motion of the motors or the macroscopic motion of stimulators in the device. The algorithms described herein to drive vibration are adapted to vacuum pump system to provide fast response times and physically differentiable levels of suction to the clitoris. Further, certain embodiments use simultaneous or sequential suction waveforms or algorithms and vibration waveforms or algorithms to amplify the effect of the device.

In some embodiments of the device and method, variations in the stimulation parameters are particularly useful in providing the desired results in a user. For example, the stimulators can be varied between a high power and/or a high frequency level and a comparatively lower power and/or lower frequency setting. In the case of coin cell type stimulators, power and frequency are coupled such that driving the stimulator at higher frequency of oscillation also drives the stimulator at a higher power. To achieve the preferred variations in stimulation, the coin cell type stimulators can be switched between a high power threshold and a low power threshold. In the case of voice coil type stimulators, power and frequency can be decoupled such that a given power of stimulation can be driven at any frequency. Without being bound to a specific mechanism or mode of action, it is believed that comparatively large variations in the power or intensity of the stimulation will produce as desirable user experience.

One of the advantages of embodiments of the invention with multiple stimulators and suction patterns is that different parts of the anatomy can be stimulated at different frequencies. For example, different parts of the frenulum can be stimulated at different frequencies. It is generally understood that different nerve types will be stimulated to a different degree at a given frequency and that different nerves are more fully stimulated at different frequencies. One of the advantages of certain embodiments is the capability of delivering the appropriate frequency and intensity stimulation and/or suction to the different parts of the vaginal anatomy. For example, with the three stimulators positioned as shown the center stimulator primarily stimulates the glans of the clitoris and the right and left stimulators stimulate the right and left crus, respectively, (and/or frenulum) of the clitoris. The device can also enable the user to select and/or tune the desired frequency for their anatomy and nerve distribution, thereby customizing the user experience.

In certain embodiments, it is desirable to release suction during use. For example, the edge of the suction cup could be pulled back, squeezed, or manipulated to create a leak path. Further, a valve in line with the suction tube that can be manually manipulated by the user to release suction. In embodiments using an onboard suction pump, the pump can be configured to include a constant leak path that the pump overcomes—therefore, if the pump stops the device will automatically release. Still further, the device can be configured with a button that the user presses which opens a valve in the pump to release suction. Still further, the valve needed for the suction pump could be normally open. When power is supplied, the valve closes, completing the seal. However, if power goes out, the valve will open and the device will release automatically.

Certain embodiments of the present invention are designed and configured to increase blood circulation in vaginal tissue to promote engorgement to the clitoris and external genitalia while simultaneously applying stimulation to the clitoris and/or other vaginal tissue. The clitoris is a sexual organ that is filled with capillaries that supply blood to a high concentration of nerves. Certain embodiments increase blood flow to stimulate the clitoris and enhance a woman's sexual response.

In women presenting symptoms ranging from sexual dissatisfaction to sexual dysfunction, methods and devices of certain embodiments can provide: (i) increased genital sensation; (ii) improved vaginal lubrication; (iii) improved sexual satisfaction; (iv) improved sexual desire; and/or (v) improved orgasm. Certain embodiments of the invention are designed and configured to be used to treat women with diminished (i) arousal, (ii) lubrication, (iii) sexual desire, and/or (iv) ability to achieve orgasm.

Certain embodiments of the invention are designed and configured to be a wearable device designed to increase sexual satisfaction. Certain embodiments of the invention are designed and configured to be used as a “conditioning” product, to prime the user before a sexual event. Certain embodiments can be: used to help a woman prepare her body in advance of a sexual experience, typically with 5-30 minutes of use prior to sex; worn during a sexual experience with a partner, including intercourse; used by a woman alone for recreational purposes to reach orgasm; used as a regime, typically used a few minutes every day, to help facilitate a more intense and pleasurable experience during intercourse with or without a partner; or used over time to help train the body to achieve a better natural sexual response.

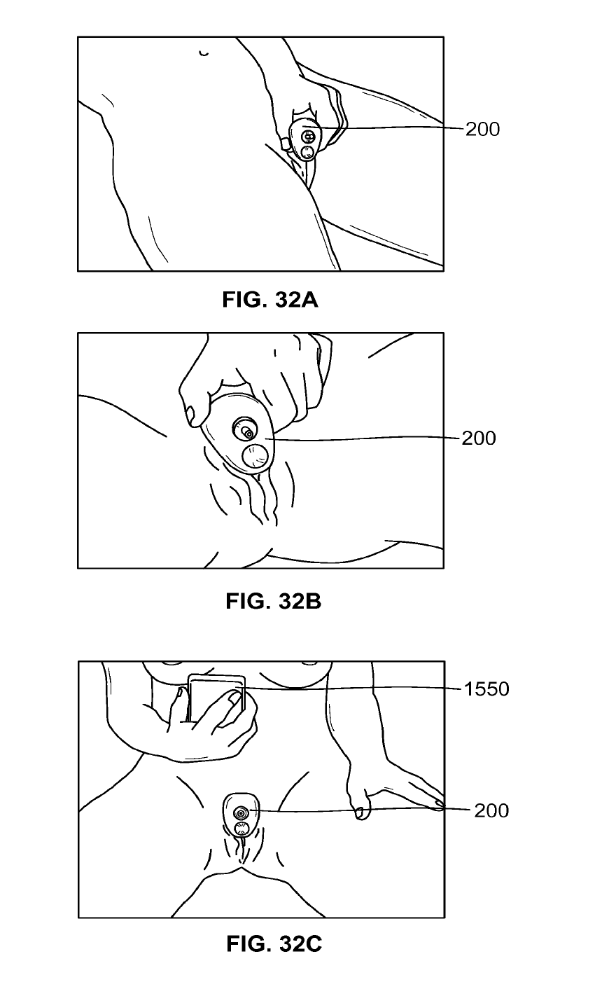

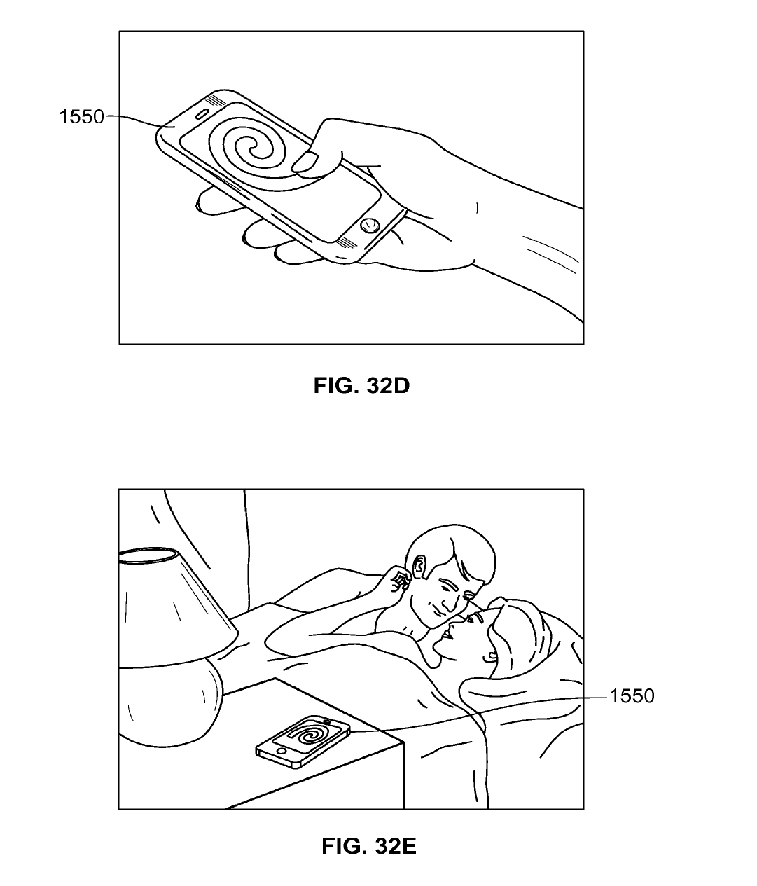

The device 200 is placed over the clitoris (FIGS. 32A-32B) by a woman, her partner or physician. Gentle suction allows the product to stay in place (so it can be completely hands free once placed), although it can be quickly and easily removed as desired. A woman can sit, stand up and walk around while wearing the device 200. As shown in FIG. 32C, a small remote control 1550 or smartphone “app” is used to adjust the device's vibration intensity and unique stroking patterns (such as the counter-clockwise movement pictured in FIGS. 32D-32E). The sequence can be customized in advance and “playlists” can be created. Once in place, the device 200 provides quiet, hands-free sexual stimulation to the clitoral region, working with a woman's body to help improve sexual response. Certain embodiments are small (about 1.5 inches long by about 1 inch wide), quiet, waterproof and discreet. The product is latex-free, hypoallergenic and washable with soap and water. It is quick and easy to place on the body, and can easily be removed. It may be worn under clothing without anyone knowing the user has it on. Since it is a hands-free product, the user can easily move around, stand or walk while wearing the device for a few minutes a day while doing something else to help a woman's body maintain a higher level of sexual responsiveness.

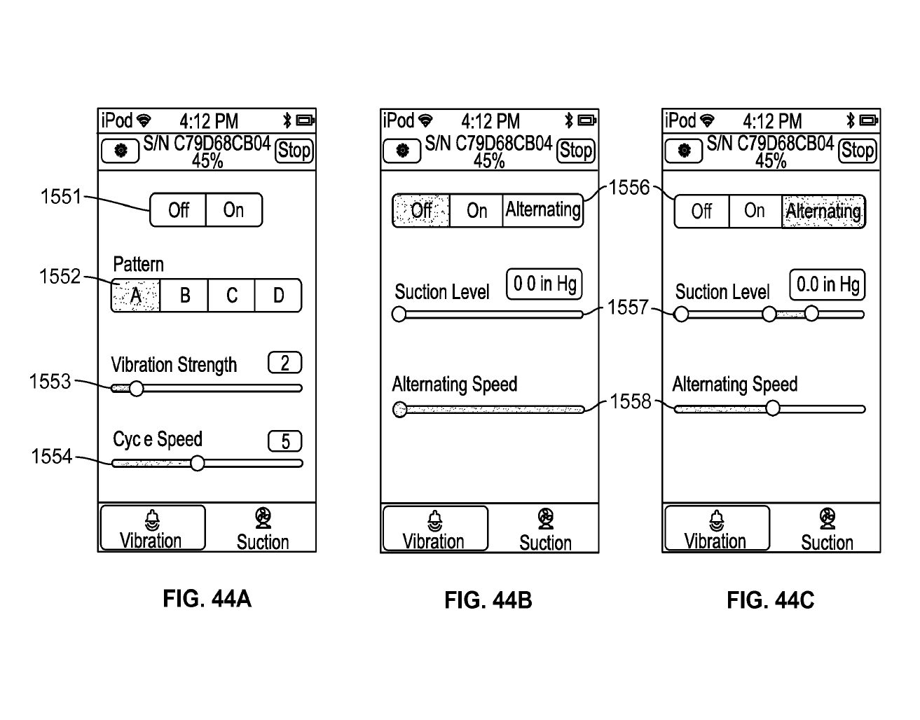

FIGS. 44A through 44C illustrate user interfaces for a smart remote controller 1550. These user interfaces provide means for controlling vibration and suction patterns, including pre-loaded patterns, user-configurable patterns, or combinations thereof. FIG. 44A illustrates a user interface including a vibration on/off button 1551, a vibration pattern selector 1552, a vibration strength selector 1553, and a vibration cycle speed selector 1554. The vibration strength selector 1552 and vibration cycle speed selector 1554 are each shown with a numeric indicator in addition to a slider. The vibration pattern selector 1552 can be loaded with pre-loaded patterns or it can be used to store user-configurable patterns. The user interface provides an intuitive and easy-to-operate means for controlling the vibration and suction patterns of the device.

FIGS. 44B and 44C illustrate a user interface including a suction on/off button 1556, a suction level selector 1557, and a suction alternating speed selector 1558. The suction on/off button 1556 also includes an “alternating” section setting. FIG. 44B illustrates that when the suction on/off button 1556 is in the “off” or “on” position, the suction level selector 1557 has a single slider point and the suction alternating speed selector 1558 is not available to use. When the user sets the suction on/off button 1556 to “on,” the suction level selector 1557 can be used to set a suction level on the device and that suction level can be numerically displayed in units such as “in Hg.”

FIG. 44C illustrates a user interface in which the suction on/off button 1556 has been set to “alternating.” In the “alternating” mode, the suction level selector 1557 has two slider points and the suction alternating speed selector 1558 is available. The “alternating” mode allows the user to set a primary suction level with the first slider point and a higher suction level with the second slider point. The device can then alternate between these two suction levels at a specific alternating speed that the user sets using the suction alternating speed selector 1558. Thus, the user can control both the difference in suction levels and the speed at which the device alternates between those two suction levels. Further, the user interface can contain a means for the user to store the two suction levels and the suction alternation speed. The user interface can include pre-loaded suction alternation levels and speeds, user-configurable suction alternation levels and speeds, or combinations thereof.

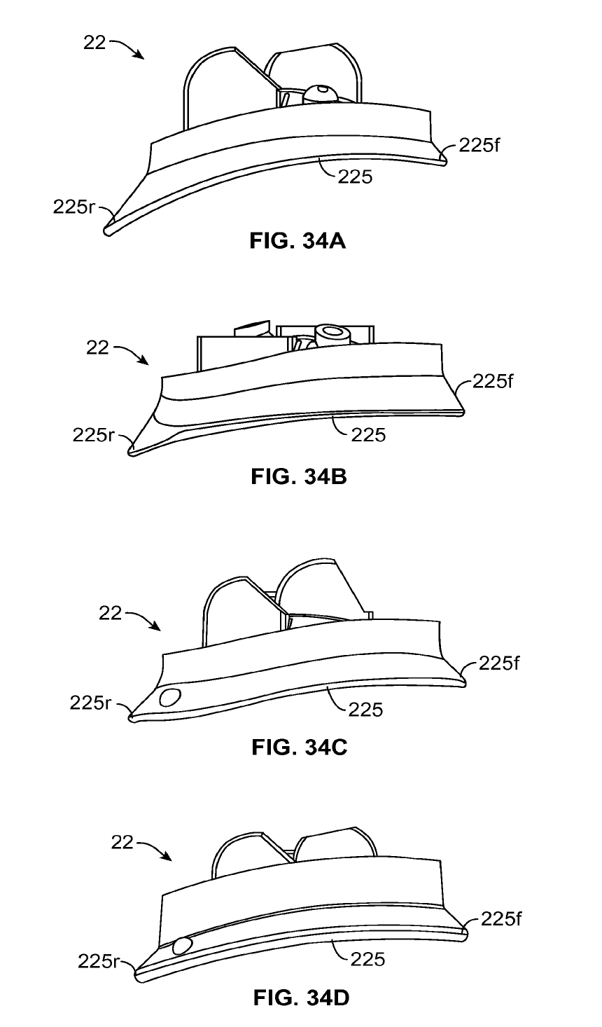

FIGS. 34A through 34D illustrate views of a portion of certain devices with different tissue contacting configurations. In each of FIGS. 34A through 34D, the interior components, such as the portions that hold the vibratory motors, are visible since the outer shell of the device body has been removed. FIG. 34A depicts the device as having a comparatively steeper curve along the tissue contacting side of the device. That is, the curvature of the sealing flange 225 from its approximate midpoint to the rear section 225r of the sealing flange 225 has a greater curvature than that same section of other device portions depicted in FIGS. 34B, 34C, and 34D. Further, the sealing flange 225 of the device portion depicted in FIG. 34A has a comparatively longer inferior section (the section is described as inferior due to its placement inferior to the clitoris when in use) or rear section 225r. This comparatively longer inferior section (or rear section 225r) is configured to conform to the anatomical curvature inferior to the clitoris and to facilitate the interaction between the sealing flange 225 and tissue. The superior and lateral flange portions are shorter relative to the longer inferior section flange portion to enable superior positioning relative to the clitoris and reduce interaction with the labia majoria. For some users, this curvature will improve the fit, comfort, and reliability of suction attachment of the device. Other uses may find that the curvature of the devices depicted in FIG. 34B, 34C, or 34D may be preferable.

The portions of the device illustrated in FIGS. 34A and 34D can be formed from a molded piece 22. This single molded piece 22 includes the sealing flange 225 and upper portions that are connected to the device body. FIG. 40 illustrates a perspective view of a device and shows the single molded piece 22 attached to the device body 210 to form the device. The upper portions of the single molded piece 22 are positioned inside the device body 210 such that the vibratory motors and the suction ports can be attached to the control mechanisms inside the device body 210.

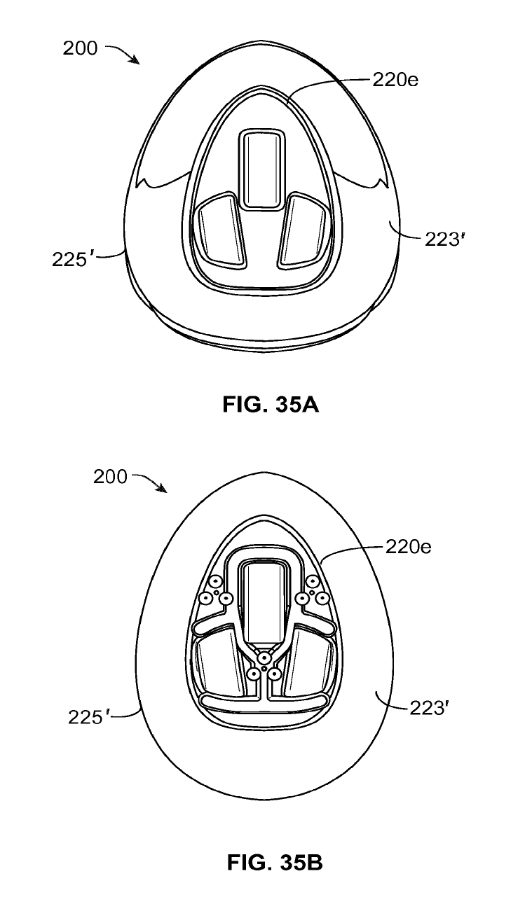

In some embodiments of the device, a removable flange assembly is provided. The flange assembly couples to the device body and is removable from the device body. FIGS. 35A and 35B depict plan views of a device 200 with the removable flange assembly 225′ attached. FIG. 35B depicts variation in the width of the flange surface 223′; in this case the flange surface 223′ is wider at a portion of the device that is placed inferior to the clitoris. As described herein, some embodiments of the invention include removable flange assemblies that can have a variety of geometries, curvatures, and configurations.

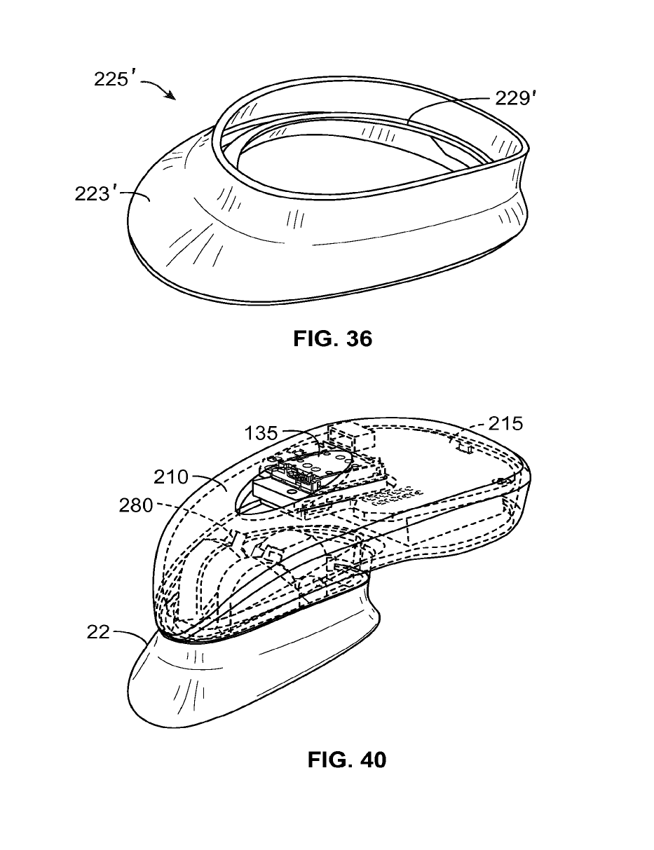

FIG. 36 depicts a perspective view of a removable flange assembly 225′ detached from a device body. FIG. 36 depicts a removable flange assembly joining member 229′ integral to the removable flange assembly 225′. The removable flange assembly joining member 229′ couples to the device body and provides a substantially airtight seal with the suction chamber to enable operation of the device. Removal of the flange assembly can allow for a user-customized fit. That is, the user can select from a range of removable flange assemblies that have varying dimensions, configurations, materials, coatings, and/or textures as well as combinations of these features.

For example, the width of the sealing flange 223′ of the removable flange assembly 225′ can be varied from a comparatively narrow width to a comparatively wide width. As another example, the curvature of the scaling flange can be varied from a comparatively steep curvature to a comparatively shallow curvature. Further, a sealing flange on a single removable flange assembly may have a combination of widths and curvatures on its sealing flange. In still another example, the removable flange assembly can be made of a combination of materials or from a single material with varying properties. For example, the sealing flange can be comparatively softer and more flexible (e.g., 0030A durometer silicone) while the removable flange body can be comparatively more rigid (e.g., 20A durometer silicone). A comparatively more rigid removable flange body can help join the immovable flange to the device body. In yet another example, the sealing flange of the removable flange assembly can have a variety of textures or coatings (such as a lubricious or pre-lubricated coating) that potentially improve the comfort, fit, and/or reliability of the seal between the device and tissue.

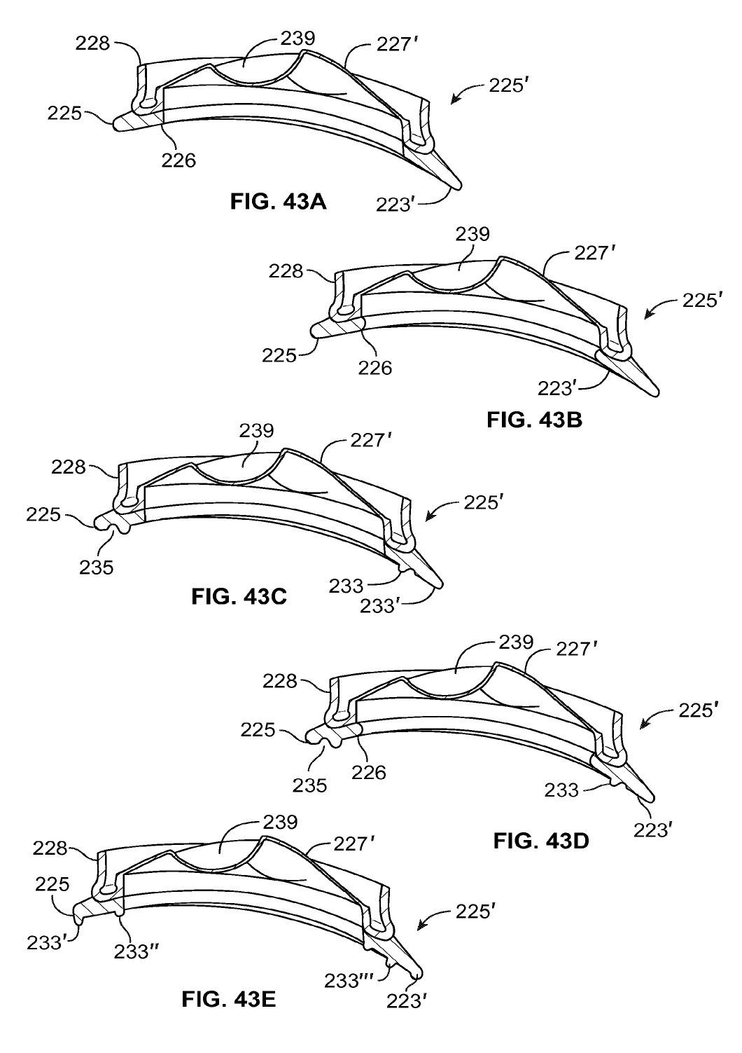

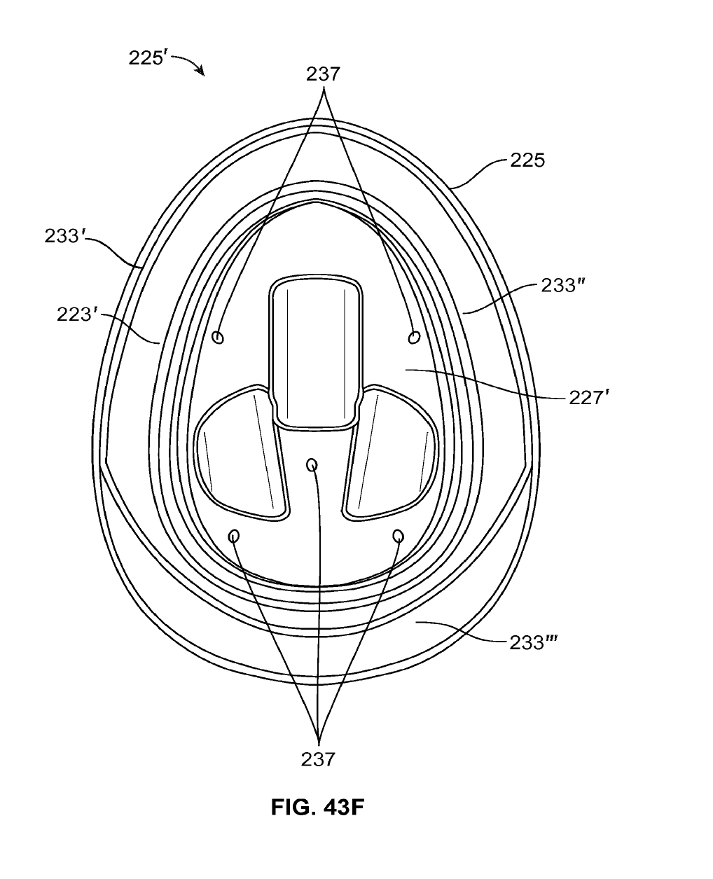

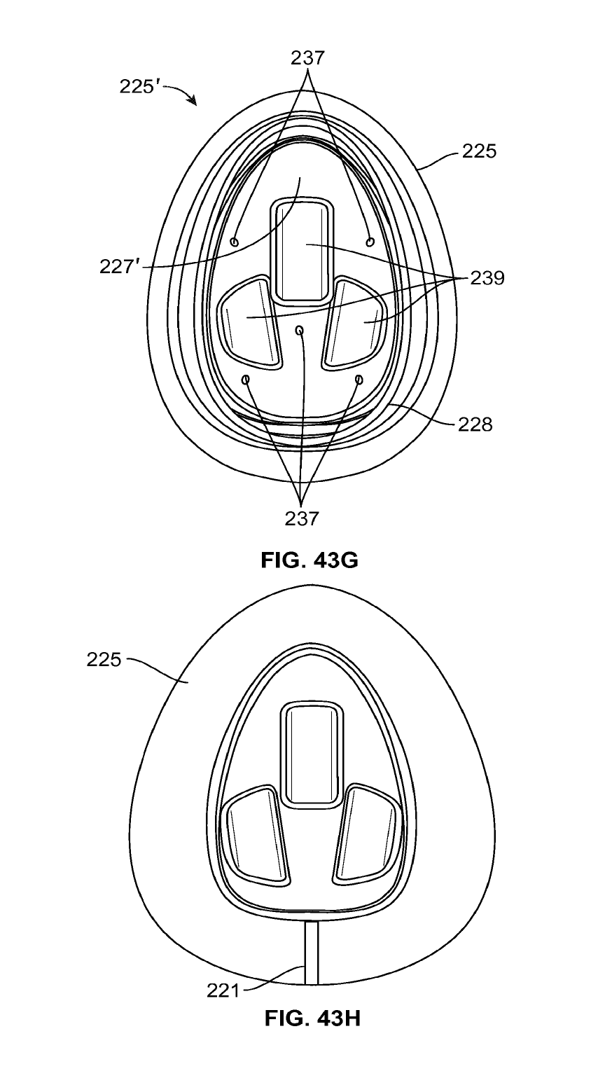

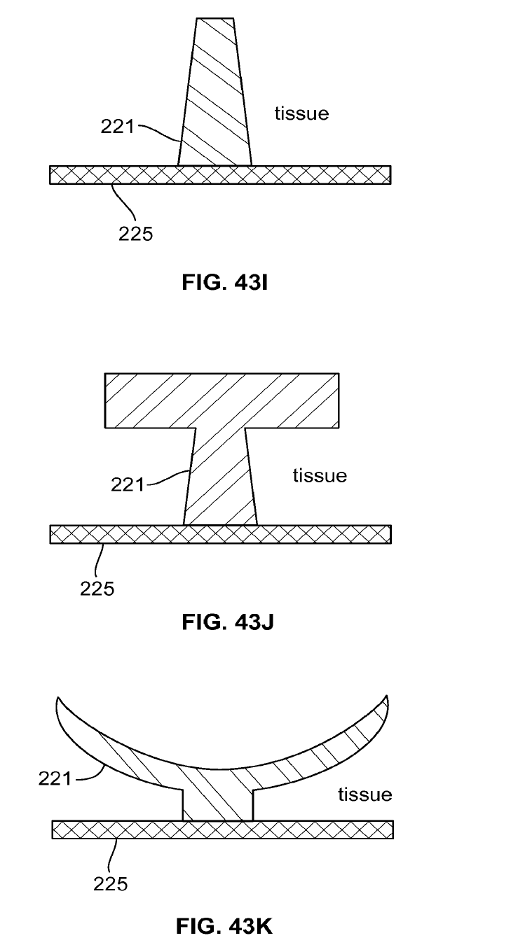

For examples, FIGS. 43A-43G show various embodiments of the sealing flange assembly 225′. FIGS. 43A-43G show the flange assembly 225′ made of a combination of materials. The sealing flange 225 is a comparatively softer and more flexible material while the flange body 228 that joins to the device body is comparatively more rigid. The sealing flange portion and flange body portion are molded together. In the embodiment of FIG. 43A, the sealing edge 226 has a sharper corner so that as tissue is sucked up into the suction chamber it makes a tight turn relative to the sealing surface 223′ to create a seal at the sealing edge.

For some tissue types and geometries, additional features help to create a seal either at the sealing edge or along the sealing surface. In the embodiment of FIG. 43B, the sealing edge 226 has an additional rib so that as tissue is sucked up into the suction chamber it makes a tight turn relative to the sealing surface 223′ and then as the tissue becomes engorged into expands out over the additional rib of the sealing edge to create a tight seal with the tissue and a mechanical interlock that helps to prevent dislodgement of the device during use.

In the embodiment of FIG. 43C, the sealing surface 223′ has a protrusion 233 running all the way around the sealing surface 223′ and a depression 235 running all the way around the sealing surface 223′. The protrusion 233 is very soft and flexible so as to form a close fit over any hair or small differences in folds of tissue that may be traversing the sealing surface 223′ to prevent a suction loss along that hair or tissue. The depression 235 provides a space for the hair or tissue as well as provides a location for extra lubricant to fill in around or over hair or tissue. In the embodiment of FIG. 43D, the protrusion 233 and depression 235 are combined with the additional rib of the sealing edge 226 of the embodiment of FIG. 43B.

The embodiment of FIG. 43E-43G has two protrusions 233′ and 233″ running all the way around the sealing surface 223′ and one protrusion 233′″ that runs only partially around the sealing surface 223′. The protrusion 233′″ is on the wider flange portion of the sealing flange 225 which is the portion of the flange that makes contact with the vulvar tissue inferior to the clitoris. The protrusion 233′″ joins up with the protrusion 233″ to create a continuous seal. The protrusions 233′, 233″ and 233′″ are very soft and flexible so as to form a close fit over any hair or small differences in folds of tissue. The dual and triple configurations provide multiple opportunities to form and maintain a seal along the sealing surface 223′ when a sufficient seal is not maintained along sealing edge 226.

As shown in the bottom view of FIG. 43F and top view of FIG. 43G, each of the embodiments of FIGS. 43A-43G have multiple suction holes 237 in flange membrane 227′. Some of the holes 237 are placed toward the perimeter of the suction chamber in order to facilitate greater sealing at the sealing edge and sealing surface. The stimulators are integrated into the suction chamber membrane 220 (not shown in FIGS. 43A-43G). The membrane pockets 239 in flange membrane 227′ match up and accommodate the stimulators in the suction chamber membrane 220. The flange membrane 227′ and membrane pockets 239 are thin such that the maximum amount of energy can be transferred from the stimulators through the membrane to the tissue.

In some embodiments, the sealing edge has a wavy texture that provides excess material to conform to variations in the tissue surface. The period and amplitude of the wave on the sealing surface will vary with the material chosen for the sealing surface to promote a secure and leak-resistance seal. In general, the sealing flange is made as thin as possible while still maintaining sufficient durability.

In some embodiments, the inferior portion of the sealing edge may be configured with a seam, line or weakness, thinned-out section, or other feature that induces a pinching motion at the tissue interface. A gentle pinching of the soft tissue can close leak pathways in the area where the inferior section of the sealing flange interacts with the labia minora. FIGS. 43H, 43I, 43J, and 43K depicts a sealing protrusion 221 on the sealing flange 225. The sealing protrusion 221 provides a surface for the labia to seal against. More than one sealing protrusion 221 can be used and the sealing protrusion can be located in other places on the sealing flange 225. The sealing protrusion 221 may contain a suction port connected with the suction system of the device to promote sealing of tissue against the protrusion. FIGS. 43I, 43J, and 43K depict different cross sections of a sealing protrusion 221.

Without being bound to a specific mechanism or mode of action, the flanges and flange assemblies of certain embodiments can provide one or more of the following beneficial properties: (i) smoothing the vaginal tissue underneath and in the area of the flange; (ii) distributing the engagement forces between the device and the vaginal tissue; (iii) providing physical features that can fit underneath the labia majora; and/or (iv) increasing the leak path from the suction chamber to the outside environment. Each of these beneficial properties can help provide a reliable, comfortable, and customizable anatomical fit.

In certain embodiments, the outer rim portion 220e of the suction chamber 220 and/or the inner portion of the sealing flange 223′ such as the sealing edge 226 are the primary part(s) of the device that form the seal with tissue. That is, until the seal between the outer rim portion 220e of the suction chamber and/or the sealing edge/inner portion of the sealing flange 223′ is substantially disrupted, the device can maintain a sufficient seal with tissue. In these embodiments, the sealing flange provides the above beneficial properties to augment the seal as well as providing a reliable, comfortable, and customizable anatomical fit. This can be true for devices with integral flange and sealing edges and devices using a removable flange assembly.

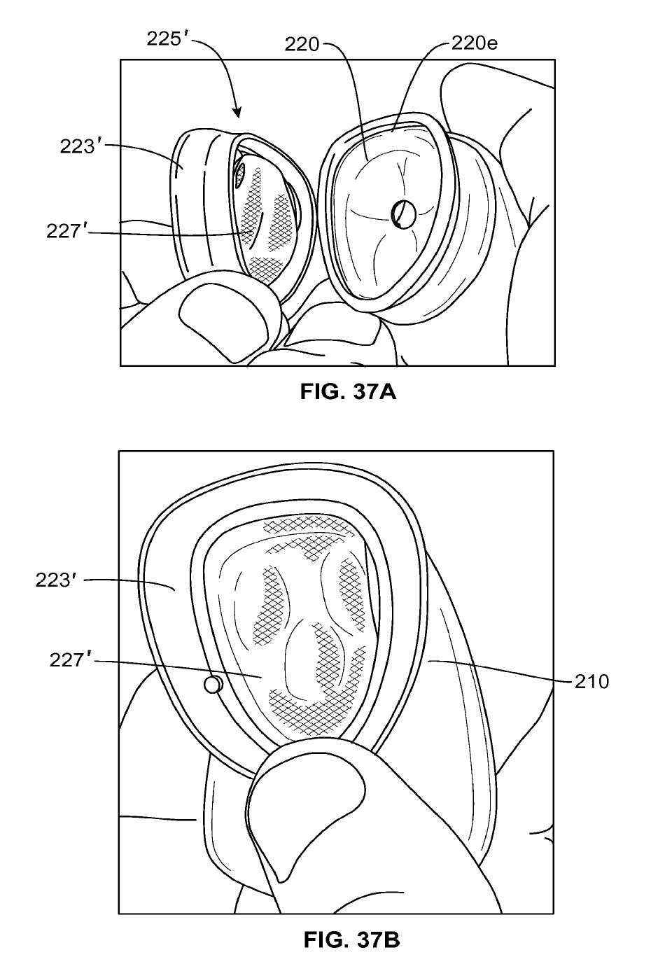

FIGS. 37A and 37B illustrate a removable flange assembly 225′ including a flange membrane 227′. The stimulators are integrated into the suction chamber membrane 220, which remains attached to the device shell. The flange membrane 227′ can be formed of the same or different material than the sealing surface 223′. The flange membrane 227′ can be relatively taut across the central opening of the removable flange assembly 225′ or it may be comparatively looser. The flange membrane 227′ may be domed, planar, or formed to conform to the geometry of the device. The flange membrane 227′ can be stretchable or compliant or comparatively less compliant. The flange membrane 227′ includes one or more perforations or holes. The flange membrane 227′ can be formed during the process of forming the removable flange assembly 225′. For example, in some embodiments the removable flange assembly 225′ is a molded part and the flange membrane 227′ can be molded integrally with the removable flange assembly 225′ as a comparatively thinner section spanning the interior of the removable flange assembly 225′. The flange membrane 227′ can be molded with holes or perforations formed during the molding process, or the holes or perforations can be formed after the molding process. The holes or perforations in the membrane may integral to the manufacture of the membrane (that is, the membrane stock material already has holes or perforations). In some embodiments, the flange membrane can be placed in the removable flange assembly mold and overmolded into place during the molding process or insert molded. In some embodiments, the flange membrane may be fixed in place after the rest of the removable flange assembly has been formed. The flange membrane can be adhered in place using suitable techniques, such as adhesive bonding, heating bonding and the like. The flange membrane can be any type of fabric or sheet material suitable for contacting tissue.

The flange membrane contributes several beneficial properties to the removable flange assembly. For example, the perforations in the flange membrane are sized to allow for airflow through the membrane while reducing the likelihood of capturing tissue within the membrane perforation or allowing tissue to be captured within the suction port of the device. The presence of the flange membrane enables larger openings in the motor membrane to assist in cleaning of the device. In another example, the flange membrane can provide further user customization by providing a range of textures for interaction with tissue. Further, the flange membrane can have a range of perforation sizes and/or patterns that can increase or decrease the suction applied to tissue in concert with the suction mechanism of the device.

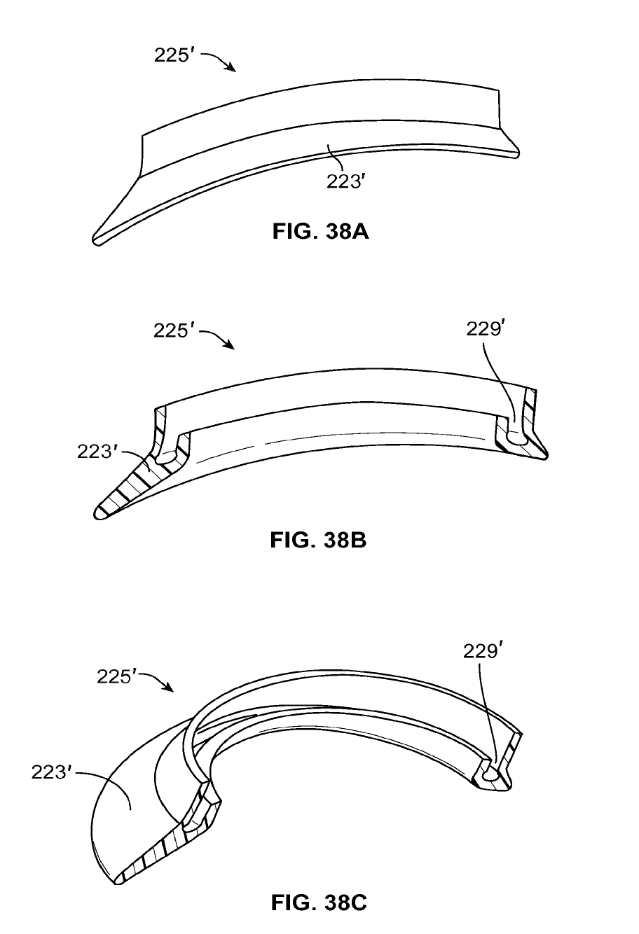

FIG. 38A illustrates a side elevation view of a removable flange assembly 225′ and FIGS. 38B and 38C depict a side elevation view and a perspective view, respectively, of a cross-section view of a removable flange assembly 225′. In these views, the removable flange assembly joining member 229′ is depicted as a trough region. In this embodiment, this trough region couples to the outer rim of the suction chamber of the device body. In other embodiments, the removable flange assembly joining member can be a projection that fits into a trough region that is located on the device body. Other configurations of the removable flange assembly joining member can be employed as long as these configurations provide a substantially airtight seal with the suction chamber.

The removable flange assembly provides the advantage of improving the ease and reliability of cleaning the entire device. In some embodiments, the removable flange assembly is formed of materials that allow the removable flange assembly to be cleaned inside a dishwasher while the remaining device body is simply rinsed or otherwise cleaned by hand. In such an embodiment, the tissue-contacting parts of the device can be cleaned more thoroughly than if the flange assembly was not removable. Alternatively, the removable flange assembly may be single use and disposable. A device may be packaged with several removable flange assemblies, and these assemblies may be identical or they may have a variety of different features. Further, a user can purchase more removable flange assemblies for use with the originally purchased device body.

Another benefit of a flange membrane is improved ease and reliability of cleaning the device body. In embodiments without a flange membrane, the flexible membrane of the suction chamber includes ports that are configured and sized to reduce the possibility of tissue capture and injury. That is, the ports are small and/or offset from tissue. Small and/or offset ports can be more challenging to clean reliably and thoroughly than larger ports or non-offset ports. Further, the ports 220h can be located toward the perimeter of the suction chamber 220 as depicted in FIG. 39. Such a location for the ports 220h can improve drainage of fluid from the device body after use or after cleaning when the device is placed with the rim of the suction chamber face down on a surface. Typically, there will be at least one hole at the top center of the flange membrane to facilitate tissue engagement with the stimulators.

Referring again to FIG. 40, the device body 210 is illustrated to provide a view of the interior of the device body 210. The vibratory motors 280 are positioned within structures in single molded piece 22 such that the stimulation from the motors can be efficiently propagated to tissue, and portions of the vibratory motors 280 are also accessible to be connected to controller block 215. In this case, controller block 215 is illustrated as a printed circuit board. An onboard pump 135 is also positioned within device body 210. The onboard pump 135 is in fluid communication with the suction chamber to provide suction within that chamber and is also in fluid communication with an exhaust port. The exhaust port is an outlet for air or fluid pumped out of the suction chamber and an inlet for air to the suction chamber when suction is reduced. In some embodiments, the onboard pump 135 sends air pumped from the suction chamber across heat-generating elements within the device body 210 before reaching the exhaust port. Such airflow can help dissipate heat and provide safe and reliable use of the device.

In some embodiments, heat generation in the device can be monitored using a component such as a thermistor. Thermistors can be positioned within the device body 210 or be integral to the controller block 215. When the thermistor detects a threshold temperature, it can turn off power to the device and/or vent external air into the device to help the cool the device and then release suction.

In some embodiments, the onboard pump is controlled by the controller block via a closed feedback loop. That is, the controller block is configured to maintain a target pressure, which can be set by the user or can be loaded as part of a pre-programmed suction algorithm. To do so, the controller block reads real-time data from an onboard pressure sensor that is configured to monitor pressure (negative pressure in the case of suction) within the suction chamber. Based on the real-time data, the controller block can engage the onboard pump to draw more suction within the suction chamber or it can engage a check valve in fluid connection with the exhaust port to vent air into the suction chamber. In typical operation, after the device has generated sufficient suction to seal it in place on the user the controller block with periodically engage the onboard pump as suction is slowly lost through leakage.

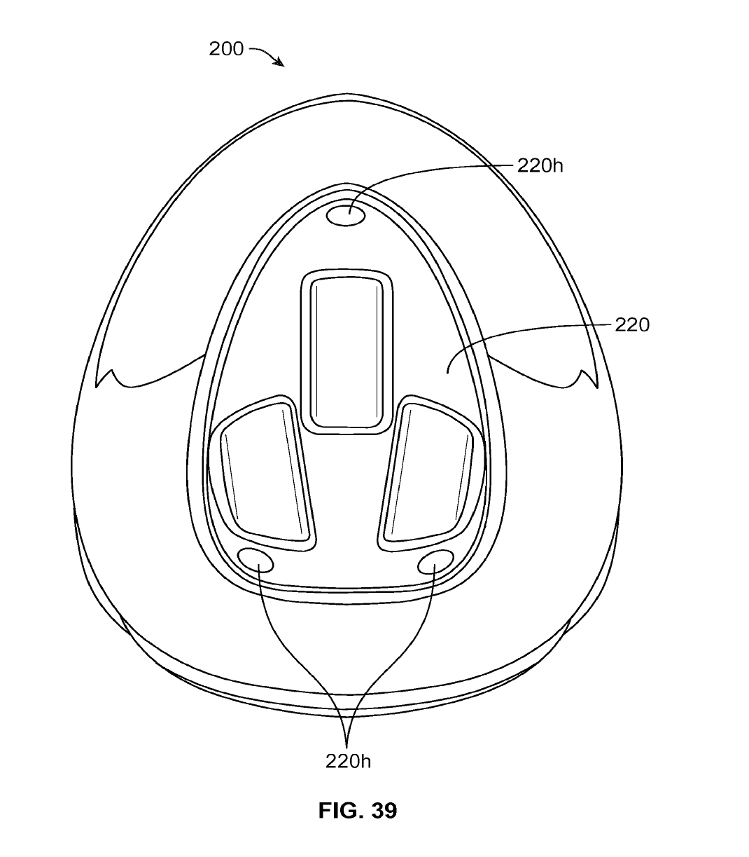

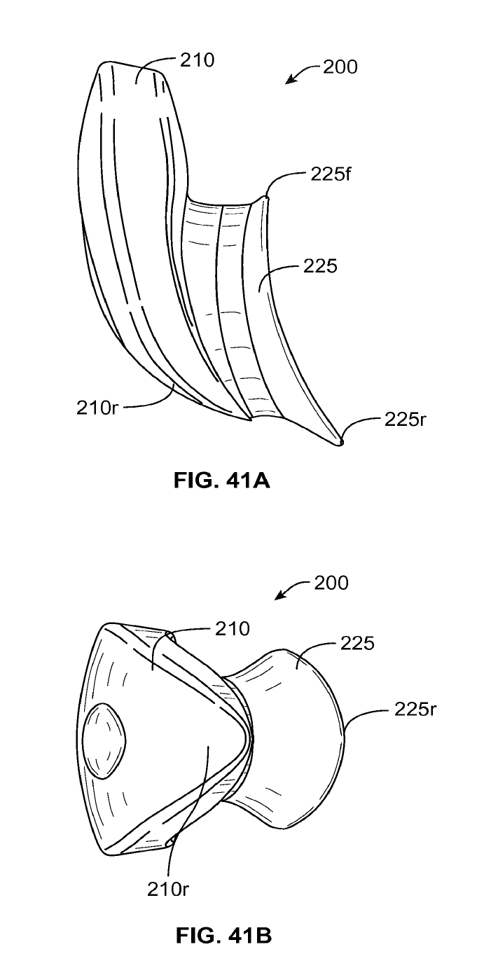

FIGS. 41A and 41B illustrate views of a device 200 including a device body 210. The sealing flange 225 is coupled to the device body 210. The curvature of the sealing flange 225 provides a comfortable and reliable fit for the anatomy. Further, the front portion 225f of the sealing flange 225 has narrower profile than the rear section 225r of the sealing flange. This configuration allows device body 210 to ride over the pubic bone of the user while sealing flange 225 is in contact with tissue. The rear section 225r of the scaling flange 225 is comparatively extended to provide a wider scaling surface, similar to that depicted in FIG. 35B. The comparatively narrower front section 225f of the sealing flange 225 is configured to comfortable and reliably fit at the apex of the labia majora.

FIGS. 41A and 41B also illustrate device body 210 configured to fit comfortably and reliably on a user in multiple contexts. Specifically, as seen in FIG. 41A the rear portion 210r of the device body 210 tapers towards the sealing edge 225 of the device 200. This taper can be helpful in allowing partner access during vaginal intercourse. A device without such a taper could hinder such access. Further, as seen in FIG. 41B the rear portion 210r tapers towards a point with respect to the sides of the device 200. This taper can be helpful in allowing a user to stand and walk with the device engaged. In a device without this taper, some users may experience disengagement of the device when standing or walking due to contact with the users thighs. Still further, the mechanisms, controller block, batteries, and other internal components can be positioned towards the front of the device body 210. Positioning the internal components in this way can place the center of mass of the device in such a way that the propensity of the device to fall away or disengage from the user is decreased. That is, having the center of mass of the device farther from the user side of the device, or in some cases towards the rear portion 210r of the device body 210, can cause the device to act as a lever and “pry” the device off the user when the user is standing or even when the user is laying down.

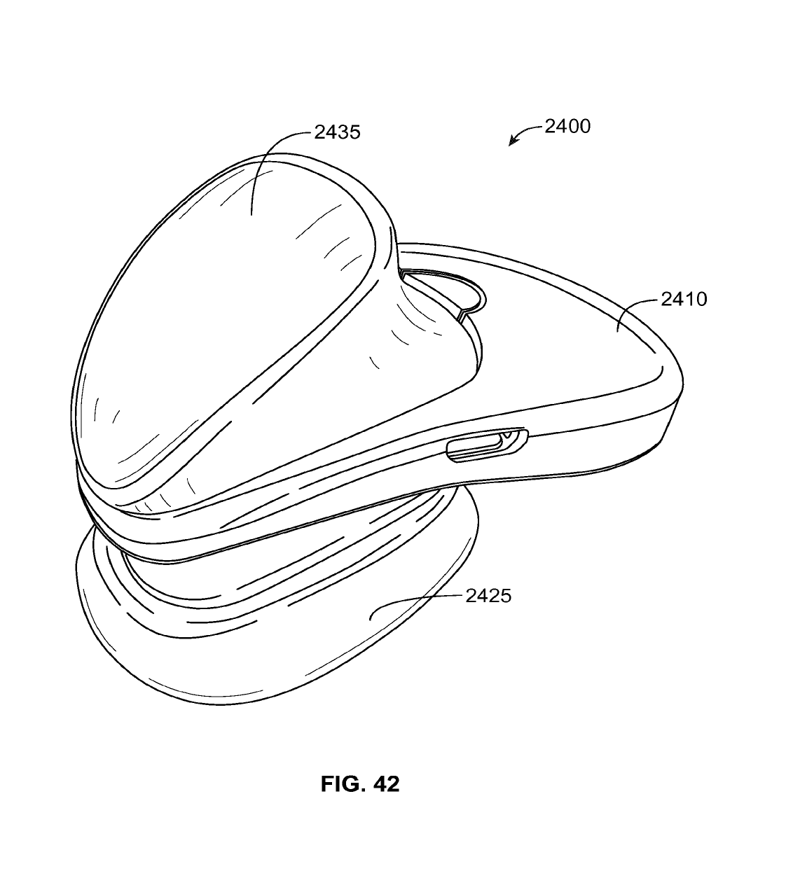

FIG. 42 illustrates a perspective view of a device 2400 that includes a device body 2410, a sealing flange 2425, and an onboard manual pump 2435. Onboard manual pump 2435 is in fluid connection with the suction chamber of the device. The pump 2435 is depicted as a bellows-style pump in which the user pushes down on the exterior surface and thereby expels air from a pumping chamber through an exhaust port. The pumping chamber is in fluid communication with the suction chamber via one or more valves that allow suction to be pulled from within the chamber but prevent air from entering the pumping chamber when air is being expelled from the pumping chamber. Other manual pumps, like bulb systems (similar to a blood pressure cuff) or plunger systems are, may be used. The onboard manual pump can be locked in a low profile state when the pump is not being activated.

Certain embodiments of the invention include device and methods to enhance female sexual wellness and female sexual pleasure and some methods are for treatment of female sexual dysfunction. Certain embodiments of the invention include device and methods to treat (i) female sexual arousal disorder, (ii) hypoactive sexual desire disorder, and/or (iii) female orgasmic disorder. The methods naturally enhance a woman's own sexual response without undesirable, lasting side-effects. A woman will enjoy sexual intimacy again and feel confident in her body's ability to respond to sexual stimulation.

In embodiments described herein, coin-style vibrating motors can be placed edge-on to tissue, in a planar configuration against tissue, or at an angle with respect to tissue therebetween. The angle with respect to tissue can provide a varying degree of intensity. In some embodiments, the device is configured such that the motor angle can be adjusted by the user directly (as in manually) or indirectly by selecting certain stimulation patterns from the controller.

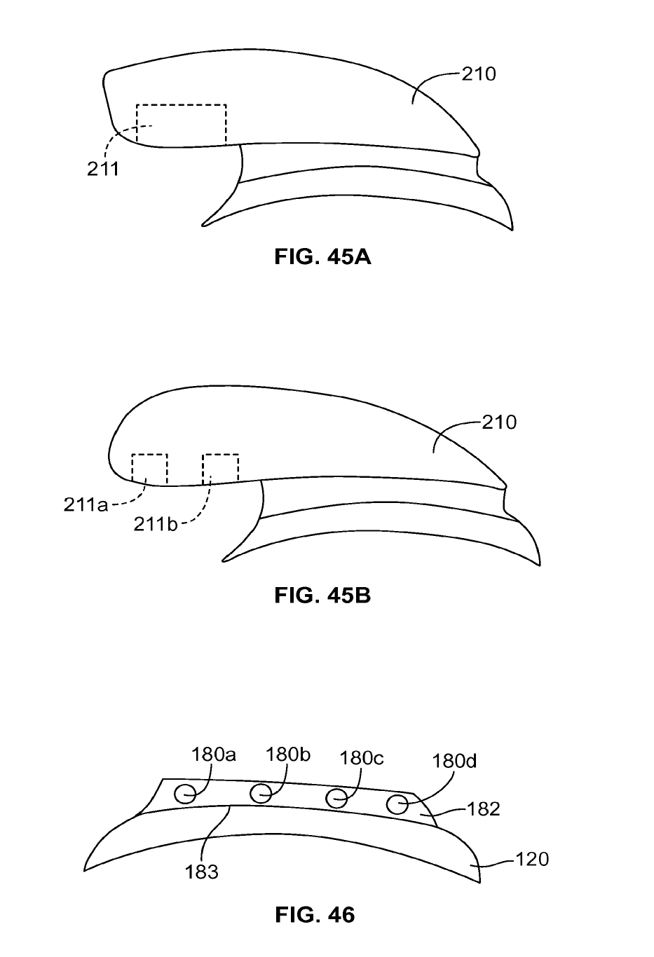

FIG. 45A illustrates an embodiment in which a body vibration source 211 (such as a vibration motor) on the device body 210 provides a baseline level of vibratory stimulation. The vibration on the device body 210 could be, as described in more detail below, the result of contacting the device body 210 with a conventional vibrator. Alternatively, a body vibration source 211 can be included on the device body 210 in addition to any of the stimulating elements described herein as delivering stimulation to vaginal tissue within a tissue chamber (or a suction chamber). Advantageously, the body vibration source 211 provides a level of stimulation that serves to effectively amplify the stimulation provided in the tissue chamber. That is, a baseline level of vibration can contribute to the engorgement and arousal process, and the stimulating elements integrated with the tissue chamber further advance the engorgement and arousal process. Further, the internal vibrating motors can be used initially for arousal and then the body vibration source may be used as additional vibration for additional sensation and/or for attainment of climax. Still further, the baseline vibration from the body vibration source 211 cooperates with vibratory motors to produce resonant and/or harmonic vibration patterns with tissue. Certain users may prefer labial stimulation in conjunction with clitoral stimulation, and the body vibration source 211 can provide vibratory labial stimulation.

In related embodiments illustrated in FIG. 45B, multiple body vibration source 211a and 211b can be positioned on the device body 210. When multiple motors are positioned on the device body 210, the multiple body vibration source 211a and 211b can be configured to vibrate at various frequencies, creating various vibration profiles. The vibration profiles can be in phase, out of phase, di-phasic (creating di-phasic amplification), or multi-phasic.

FIG. 46 illustrates an embodiment of the device and method, in which one or more stimulation sources (such as vibratory motors) 180a, 180b, 180c, and 180d are contained within a stimulation chamber 182 and the stimulation chamber 182 is positioned within the device such that it can contact vaginal tissue and the clitoris in particular. The stimulation sources 180a, 180b, 180c, and 180d are free to stimulate and/or vibrate within the stimulation chamber 182 and in this way periodically apply vibratory stimulation to a bottom surface 183 of the stimulation chamber 182 that is connected to the suction chamber 120. The stimulation sources 180a, 180b, 180c, and 180d may be connected by wires to a control block, but are other wise free to move within the stimulation chamber 182. In some embodiments, the control signals are wireless. Further, the motors may be powered and/or charged by RF signals so that they need not be tethered by wires. In this case, the stimulation sources 180a, 180b, 180c, and 180d are entirely free to move within the vibratory chamber. One feature of these embodiments is that the stimulation sources 180a, 180b, 180c, and 180d are not suspended within the suction chamber 120 but rather periodically impinge upon the suction chamber 120.

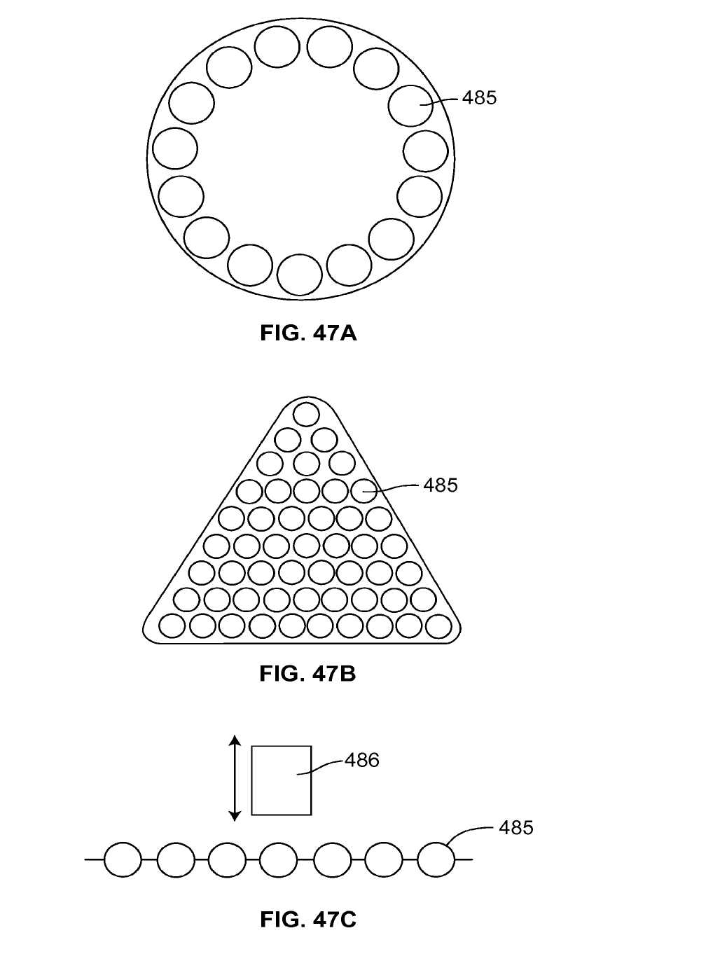

FIGS. 47A, 47B and 47C illustrate embodiments in which stimulating features 485 can be made to impinge upon the tissue chamber. FIGS. 47A-47C operate in a manner similar to the embodiments disclosed in FIG. 10. For example, an array of stimulating features 485 can be positioned above the tissue chamber and the array can be rotated or otherwise moved with respect to tissue. In some embodiments, such as depicted in FIG. 47C, another displacing element 486 can be positioned above the array of stimulating features 485 and the movement of the displacing element 486 forces individual or groups of stimulating features 485 in the array to impinge upon the tissue chamber. The displacing element 486 and the stimulating features 485 can be permanent magnets or electromagnets such that the displacing element 486 generates movement in the stimulating features 485 by magnetic opposition. In embodiments in which the stimulating features 485 are permanent magnets or electromagnets, the stimulating features 485 can be positioned in a holding tray or embedded in a membrane to keep the elements apart. Without such a holding tray or membrane, the magnetic attraction among the stimulating features 485 could cause them to bind together and prevent the desired movement. FIG. 47D illustrates an embodiment in which an array of displacing elements 486 is positioned above an array of stimulating features 485. The array of displacing elements 486 is selectively addressable to create patterns of stimulation by forcing the stimulating features 485 to impinge upon the tissue chamber 220.

In many of the embodiments described herein, it is advantageous to minimize the number or moving parts. It is also advantageous to minimize the number of relatively expensive parts. The embodiments that use an array of stimulating elements that are in some way driven by comparatively fewer motors, magnets, or other energy sources achieve the advantages or fewer moving parts and/or fewer expensive parts.

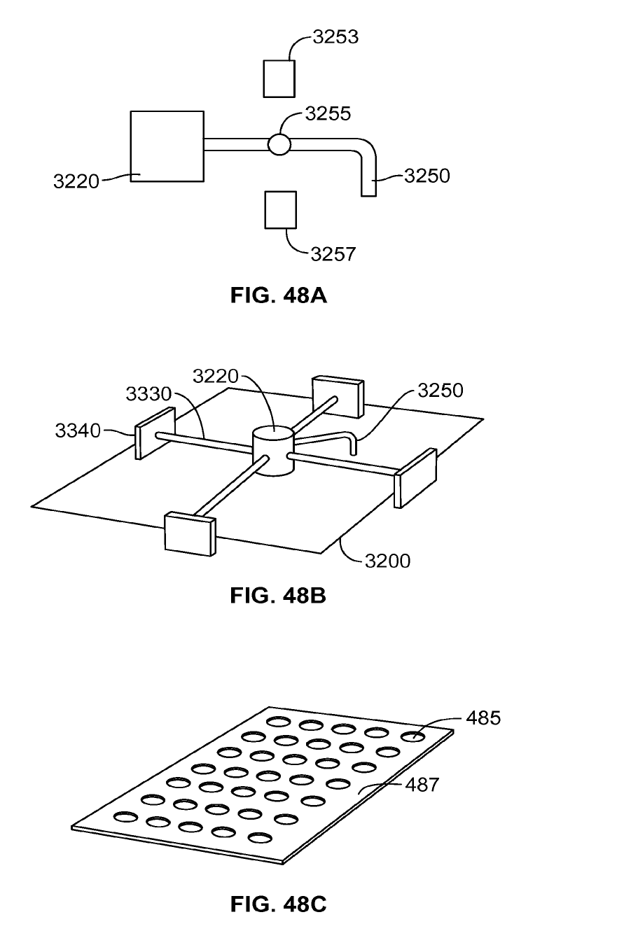

In another embodiment illustrated in FIGS. 48A, 48B, and 48C, a vibratory source includes a vibrating stylus 3250 connected to a motor 3220. The stylus 3250 is positioned within a translating frame 3200 that enables the stylus 3250 to be translated rapidly to different positions with respect to the tissue within the tissue chamber (or suction chamber). In a preferred embodiment, the translating frame 3200 is configured such that the stylus 3250 recenters within the frame when translating forces are removed. For example, the stylus 3250 can be connected using elastic members 3330 to electromagnets 3340. The motor housing 3220 can include a permanent magnet or an electromagnet, which is actively translated by fields generated by the electromagnets in the translating frame. The motor housing 3220 can, alternatively, be moved by a pulley type system between movable fixtures on the translating frame. The motor connected to the stylus 3250 can be vibrationally isolated from the stylus 3250 and translating frame 3200 by mounted the motor on a dampening structure, such as a foam. More than one stylus 3250 and/or more than one translating frame 3200 can be used in various embodiments described herein. In some embodiments, the stylus 3250 can be used to force stimulating features 485 in an array 48, such as that depicted in FIG. 48C, to impinge upon tissue as further described in other embodiments herein. FIG. 48A further depict an embodiment in which the stylus 3250 is translated via the interaction of a magnet 3255 positioned on the stylus arm. Electromagnets 3253 and 3257 are used to translate the stylus 3250 and motor 3220 vibrates the stylus 3250.

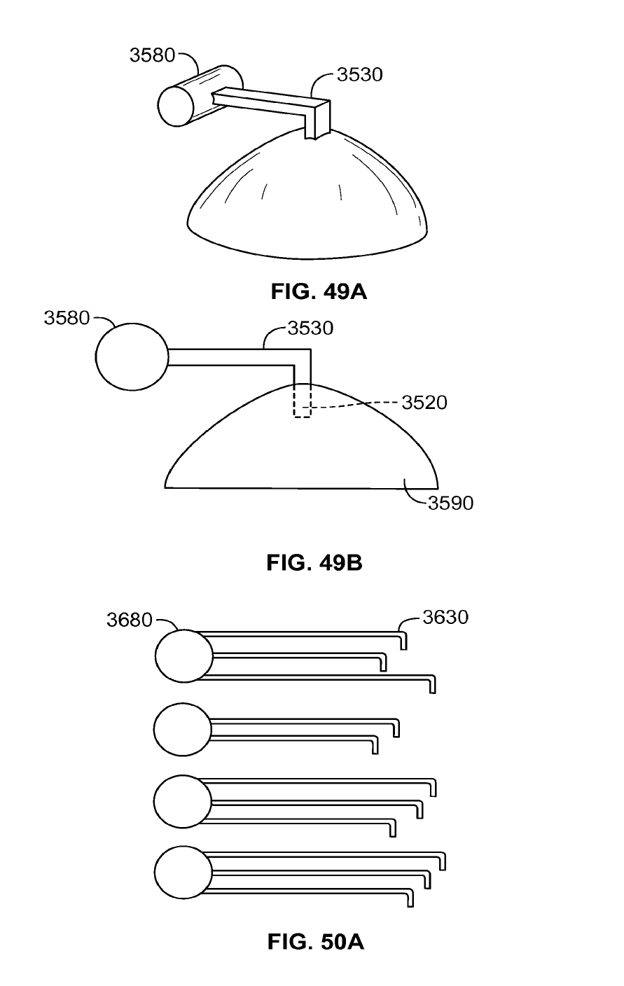

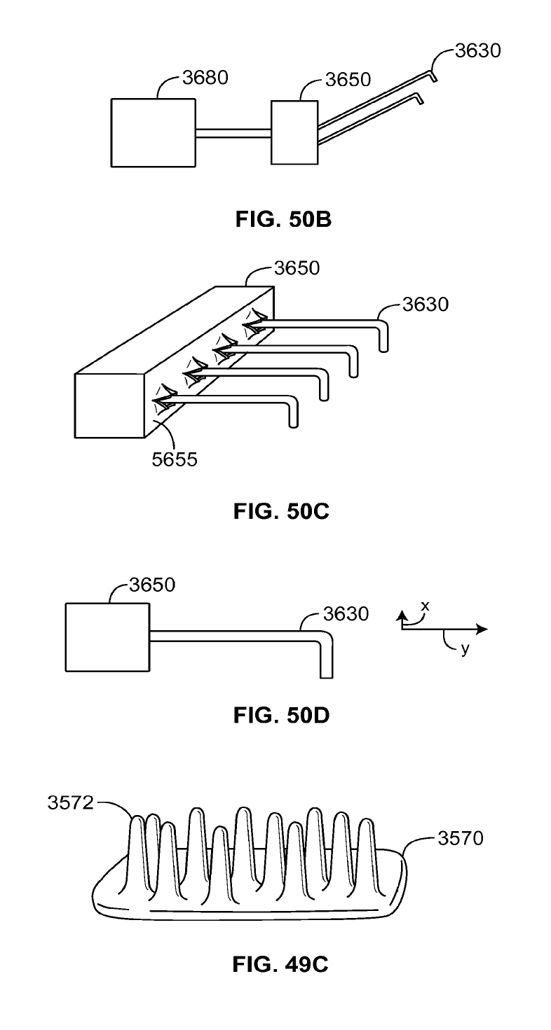

In embodiments of the device and method illustrated in FIGS. 49A and 49B, a motor 3580 located outside the suction chamber 3590 is connected to or otherwise communicates vibration to a link 3530 mounted at least partially within the suction chamber 3590. The link 3530 interacts directly or indirectly with tissue within the suction chamber via a stimulating feature 3520. For example, the link 3530 may directly stimulate tissue by being in contact with the tissue, or the link 3530 may indirectly stimulate tissue by communicating vibration to a stimulating member (such as the array 487 depicted in FIG. 48C or depicted in FIG. 49C) that is in contact with tissue. The stimulating member 3520, such as that depicted in FIG. 49C, may have one or more projections 3572 that stimulate tissue directly. The projections 3572 may have a variety of stiffnesses such that they produced a variable stimulating profile. For example, some projections 3572 may be comparatively flexible and others may be comparatively stiff. The stiff projections transmit comparatively more vibration than the flexible projections.

In some embodiments, the suction chamber includes end effectors that are coupled to and driven by a motor on the outside of the suction chamber. As depicted in a schematic view in FIG. 50A, one or more end effectors 3630 can be selectively addressed by one or more motors 3680. That is, an individual motor 3680 can move or vibrate one or more end effectors 3630 as directed by a controller. Further, the controller can direct the individual motor 3680 to move or vibrate just one end effector 3630 or multiple end effectors. If the individual motor 3680 is directed to move or vibrate multiple end effectors 3630, the motor 3680 can be further directed as to the sequence in which the multiple end effectors 3630 are moved or vibrated. FIG. 50B illustrates a coupler 3650 positioned between each motor 3680 and certain end effectors 3630 to facilitate the selective transmission of motion or vibration from the motor 3680 the desired end effector or effectors 3630. A variety of methods, including magnetic coupling and mechanical coupling, can be used by the coupler to selectively transmit motion or vibration. For example, the end effectors 3630 can be coupled by selectively activating and electromagnet to draw in and connect a permanent magnet on the near end of an end effector 3630 to the coupler 3650. Then, reversing the polarity of the electromagnet can decouple the end effector 3630 and return it to its original position. In another example depicted in FIG. 50C, one of an array of grippers 5655 can grip the near end of given an end effector 3630 to enable transmission of motion or vibration and be released to stop the transmission of motion or vibration. As with other embodiments described herein, the end effector 3630 can be translated in the in two dimensions as depicted in FIG. 50D.

Advantageously, in some embodiments multiple motors can be arranged in a layered configuration with connecting rods of varied lengths. This is an advantage because multiple motors can be arrayed in a comparatively small space and transmit vibration to a larger vibration member. Such an arrangement can also be combined with a stimulator, such as a vibratory motor, suspended within the suction chamber. Alternatively, the multiple motors can be layered and/or configured such that they transmit vibration to at a comparatively higher resolution. That is, the motors can communicate via rods, for example, to a vibratory element whose footprint is comparatively smaller than the footprint of the motor configuration. Further, the vibratory element can have a high density of the stimulating elements that are individually or multiply addressable by the motors.

In contrast to some prior art devices, these embodiments directly interact with a stimulating member having an array of projections. That is, some prior art devices simply shake an entire array of projections rather than providing a series of transmission point that efficiently transmit vibration from a motor to discrete parts of a stimulating array.

In some embodiments, the motor or motors can be located remotely from the stimulating and/or suction chamber such that the motors are contained in a separate housing. The motors can transmit vibration to the site of stimulation via a cable or rod assembly or other similar member. The motor housing can be mounted on a garment or other wearable item. Or, the motor housing can be placed nearby the user without actually being worn or held by the user.

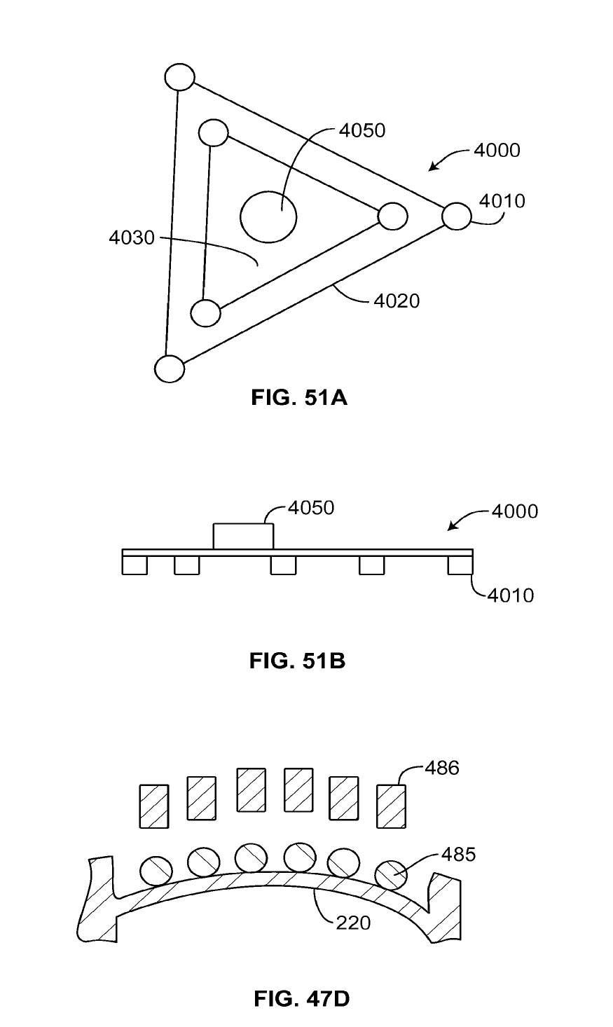

FIGS. 51A and 51B illustrate an embodiment in which a single motor 4050 can drive a stimulation-coupling element 4000, which has areas of differing rigidity. Rigid areas of the stimulation-coupling element 4000 can vibrate harmonically or resonantly with the motor 4050. Thus, a single motor 4050 can drive spatially differentiated vibratory stimulation.

The stimulation-coupling element 4000 can be a network of comparatively rigid nodes 4010 connected by comparatively rigid spokes 4020. The stimulation-coupling element 4000 can also have less rigid regions 4030 that help isolate the vibration to the nodes. That is, the presence of less rigid regions 4030 serves to help spatially differentiate the areas that are vibrating in resonance or harmony with the drive motor 4050.

Alternately, the nodes 4010 can include passive actuators that can couple with the drive motor to provide spatially differentiated stimulation. A passive actuator can include piston and cylinder configuration that stores energy, such as via a spring or its equivalent, and the stored energy can be released and reloaded through resonant coupling of the node 4010 to the drive motor 4050. In some embodiments, passive actuators at nodes 4010 can be selectively controlled by activating or deactivating local dampers. For example, passive actuators have selectively addressable locking mechanisms. Such mechanisms can be electronically controlled by the device controller block that provides patterns for spatially differentiated stimulation. Micro-Electro-Mechanical Systems (MEMS) technology provides various routes for local, selectively addressable control of active and passive actuators and can be implemented in the embodiments described herein.

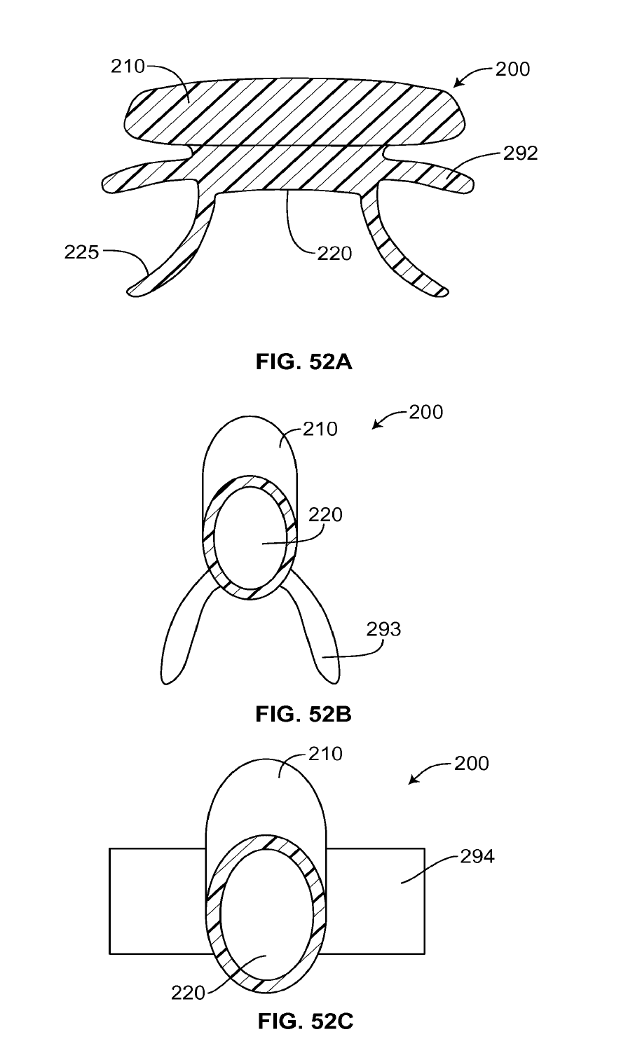

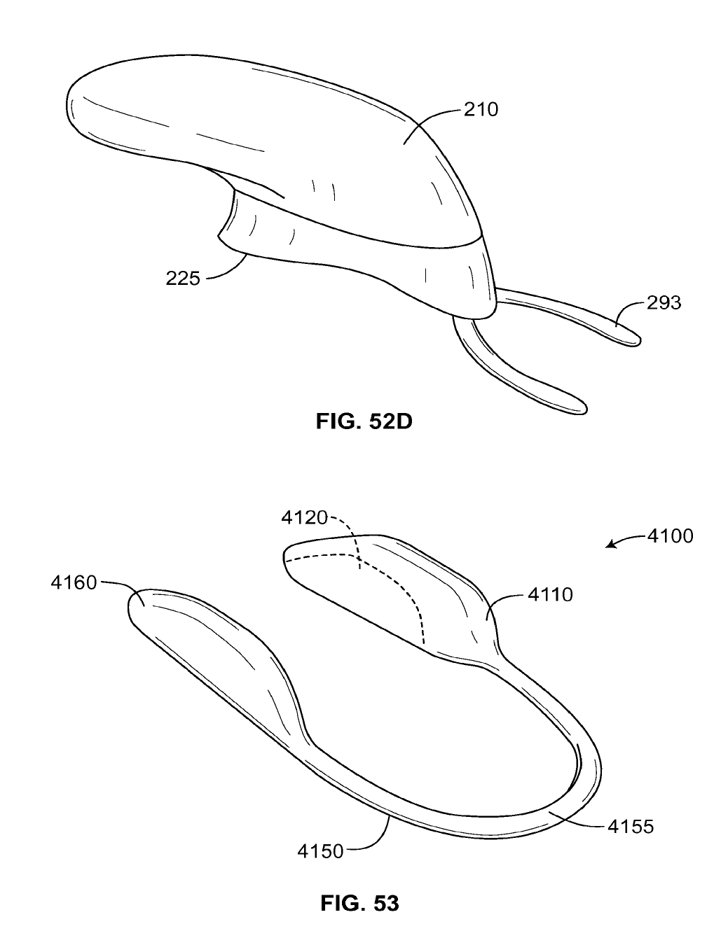

Devices described herein are advantageously attached securely and comfortable to a user's body. In some embodiments, the tissue chamber is configured to fit under the labia majora such that the device is wearable without any other attachment mechanisms (although suction is an optional attachment mechanism). In some embodiments, additional features on the device provide additional ways of comfortably securing the device. For example, adhesives (such as gummy, sticky, or otherwise tacky materials) can be applied to the tissue flange on the device. Still further, flexible wings 294, as depicted in FIG. 52C, can be detachably present on the device body 210 (as seen from the bottom), and the wings 294 can be configured as pressure-sensitive, temperature-sensitive, or moisture-sensitive surfaces. A device 200 can be supplied to a user with multiple attachable and disposable adhesive wings 294. For many users, it is preferable to apply adhesive to an area superior to the clitoris, such as the clitoral hood, where the tissue is more skin than mucosa.

Another method for providing secure and comfortable attachment is through the use of lateral projections 292 on the sides of the device 200 as depicted in FIG. 52A in cross-section. Such lateral projections 292 complement the tissue flange 225 that extends below the labia majora. The lateral projections 292 can be resilient and flexible to facilitate placement. Further, the lateral projections 292 can be configured to bend or snap into place after placement of the tissue flange 225 under the labia majora. The lateral projections 292 can be configured to transmit vibration to the labia majora for users interested in such supplemental stimulation. Alternately, the device can include soft clips for attaching the device to the labia majora.

Still another method for providing secure and comfortable attachment is through the use of soft and comparatively compliant extensions 293 attached to the inferior portion of the device 200, as depicted in FIGS. 52B (as seen from below) and 52D (an isometric view). These inferior extensions 293 are configured to extend under the labial fold and press laterally to stabilize the device 200. The extensions 293 can be resilient and flexible so that they can be pinched together during device positioning and allowed to spring back open and provide gentle support for the device.

In some embodiments, the system 4100 includes an intravaginal unit 4160 coupled to a clitoral stimulation device 4110. The intravaginal unit 4160 can deliver stimulation, including all the types of stimulation disclosed herein. Additionally or alternatively, the intravaginal unit 4160 can house any of the components of the system disclosed herein. Alternatively, intravaginal unit 460 can be passive and act as a unit to provide additional compression/stabilization of the clitoral stimulation device 4110. For example, in some embodiments the intravaginal unit 4160 includes a motor that is coupled to stimulating elements within the clitoral stimulation device 4110. The motor can be configured to provide both intravaginal vibration and clitoral stimulation by transmitting vibration through the stimulating elements. A transmission element, such as a cable, connects the motor in the intravaginal unit 4160 with the clitoral stimulation device 4110. The intravaginal unit 4160 can be configured to engage and stimulate erogenous zone(s) on the anterior vaginal wall (the “G-spot”).

The coupling between the intravaginal unit 4160 and the clitoral stimulation device can be a “C” shaped connecter 4150, which is configured to provide a secure and comfortable fit. For example, the connector 4150 could be reversibly deformable or it could be capable of flexing open and closed to return to an original position. The connector 4150 can be formed from a resilient or malleable wire encased in a protective cover. The connector can have a hinge point 4155 to facilitate placement. The intravaginal unit 4160 can be configured to vibrate or otherwise stimulate the G-spot via a stimulation source (such as a motor) located near where the unit 4160 meets the connector 4150. In another aspect, the stimulator for the intravaginal unit 4160 can be located in the housing of the clitoral stimulation device 4110.

In some embodiments, the intravaginal unit is not physically connected to the clitoral stimulation device. In such embodiments, the intravaginal unit can communicate by near-field radiofrequency technology or other interdevice communication methods. In such embodiments in which the intravaginal unit is not physically connected to the clitoral stimulation device, the intravaginal unit can still provide vibratory of other stimulation by virtue of stimulation elements included in the intravaginal unit.

An intravaginal unit can be used to provide clitoral stimulation by vibrating or resonating with a comparatively small device applied to the clitoris. Advantageously, such embodiments can use a soft clip or similar device applied to the clitoris, and the soft clip can be driven to provide stimulation by the intravaginal unit. In one embodiment, the soft clip contains permanent or electromagnets that can be driven to squeeze together and come apart to provide stimulation to clitoral tissue. An intravaginal unit or a separate unit can provide the external magnetic field used to drive the soft clip.

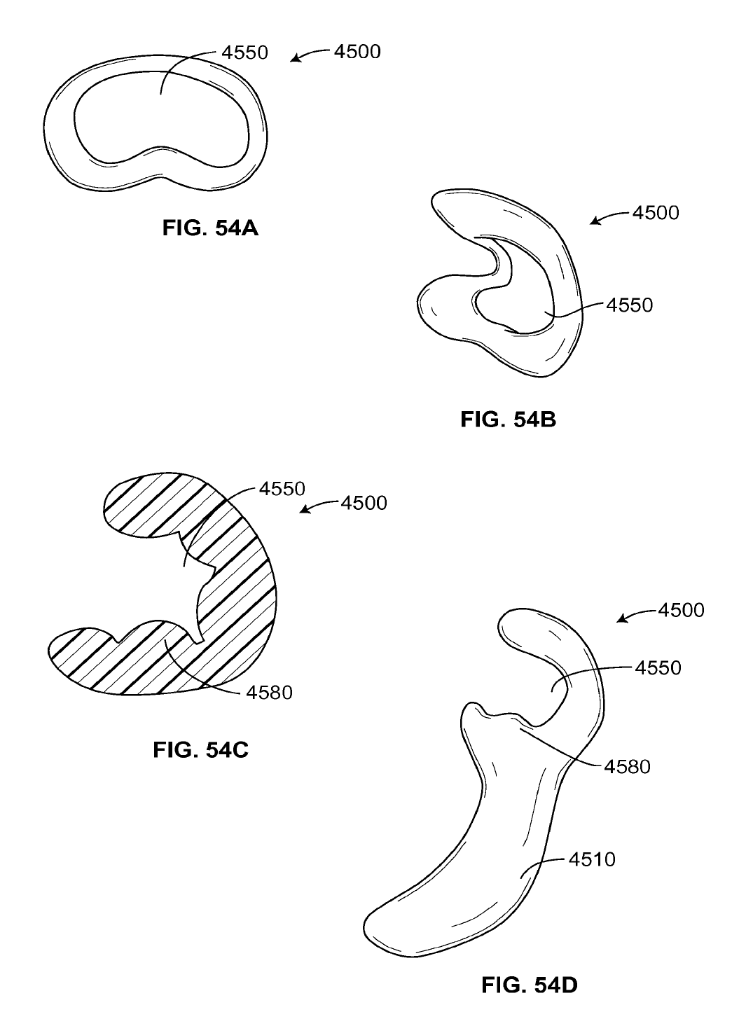

Other embodiments of the device, depicted in FIGS. 54A, 54B, 54C, and 54D, place some or all of the stimulators inferior to the clitoris. The body 4510 of the device 4500 in these embodiments is placed in the space between the labia such that the center of mass of the device is farther inferior than other embodiments described herein in which a significant portion of the device rests on the mons. One advantage of this embodiment is that the weight of the device is somewhat inferior to the clitoris and therefore can provide secure and comfortable attachment. The device may partially obstruct the urethra and/or the vaginal opening. The device can be configured to take advantage of its location and employ any of the intravaginal unit embodiments described herein. Another advantage of this embodiment is that the stimulators 4580 can directly contact the clitoris without relying on clitoral engorgement. That is, by placing the motors inferior to the clitoris, the motors contact the clitoris while it is in a comparatively flaccid state. FIGS. 54A, 54B, and 54C illustrate a front view, a perspective view, and a side cross-sectional view, respectively, of the clitoral engagement chamber 4550.

In certain embodiments, the suction chamber is flexible and/or capable of expanding. The suction chamber is brought into contact with clitoral and/or vulvar tissue. When suction is applied, tissue is captured and the flexible suction chamber displaces and optionally expands to further capture tissue and to present tissue to stimulating elements, such as vibratory motors. In these embodiments, the vibratory motors can be located outside the suction chamber, as opposed to being suspended with the suction chamber. Further, clitoral and/or vulvar tissue may be gently squeezed towards the stimulating elements in addition to, or instead of, being drawn by suction towards the stimulating elements. Squeezing tissue can be accomplished using a variety of methods. For example, the walls of the suction chamber can be plastically deformable such that a user can manually manipulate the chamber to squeeze tissue. In another example, the suction chamber walls can be biased to squeeze together and the user can manually separate them during placement on clitoral and/or vulvar tissue.

In some embodiments, electromagnetic actuators that are configured differently than a conventional voice coil are used. For example, planar magnetic transducers can be used as actuators to deliver stimulation to clitoral and/or vulvar tissue. Planar magnetic transducers can provide direct mechanical stimulation via a diaphragm or membrane that directly contacts tissue, or they can provide acousto-mechanical stimulation that drives air against clitoral and/or vulvar tissue.

Planar magnetic transducers typically consist of a diaphragm having a printed circuit spread across the surface of a thin-film substrate and a magnetic array. The magnetic array creates a magnetic field parallel to the diaphragm. The thin diaphragm is highly responsive to electrical signals and can be used to generate spatially differentiated kinesthetic sensations and forces.

In other embodiments, magnets can be embedded in a thin membrane that is positioned and configured to stimulate clitoral and/or vulvar tissue. An electromagnetic array can be positioned above the membrane to drive specific magnets and create spatially differentiated stimulation. That is, selective activation of the electromagnetic array can drive individual or groups of embedded magnets. Alternatively, instead of an electromagnetic array, one or more moveable permanent magnets can be used to selectively drive individual or groups of embedded magnets. The permanent magnet can be moved by a variety of mechanical or electromechanical means and according to various programmable or pre-programmed patterns.

In certain embodiments, the system includes a vacuum reservoir. That is, the system includes a chamber that is capable of holding negative pressure that can be applied to the suction chamber of the device through a valve system. During initial attachment, after achieving the desired level of suction in the suction chamber, such as with an on-board pump, the vacuum source continues to run to supply the vacuum reservoir with excess negative pressure. The on-board pump can stop running, and if a small leak develops the negative pressure in the vacuum reservoir can supply suction to the suction chamber until it is exhausted, and then the pump can turn back on to replenish the reservoir and suction chamber and then stop running again. One advantage of the vacuum reservoir is that the desired level of suction can be maintained while having the suction source operate comparatively less than a system without a vacuum reservoir.

Systems described herein can be equipped with sensors and sensing capabilities. The data collected from sensing can be used in a variety of ways, such as display to the user and/or feedback to the device control systems. Sensed parameters include tissue temperature, tissue impedance, blood flow, tissue turgidity and/or engorgement, heart rate, and blood pressure. The data can be represented on the user control device, such as a smartphone. The data can be represented graphically and/or numerically and can be mapped over a visual representation of the anatomy. In a sense, the displayed data can be an “arousal meter” that provides information to the user. Further, the state of the user's arousal can be used to provide a biofeedback loop to control the device. For example, the user can set an arousal level on the device prior to use and the device can monitor the user's arousal state. By sensing the arousal state, the device control systems can increase or decrease stimulation to meet the user-set state.

In some embodiments, actuators are used rather than coin-style or other vibratory motors. One style of actuator is a linear actuator in which a member is driven back and forth. The electromagnetic voice coils described herein are an example of a type of linear actuator wherein a membrane is driven in response to an electromagnetic coil. Other linear actuators involve electromagnets and passive magnets arranged in a piston-type configuration to create linear motion.

In certain embodiments, the linear actuators used are not driven solely, or at all, by electromagnetic fields. For example, pneumatic actuators can be used in which a reservoir is charged with compressed gas (including air) by a pump. The pump can be a manual pump such as a bellows or a syringe pump. The linear drive element of the pneumatic actuator can be biased in a first position and driven to a second position by a burst of gas released from the reservoir through a valve system. Other configurations of pneumatic actuators are useful in these embodiments.

In certain embodiments, miniature scale actuators of other types are used to generate stimulating forces. For example, various types of thermomechanical and thermoelectric actuators can be used to drive stimulating elements in a device. Such actuators include those that use thermoelectricity to expand a fluid, and such fluid expansion can drive a mechanical element (a piston, for example). Other thermoelectric actuators that are useful in some embodiments include shape memory alloys, such as nitinol, which can be used to produce mechanical motion when thermoelectrically heated. More generally, actuators capable of producing kinesthetic forces and sensations, including each of the types of actuators disclosed herein, are applicable as stimulators.

In some embodiments, pneumatic systems can be used to provide stimulation. Pneumatic systems having miniature ports can deliver rapid puffs of air (or other gas) to produce tactile and/or kinesthetic sensations and forces. The rate and volume of the puffs of air can be varied to produce a variety of stimuli. Multiple ports for delivery of puffs of air can be used to achieve spatially differentiated stimulation of clitoral and/or vulvar tissue. Multiple ports can be configured using a valve and port array that delivers air from one or more pneumatic sources. Alternately, an array of pneumatic sources can be used.

In some embodiments, circulating air can be used to provide stimulation. As with the pulsed or puffs of air, a pneumatic source or sources can deliver air through a valve and port system. In contrast to the pulsed air system, a circulating air system can be used to stimulate tissue by blowing across tissue rather than pulsing against tissue. Certain embodiments employ both types of pneumatic systems in which air is circulated and pulsed. Further, pulsed air may also be directed across the surface of tissue. And, pneumatic stimulators can be used on conjunction with any of the other stimulator types disclosed herein.

Referring still to systems including multiple valve and ports, in some embodiments a suction source is used to apply suction through a valve and port array. Such a system can engage clitoral and/or vulvar tissue at multiple, spatially differentiated locations. Alternately, multiple and separately controlled suction sources can be used in conjunction with, or in place of an array of valves and ports. In some embodiments, rapid fluctuation of suction can be used to produce kinesthetic sensations and forces.

In many of the embodiments described herein, it can be desirable to apply therapeutic energy to clitoral and/or vulvar tissue, such as light energy or electromagnetic energy. Certain light frequencies can decrease tissue inflammation and certain light frequencies can increase local blood flow.

In many of the embodiment described herein, it can be desirable to provide ambient sounds via the device or system. Ambient sounds can be soundscapes that promote feelings of well-being and/or arousal in the user. Additionally, the ambient sound can be a “white noise” that provides a relatively constant background sound and thereby masks or de-emphasizes sounds made by the device during device operation. To that end, the device or system could include an active noise cancellation system.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1-29. (canceled)

30. An apparatus for promoting sexual stimulation in a female user, comprising:
a body, the body having an upper side portion and a lower side portion, the lower side portion including a chamber;
a first extension extending laterally from a first side of the body;
a second extension extending laterally from a second side of the body;
wherein the first and second extensions each being sized and shaped to engage a labia of the female user to provide a secure attachment thereto.

31. The apparatus of claim 30, wherein the first and second extensions are configured to extend under a labial fold.

32. The apparatus of claim 30, wherein the first and second extensions are configured to press laterally.

33. The apparatus of claim 30, wherein the first and second extensions are resilient.

34. The apparatus of claim 30, wherein the first and second extensions are flexible.

35. The apparatus of claim 30, wherein the first and second extensions are configured to be pinched together during positioning.

36. The apparatus of claim 35, wherein the first and second extensions are configured to spring back to an open position after releasing a pinching force.

37. The apparatus of claim 30, wherein the body has a superior portion and an inferior portion, and the first and second extensions are attached to the inferior portion.

38. The apparatus of claim 30, further comprising a suction housing.

39. The apparatus of claim 30, further comprising a stimulator.

40. The apparatus of claim 30, further comprising a manifold.

41. The apparatus of claim 30, further comprising a micro-pump.
